(19) United States
(12) Patent Application Publication
(10) Pub. No.: US 2025/0375063 A1
(43) Pub. Date: Dec. 11, 2025

(54) TEMPERATURE CONTROL ACCESSORIES FOR CHARCOAL-FUELED KETTLE GRILLS

(71) Applicant: Weber-Stephen Products LLC, Palatine, IL (US)

(72) Inventors: Andrew Kosir, Chicago, IL (US); Matthew Dacanay, Addison, IL (US); Nicholas Beyrer, San Francisco, CA (US); Gabriel Risk, San Francisco, CA (US); Brian C. Donnelly, Naperville, IL (US)

(21) Appl. No.: 19/226,063

(22) Filed: Jun. 2, 2025

Related U.S. Application Data
(60) Provisional application No. 63/658,523, filed on Jun. 11, 2024.

(51) Int. Cl. A47J 37/07; A47J 36/32; A47J 37/04

(52) U.S. Cl. CPC A47J 37/0786; A47J 36/32; A47J 37/041; A47J 37/0704; A47J 37/0754; A47J 2202/00

(57) ABSTRACT

Temperature control accessories for charcoal-fueled kettle grills are disclosed. An example temperature control accessory includes a support ring, an interior duct, and a control unit. The support ring includes a sidewall. The interior duct is located internally relative to the sidewall. The control unit is located externally relative to the sidewall. The control unit includes an airflow generator configured to generate a flow of air. The flow of air is to pass from the airflow generator, through an opening formed in the sidewall of the support ring, and into the interior duct.

### RELATED APPLICATIONS

This application claims priority to U.S. Provisional Patent Application No. 63/658,523, filed Jun. 11, 2024. The entirety of U.S. Provisional Patent Application No. 63/658,523 is hereby incorporated by reference herein.

### FIELD OF THE DISCLOSURE

This disclosure relates generally to charcoal-fueled kettle grills and, more specifically, to temperature control accessories for charcoal-fueled kettle grills.

### BACKGROUND

Charcoal-fueled kettle grills typically include a bowl-shaped firebox, a dome-shaped lid, a cooking grate, and a fuel grate. The cooking grate and the fuel grate are located within a cooking chamber defined by the firebox and the lid, with the fuel grate being located below the cooking grate. The fuel grate is configured to support charcoal fuel (e.g., charcoal briquettes). The cooking grate is configured to support one or more item(s) of food to be cooked within the cooking chamber via heat generated from combustion of the charcoal fuel. Kettle grills also typically include one or more vent(s) located at the bottom of the firebox and/or at the top of the lid, with such vent(s) being manually adjustable to assist in either increasing or decreasing the temperature within the cooking chamber during a cooking operation performed therein. Kettle grills have historically been configured to operate without an automated temperature control mechanism configured to regulate the temperature within the cooking chamber.

### BRIEF DESCRIPTION OF THE DRAWINGS

FIG. 1 is a block diagram of an example temperature control accessory constructed in accordance with the teachings of this disclosure.

FIG. 2 is a first perspective view of an example implementation of the temperature control accessory of FIG. 1.

FIG. 3 is a second perspective view of the temperature control accessory as shown in FIG. 2.

FIG. 4 is a top view of the temperature control accessory as shown in FIGS. 2 and 3.

FIG. 5 is a bottom view of the temperature control accessory as shown in FIGS. 2-4.

FIG. 6 is a first perspective view of an example support ring of the temperature control accessory shown in FIGS. 2-5, with the support ring shown in isolation.

FIG. 7 is a second perspective view of the support ring as shown in FIG. 6.

FIG. 8 is a perspective view of an example first seal and an example second seal that are couplable to the support ring of the temperature control accessory as shown in FIGS. 2-7.

FIG. 9 is a first perspective view of the support ring as shown in FIGS. 2-7, with the first seal and the second seal of FIG. 8 shown coupled to the support ring.

FIG. 10 is a second perspective view of the support ring as shown in FIG. 9.

FIG. 11 is a first perspective view of an example interior duct of the temperature control accessory shown in FIGS. 2-5, with the interior duct shown in isolation.

FIG. 12 is a second perspective view of the interior duct as shown in FIG. 11.

FIG. 13 is a first perspective view of an example transfer duct configured to be implemented by the temperature control accessory shown in FIGS. 2-5, with the transfer duct shown in isolation.

FIG. 14 is a second perspective view of the transfer duct as shown in FIG. 13.

FIG. 15 is a first perspective view of an example shutter configured to be implemented by the temperature control accessory shown in FIGS. 2-5, with the shutter shown in isolation.

FIG. 16 is a second perspective view of the shutter as shown in FIG. 15.

FIG. 17 is a perspective view of the shutter as shown in FIGS. 14 and 15 assembled relative to the transfer duct as shown in FIGS. 12 and 13, with the shutter positioned in an example non-blocking position.

FIG. 18 is a perspective view of the shutter as shown in FIGS. 14 and 15 assembled relative to the transfer duct as shown in FIGS. 12 and 13, with the shutter positioned in an example blocking position.

FIG. 19 is a top view of an example control unit of the temperature control accessory shown in FIGS. 2-5, with the control unit shown in isolation, and with the shutter of the control unit positioned in the non-blocking position as shown in FIG. 17.

FIG. 20 is a bottom view of the control unit as shown in FIG. 19.

FIG. 21 is a front view of the control unit as shown in FIGS. 19 and 20.

FIG. 22 is a rear view of the control unit as shown in FIGS. 19-21.

FIG. 23 is a right side view of the control unit as shown in FIGS. 19-22.

FIG. 24 is a left side view of the control unit as shown in FIGS. 19-23.

FIG. 25 is a cross-sectional view of the control unit as shown in FIGS. 19-24, taken along section B-B of FIG. 21.

FIG. 26 is a perspective view of the cross-sectional shown in FIG. 25.

FIG. 27 is a cross-sectional view of the control unit as shown in FIGS. 19-24, taken along section A-A of FIG. 19.

FIG. 28 is a perspective view of the cross-sectional view shown in FIG. 27.

FIG. 29 is a cross-sectional view of the control unit as shown in FIGS. 19-24, taken along section B-B of FIG. 21, with the control unit shown coupled to the support ring and/or the interior duct of the temperature control accessory of FIGS. 2-5.

FIG. 30 is a perspective view of the cross-sectional view shown in FIG. 29.

FIG. 31 is a cross-sectional view of the control unit as shown in FIGS. 19-24, taken along section A-A of FIG. 19, with the control unit shown coupled to the support ring and/or the interior duct of the temperature control accessory of FIGS. 2-5.

FIG. 32 is a perspective view of the cross-sectional view shown in FIG. 31.

FIG. 33 is a top view of the control unit of the temperature control accessory shown in FIGS. 2-5 and 19-32, with the control unit shown in isolation, and with the shutter of the control unit positioned in the blocking position as shown in FIG. 18.

FIG. 34 is a bottom view of the control unit as shown in FIG. 33.

FIG. 35 is a front view of the control unit as shown in FIGS. 33 and 34.

FIG. 36 is a rear view of the control unit as shown in FIGS. 33-35.

FIG. 37 is a right side view of the control unit as shown in FIGS. 33-36.

FIG. 38 is a left side view of the control unit as shown in FIGS. 33-37.

FIG. 39 is a cross-sectional view of the control unit as shown in FIGS. 33-38, taken along section D-D of FIG. 35.

FIG. 40 is a perspective view of the cross-sectional shown in FIG. 39.

FIG. 41 is a cross-sectional view of the control unit as shown in FIGS. 33-38, taken along section C-C of FIG. 33.

FIG. 42 is a perspective view of the cross-sectional view shown in FIG. 41.

FIG. 43 is a cross-sectional view of the control unit as shown in FIGS. 33-38, taken along section D-D of FIG. 35, with the control unit shown coupled to the support ring and/or the interior duct of the temperature control accessory of FIGS. 2-5.

FIG. 44 is a perspective view of the cross-sectional view shown in FIG. 43.

FIG. 45 is a cross-sectional view of the control unit as shown in FIGS. 33-38, taken along section C-C of FIG. 33, with the control unit shown coupled to the support ring and/or the interior duct of the temperature control accessory of FIGS. 2-5.

FIG. 46 is a perspective view of the cross-sectional view shown in FIG. 45.

FIG. 47 illustrates an example food temperature probe configured to be implemented with the temperature control accessory of FIGS. 2-5.

FIG. 48 illustrates an example power cord configured to be implemented with the temperature control accessory of FIGS. 2-5.

FIG. 49 is an exploded view of an example kettle grill including the temperature control accessory shown FIGS. 2-5.

FIG. 50 is an example assembled view of the kettle grill shown in FIG. 49, with the temperature control accessory shown installed between the firebox and the lid of the kettle grill.

FIG. 51 is a flowchart representative of example machine-readable instructions and/or example operations that may be executed by processor circuitry to implement the temperature control accessory of FIG. 1.

FIG. 52 is a block diagram of an example processor platform including processor circuitry structured to execute and/or instantiate the machine-readable instructions and/or operations of FIG. 51 to implement the temperature control accessory of FIG. 1.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

As discussed above, conventional charcoal-fueled kettle grills have historically been configured to operate without an automated temperature control mechanism configured to regulate the temperature within the cooking chamber of the kettle grill. When used with and/or installed on such conventional charcoal-fueled kettle grills, example temperature control accessories disclosed herein advantageously provide an automated mechanism to regulate the temperature within the cooking chamber of the kettle grill. In some disclosed examples, a temperature control accessory includes a support ring, an interior duct, and a control unit. The support ring includes a sidewall. The interior duct is located internally relative to the sidewall of the support ring, and the control unit is located externally relative to the sidewall of the support ring. In some disclosed examples, the control unit includes an airflow generator (e.g., a blower or a fan) configured to generate a flow of air. The flow of air generated by the airflow generator passes from the airflow generator, through an opening formed in the sidewall of the support ring, and into the interior duct.

In some disclosed examples, the control unit of the temperature control accessory further includes a controller operatively coupled to the airflow generator. The controller is configured to operate the airflow generator to control a temperature within a cooking chamber of the kettle grill. In some disclosed examples, the controller is configured to operate the airflow generator to regulate a measured temperature of the cooking chamber relative to a temperature setpoint. In some disclosed examples, the temperature control accessory further includes a temperature sensor having a sensing portion located internally relative to the sidewall of the support ring. The temperature sensor is configured to sense the measured temperature of the cooking chamber. In some disclosed examples, the support ring includes a sensor mounting bracket coupled to and located internally relative to the sidewall of the support ring. The sensor mounting bracket is configured to support or carry the temperature sensor.

In some disclosed examples, the interior duct of the temperature control accessory includes a first end having an inlet, a second end having an outlet, and a sidewall extending between the inlet and the outlet. The first end of the interior duct is coupled to the sidewall of the support ring such that the inlet of the interior duct is in fluid communication with the opening formed in the sidewall of the support ring. In some disclosed examples, the flow of air generated by the airflow generator is to pass along an airflow pathway extending from the airflow generator, through the opening formed in the sidewall of the support ring, through the inlet and through the outlet of the interior duct, and into a cooking chamber of the kettle grill. In some disclosed examples, the sidewall of the interior duct extends downwardly from the support ring such that the outlet of the interior duct is located below a lower rim of the support ring. In some disclosed examples, the outlet of the interior duct is configured to be vertically oriented at a normal angle relative to a surrounding area of an interior surface of a firebox of the kettle grill.

In some disclosed examples, the control unit of the temperature control accessory further includes a transfer duct located between the airflow generator of the control unit and the sidewall of the support ring. The transfer duct includes a first end having an inlet, a second end having an outlet, and a flow chamber extending between the inlet and the outlet. The inlet of the transfer duct is in fluid communication with an outlet of the airflow generator. The second end of the transfer duct is coupled to the sidewall of the support ring such that the outlet of the transfer duct is in fluid communication with the opening formed in the sidewall of the support ring. In some disclosed examples, the flow of air generated by the airflow generator is to pass along an airflow pathway extending from the airflow generator, through the inlet, through the flow chamber, and through the outlet of the transfer duct, through the opening formed in the sidewall of the support ring, through the inlet and through the outlet of the interior duct, and into a cooking chamber of the kettle grill.

In some disclosed examples, the control unit of the temperature control accessory includes a shutter associated with the transfer duct and movable between a non-blocking position and a blocking position. The inlet and the outlet of the transfer duct are open when the shutter is in the non-blocking position. A portion of the flow chamber of the transfer duct is unblocked when the shutter is in the non-blocking position and blocked when the shutter is in the blocking position. In some disclosed examples, the shutter includes a panel having an opening. The panel is slidable within a slot formed in the transfer duct. The panel is configured such that the opening of the panel is aligned with the flow chamber of the transfer duct when the shutter is in the non-blocking position and such that the opening of the panel is not aligned with the flow chamber of the transfer duct when the shutter is in the blocking position. Movement of the shutter between the non-blocking position and the blocking position occurs in a direction that is crosswise relative to a central axis of the flow chamber of the transfer duct. In some disclosed examples, movement of the shutter between the non-blocking position and the blocking position occurs in response to user interaction with a tab of the shutter. The tab is accessible to the user from a location outside of an external housing of the control unit. In some disclosed examples, the transfer duct includes a protrusion located along and extending downward from a bottom wall of the transfer duct. The shutter includes a lower flange having a first detent and a second detent spaced apart from the first detent. The protrusion is received in the first detent when the shutter is in the non-blocking position. The protrusion is received in the second detent when the shutter is in the blocking position.

In some disclosed examples, the support ring of the temperature control accessory includes an upper rim and a lower rim. The upper rim is configured to interface with a lid of the kettle grill. The lower rim is configured to interface with a firebox of the kettle grill. The sidewall of the support ring extends between the upper rim and the lower rim of the support ring. In some disclosed examples, the lower rim of the support ring is configured to be seated on, circumscribed by, or nested within an upper rim of the firebox, and the upper rim of the support ring is configured to be seated under, circumscribed by, or nested within a lower rim of the lid. In some disclosed examples, the upper rim and the lower rim of the support ring have a circular shape.

In some disclosed examples, the support ring of the temperature control accessory includes a plurality of support flanges coupled to and extending internally relative to the sidewall of the support ring. Respective ones of the support flanges are configured to support a cooking grate. In some disclosed examples, the support ring of the temperature control accessory includes a pair of circumferentially opposed openings formed in the sidewall of the support ring. Each one of the circumferentially opposed openings is configured to receive a portion of a rotisserie spit when the rotisserie spit is in use with the temperature control accessory. Each one of the circumferentially opposed openings is further configured to receive a seal when the rotisserie spit is not in use with the temperature control accessory.

The above-identified features as well as other advantageous features of example temperature control accessories for charcoal-fueled kettle grills are further described below in connection with the figures of the application.

As used herein in a mechanical context, the term “configured” means sized, shaped, arranged, structured, oriented, positioned, and/or located. For example, in the context of a first part configured to fit within a second part, the first part is sized, shaped, arranged, structured, oriented, positioned, and/or located to fit within the second part. As used herein in an electrical and/or computing context, the term “configured” means arranged, structured, and/or programmed. For example, in the context of processor circuitry configured to perform a specified operation, the processor circuitry is arranged, structured, and/or programmed (e.g., based on machine-readable instructions) to perform the specified operation.

As used herein in the context of a first object circumscribing a second object, the term “circumscribe” means that the first object is constructed around and/or defines an area around the second object. In interpreting the term “circumscribe” as used herein, it is to be understood that the first object circumscribing the second object can include gaps and/or can consist of multiple spaced-apart objects, such that a boundary formed by the first object around the second object is not necessarily a continuous boundary.

As used herein, unless otherwise stated, the terms “above” and “below” describe the relationship of two parts relative to Earth. For example, as used herein, a first part is “above” a second part if the second part is closer to Earth than the first part is. As another example, as used herein, a first part is “below” a second part if the first part is closer to Earth than the second part is. It is to be understood that a first part can be above or below a second part with one or more of: another part or parts therebetween; without another part therebetween; with the first and second parts contacting one another; or without the first and second parts contacting one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts at the point (or points) of contact between the two parts.

As used herein, the term “fastener” means any device(s), structure(s), and/or material(s) that is/are configured, individually or collectively, to couple, connect, attach, and/or fasten one or more component(s) to one or more other component(s). For example, a fastener can be implemented by any type(s) and/or any number(s) of bolts, nuts, screws, posts, anchors, rivets, pins, clips, ties, welds, adhesives, etc.

As used herein, the term “in electrical communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein in the context of describing the relationship between two structures, the term “in fluid communication” means that the two structures are individually and/or collectively configured to allow a fluid (e.g., a gas or a liquid) to pass (e.g., to flow) from the first of the two structures to the second of the two structures, or vice-versa. For example, a second duct may be described as being in fluid communication with a first duct when a fluid (e.g., a gas or a liquid) is able to pass (e.g., to flow) from the first duct into the second duct, or from the second duct into the first duct.

As used herein, the term “airflow generator” encompasses any electromechanical device that is configured to generate and/or produce a flow of air, and/or to move a volume of air from one location to another location. Example airflow generators described herein can therefore be implemented by any type(s) and/or any number(s) of blower(s), fan(s), and/or other electromechanical device(s) that is/are configured to generate and/or produce a flow of air, and/or to move a volume of air from one location to another location.

As used herein, “processor circuitry” is defined to include (i) one or more special purpose electrical circuit(s) structured to perform one or more specific operation(s), and/or (ii) one or more general purpose electrical circuit(s) programmable with instructions to perform one or more specific operation(s). Example processor circuitry described herein can include any type(s) and/or any number(s) of processor(s), microprocessor(s), controller(s), microcontroller(s), application specific integrated circuit(s) (ASIC(s)), programmable logic device(s) (PLD(s)), field programmable logic device(s), (FPLD(s)), field programmable gate arrays (FPGA(s)), digital signal processor(s) (DSP(s)), graphics processing unit(s) (GPU(s)), central processor unit(s) (CPU(s)), semiconductor-based (e.g., silicon-based) circuit(s), digital circuit(s), analog circuit(s), logic circuit(s), and/or integrated circuit(s) implemented via any type(s) and/or any number(s) of transistor(s), capacitor(s), diode(s), inductor(s), resistor(s), timer(s), counter(s), printed circuit board(s), connector(s), wire(s), and/or other electrical circuit component(s).

As used herein, the terms “non-transitory computer-readable medium” and “non-transitory computer-readable storage medium” are expressly defined to include any type of computer-readable storage device and/or storage disk and to exclude propagating signals and to exclude transmission media.

As used herein, the terms “substantially” and/or “approximately” modify their subjects and/or values to recognize the potential presence of variations that occur in real world applications. For example, “substantially” and/or “approximately” may modify dimensions that may not be exact due to manufacturing tolerances and/or other real-world imperfections as will be understood by persons of ordinary skill in the art. For example, “substantially” and/or “approximately” may indicate such dimensions may be within a tolerance range of +/−10% unless otherwise specified in the description provided herein.

As used herein, the terms “including” and “comprising” (and all forms and tenses thereof) are open-ended terms. Thus, whenever the written description or a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or method actions may be implemented by, for example, the same entity or object. Additionally, although individual features may be included in different examples or claims, these may possibly be combined, and the inclusion in different examples or claims does not imply that a combination of features is not feasible and/or advantageous.

The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein, when the phrase “at least” is used as the transition term in, for example, a preamble of a claim, it is open-ended in the same manner as the term “comprising” and “including” are open-ended. As used herein in the context of describing structures, components, items, objects, and/or things, the phrase “at least one of A and B” is intended to refer to implementations including any of (1) at least one A, (2) at least one B, or (3) at least one A and at least one B. Similarly, as used herein in the context of describing structures, components, items, objects, and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, and/or steps, the phrase “at least one of A or B” is intended to refer to implementations including any of (1) at least one A, (2) at least one B, or (3) at least one A and at least one B.

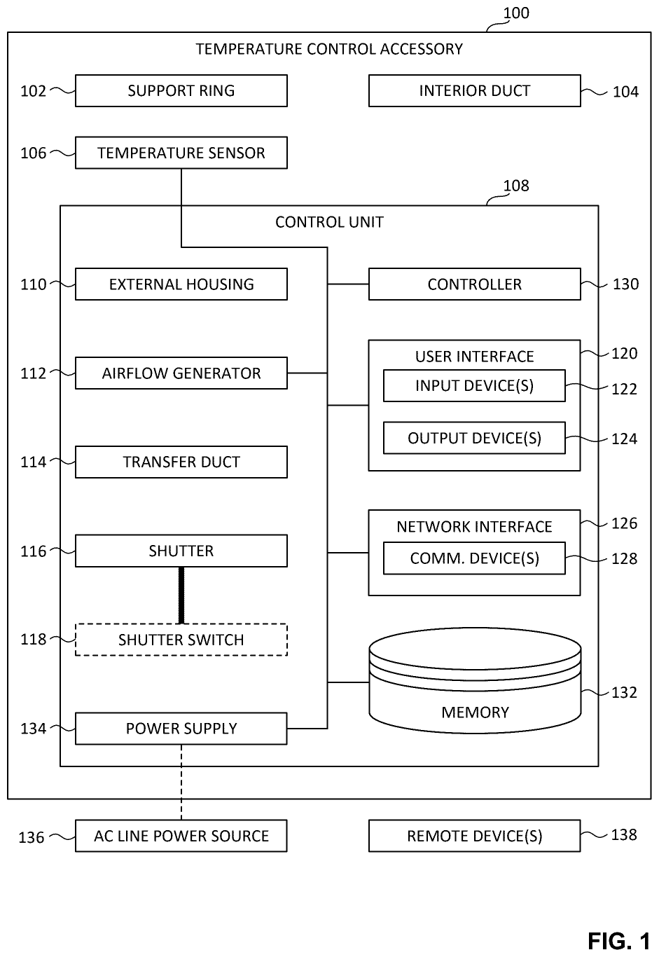

FIG. 1 is a block diagram of an example temperature control accessory 100 constructed in accordance with the teachings of this disclosure. The temperature control accessory 100 of FIG. 1 is configured for use with and/or installation on a charcoal-fueled kettle grill, as further described herein. In the illustrated example of FIG. 1, the temperature control accessory 100 includes an example support ring 102, an example interior duct 104, an example temperature sensor 106, and an example control unit 108. The control unit 108 includes an example external housing 110 that houses, supports, and/or carries one or more component(s) of the control unit 108, as further described herein. When the temperature control accessory 100 is used with and/or installed on a kettle grill, the support ring 102 interposes and/or extends between a firebox and a lid of the kettle grill, the interior duct 104 extends from and/or is located internally relative to (e.g., radially inward from) the support ring 102, a sensing portion of the temperature sensor 106 extends from and/or is located internally relative to (e.g., radially inward from) the support ring 102, and the external housing 110 of the control unit 108 extends from and/or is located externally relative to (e.g., radially outward from) the support ring 102 and/or externally relative to an exterior surface of the firebox of the kettle grill. In addition to being located internally relative to the support ring 102, the interior duct 104 is also located internally relative to (e.g., radially inward from) an interior surface of the firebox of the kettle grill, with the interior duct 104 extending downwardly from the support ring 102 along the interior surface of the firebox.

The support ring 102 of the temperature control accessory 100 of FIG. 1 includes a sidewall, an upper rim, and a lower rim, with the lower rim being located opposite the upper rim. The sidewall of the support ring 102 extends between, terminates in, and/or defines the upper rim and the lower rim of the support ring 102. In some examples, the support ring is configured as an open cylinder, with the upper rim and the lower rim constituting the open ends of the open cylinder. In some such examples, the sidewall of the support ring 102 defines an outer diameter and/or an outer circumference of the support ring 102. The sidewall of the support ring 102 of FIG. 1 is configured to support and/or carry the interior duct 104, a portion of the temperature sensor 106, and/or the control unit 108 of the temperature control accessory 100.

In some examples, the support ring 102 includes one or more first opening(s) (e.g., one or more first through hole(s)) formed in and/or extending through the sidewall of the support ring 102, with the one or more first opening(s) being configured to receive a corresponding one or more fastener(s) to couple and/or mount the interior duct 104 and/or the control unit 108 to the sidewall of the support ring 102. In some examples, the support ring 102 further includes a second opening (e.g., a second through hole) formed in and/or extending through the sidewall of the support ring 102, with the second opening being configured to enable a pressurized flow of air generated by the control unit 108 (e.g., by an airflow generator of the control unit 108) to travel along an airflow pathway extending from an outlet of the control unit 108, through the second opening formed in the sidewall of the support ring 102, and into an inlet of the interior duct 104. In this regard, the control unit 108 is generally located externally relative to (e.g., radially outward from) the sidewall of the support ring 102, and the interior duct 104 is generally located internally relative to (e.g., radially inward from) the sidewall of the support ring 102.

When the temperature control accessory 100 of FIG. 1 is used with and/or installed on a kettle grill having a firebox and a lid, the sidewall of the support ring 102 of FIG. 1 is located and/or extends between the firebox and the lid, with the support ring 102 being seated on and/or otherwise supported by the firebox of the kettle grill, and with the lid of the kettle grill being seated on and/or otherwise supported by the support ring 102. In some examples, the firebox of the kettle grill is a bowl-shaped firebox having an upper rim, and the lid of the kettle grill is a dome-shaped lid having a lower rim. In some such examples, the lower rim of the support ring 102 is configured to interface with the firebox, and the upper rim of the support ring 102 is configured to interface with the lid. In some such examples, the lower rim of the support ring 102 is configured to be seated onto, circumscribed by, and/or nested within the upper rim of the firebox, and the upper rim of the support ring 102 is configured to be seated under, circumscribed by, and/or nested within the lower rim of the lid. Alternatively, the lower rim of the support ring 102 can be configured to circumscribe the upper rim of the firebox, and/or the upper rim of the support ring 102 can be configured to circumscribe the lower rim of the lid. In some of the aforementioned examples, the upper rim of the support ring 102, the lower rim of the support ring 102, the upper rim of the firebox, and the lower rim of the lid are each configured to have a circular shape.

The interior duct 104 of the temperature control accessory 100 of FIG. 1 is coupled (e.g., via one or more fastener(s)) to the sidewall of the support ring 102, with the interior duct 104 being located internally relative to (e.g., radially inward from) the sidewall of the support ring 102. The interior duct 104 is configured to receive a pressurized flow of air generated by the control unit 108 of the temperature control accessory 100 of FIG. 1 (e.g., by an airflow generator of the control unit 108), and to thereafter guide, direct, and/or otherwise carry the received pressurized flow of air to and/or toward charcoal fuel (e.g., charcoal briquettes) located within a firebox of a kettle grill.

In some examples, the interior duct 104 of FIG. 1 includes a first end, a second end located opposite the first end, and a sidewall extending between the first end and the second end. The first end of the interior duct 104 includes an inlet configured to receive the pressurized flow of air generated by the control unit 108. The second end of the interior duct 104 includes an outlet configured to expel the pressurized flow of air as it reaches the second end of the interior duct 104. In this regard, the first end and/or the inlet of the interior duct 104 is/are located proximate to (e.g., adjacent to or in contact with) the sidewall of the support ring 102, with the inlet of the interior duct 104 being aligned with and/or otherwise being in fluid communication with the second opening formed in the sidewall of the support ring 102. The sidewall of the interior duct 104 extends downwardly from the support ring 102 such that the second end and/or the outlet of the interior duct 104 is/are located below (e.g., axially downward from) the support ring 102 (e.g., below the lower rim of the support ring 102). The outlet of the interior duct 104 guides, directs, and/or otherwise supplies the pressurized flow of air to or toward charcoal fuel (e.g., charcoal briquettes) located within (e.g., near the bottom of) a firebox of a kettle grill. In some examples, the outlet of the interior duct 104 is vertically oriented at a normal angle (e.g., perpendicular) relative to a surrounding area of an interior surface of the firebox of the kettle grill such that the outlet and/or, more generally, the interior duct 104 generates a cyclonic pressurized flow of air within the firebox. In some examples, the interior duct 104 is configured as a rigid (e.g., non-flexible) conduit having a generally rectangular cross-sectional profile along the length of the interior duct 104 (e.g., moving from the first end and/or the inlet of the interior duct 104 toward the second end and/or the outlet of the interior duct 104).

When the temperature control accessory 100 of FIG. 1 is used with and/or installed on a kettle grill, a cooking chamber is formed by the firebox and the lid of the kettle grill along with the support ring 102 of the temperature control accessory 100, with the support ring 102 interposing and/or extending between the firebox and the lid. The cooking chamber is configured to cook (e.g., grill) one or more item(s) of food contained therein. In some examples, the lid is movable relative to the firebox and/or relative to the support ring 102 between a closed position and an open position. In such examples, the cooking chamber becomes accessible to a user of the kettle grill when the lid is moved from the closed position toward or into the open position. Conversely, the cooking chamber is generally inaccessible to the user of the kettle grill when the lid is in the closed position. User access to the cooking chamber of the kettle grill may periodically become necessary, for example, to add an item of food to the cooking chamber (e.g., at or toward the beginning of a cooking process), to remove an item of food from the cooking chamber (e.g., at or toward the end of a cooking process), and/or to flip, rotate, relocate, or otherwise move an item of food within the cooking chamber (e.g., during the middle of a cooking process). The cooking chamber of the kettle grill can be of any configuration suitable for supporting, holding, and/or containing one or more cooking surface(s) (e.g., one or more cooking grate(s)) and/or one or more fuel support surface(s) (e.g., one or more fuel grate(s)) to be located therein, and/or one or more item(s) of food to be cooked therein.

The temperature sensor 106 of the temperature control accessory 100 of FIG. 1 senses, measures, and/or detects the temperature (e.g., a measured temperature) within a cooking chamber of a kettle grill. In some examples, the temperature sensor 106 is implemented by and/or as a thermocouple having a sensing portion (e.g., a sensing tip) that extends into and/or is located within the cooking chamber of the kettle grill, with the cooking chamber being defined collectively by a firebox of the kettle grill, by a lid of the kettle grill, and by the support ring 102 of the temperature control accessory 100 of FIG. 1. In some examples, the temperature sensor 106 is configured to be coupled and/or mounted (e.g., via a sensor mounting bracket) to the support ring 102 of the temperature control accessory 100 such that at least the sensing portion of the temperature sensor 106 is located internally relative to (e.g., radially inward from) the sidewall of the support ring 102. In other examples, the temperature sensor 106 can instead be configured to be coupled and/or mounted to the firebox of the kettle grill, to the lid of the kettle grill, or to a cooking grate located within the cooking chamber of the kettle grill. In some examples, a non-sensing portion (e.g., a portion of a cable or a connector) of the temperature sensor 106 is located within, housed by, and/or carried by the external housing 110 of the control unit 108. Data, information, and/or signals sensed, measured, and/or detected by the temperature sensor 106 of the temperature control accessory 100 can be of any quantity, type, form, and/or format. Data, information, and/or signals sensed, measured, and/or detected by the temperature sensor 106 of the temperature control accessory 100 can be transmitted to and/or stored at the control unit 108 of the temperature control accessory 100.

The control unit 108 of the temperature control accessory 100 of FIG. 1 is configured to control a temperature within a cooking chamber of a charcoal-fueled kettle grill by regulating a measured temperature sensed and/or detected (e.g., via the temperature sensor 106) from within the cooking chamber relative to a temperature setpoint (e.g., as selected and/or otherwise indicated via a user of the temperature control accessory 100). In the illustrated example of FIG. 1, the control unit 108 includes the external housing 110, an example airflow generator 112, an example transfer duct 114, an example shutter 116, an example user interface 120 (e.g., including one or more example input device(s) 122 and one or more example output device(s) 124), an example network interface 126 (e.g., including one or more example communication device(s) 128), an example controller 130, example memory 132, and an example power supply 134. In other examples, one or more of the aforementioned component(s) of FIG. 1 can be omitted from the control unit 108 and/or, more generally, from the temperature control accessory 100. In still other examples, the control unit 108 and/or, more generally, the temperature control accessory 100 can include one or more other component(s) in addition to or in lieu of the aforementioned components of FIG. 1. For example, the control unit 108 of FIG. 1 can also optionally include an example shutter switch 118. The control unit 108 and/or, more generally, the temperature control accessory 100 of FIG. 1 is configured to communicate (e.g., wirelessly communicate) with one or more example remote device(s) 138, as further described below.

One or more component(s) (e.g., the external housing 110 and/or the transfer duct 114) of the control unit 108 of the temperature control accessory 100 of FIG. 1 is/are coupled (e.g., via one or more fastener(s)) to the sidewall of the support ring 102, with at least the external housing 110 of the control unit 108 being located externally relative to the sidewall of the support ring 102 and/or externally relative to an exterior surface of the firebox of the kettle grill. In some examples, the external housing 110 of the control unit 108 is located radially outward from the sidewall of the support ring 102. In other examples, the external housing 110 of the control unit 108 can instead be coupled to and/or located along the exterior surface of the firebox of the kettle grill, or coupled to and/or located along a component (e.g., a handle, an ash catcher, etc.) that itself is coupled and/or located along the exterior surface of the firebox of the kettle grill.

The airflow generator 112 of the control unit 108 of FIG. 1 generates a pressurized flow of air that is directed and/or transferred from an outlet of the airflow generator 112 toward and/or into an inlet of the transfer duct 114 of the control unit 108. In some examples, the airflow generator 112 of the control unit 108 is implemented as a blower. In some such examples, the blower is a DC-powered, variable speed blower that is powered by the power supply 134 of the control unit 108 and controlled by the controller 130 of the control unit 108. In other examples, the airflow generator 112 of the control unit 108 is implemented as a fan. In some such other examples, the fan is a DC-powered, variable speed fan that is powered by the power supply 134 of the control unit 108 and controlled by the controller 130 of the control unit 108. In some examples, the airflow generator 112 is coupled to, located within, housed by, and/or carried by the external housing 110 of the control unit 108. In some such examples, the external housing 110 includes one or more opening(s) (e.g., one or more through hole(s)) formed in and/or extending through the external housing 110, with said one or more opening(s) being configured to enable air from the surrounding atmosphere to be drawn into the airflow generator 112.

The transfer duct 114 of the control unit 108 of FIG. 1 extends between the outlet of the airflow generator 112 of the control unit 108 and the sidewall of the support ring 102. In some examples, the transfer duct 114 of the control unit 108 of FIG. 1 is coupled (e.g., via one or more fastener(s)) to the sidewall of the support ring 102, with the transfer duct 114 being located externally relative to (e.g., radially outward from) the sidewall of the support ring 102. In some examples, the transfer duct 114 is coupled to, located within, housed by, and/or carried by the external housing 110 of the control unit 108. The transfer duct 114 is configured to receive the pressurized flow of air generated by the airflow generator 112 of the control unit 108, and to thereafter transport, guide, direct, and/or otherwise carry the received pressurized flow of air to and/or toward the sidewall of the support ring 102 and/or the inlet of the interior duct 104 of the temperature control accessory 100.

In some examples, the transfer duct 114 of FIG. 1 includes a first end, a second end located opposite the first end, and a flow chamber extending between the first end and the second end. The first end of the transfer duct 114 includes an inlet configured to receive the pressurized flow of air generated by the airflow generator 112. The inlet of the transfer duct 114 is accordingly in fluid communication with an outlet of the airflow generator 112. The second end of the transfer duct 114 includes an outlet configured to expel the pressurized flow of air as it reaches the second end of the transfer duct 114. In this regard, the second end and/or the outlet of the transfer duct 114 is/are located proximate to (e.g., adjacent to or in contact with) the sidewall of the support ring 102, with the outlet of the transfer duct 114 being aligned with and/or otherwise being in fluid communication with the second opening formed in the sidewall of the support ring 102. The outlet of the transfer duct 114 is also aligned with and/or is otherwise in fluid communication with the inlet of the interior duct 104 such that the pressurized flow of air generated by the airflow generator 112 of the control unit 108 travels, passes, and/or is directed from the outlet of the airflow generator 112 toward and/or into the inlet of the transfer duct 114, from the inlet of the transfer duct 114 toward and/or into the outlet of the transfer duct 114 (e.g., via the flow chamber of the transfer duct 114), from the outlet of the transfer duct 114 through the second opening formed in the sidewall of the support ring 102 toward and/or into the inlet of the interior duct 104, from the inlet of the interior duct 104 toward and/or into the outlet of the interior duct 104, and from the outlet of the interior duct 104 toward and/or into a cooking chamber of a kettle grill on which the temperature control accessory 100 is installed.

Once the temperature control accessory 100 has been installed on a kettle grill, the airflow generator 112 of the control unit 108 can selectively be activated (e.g., turned “ON”) or deactivated (e.g., turned “OFF”) via one or more command(s), instruction(s), and/or signal(s) transmitted to the airflow generator 112 from the controller 130. When the airflow generator 112 is activated, the airflow generator 112 generates a pressurized flow of air (e.g., a positive airflow) that travels from the airflow generator 112 downstream through the transfer duct 114 and the interior duct 104 of the temperature control accessory 100 into the cooking chamber of the kettle grill. The pressurized flow of air generated by the activated airflow generator 112 minimizes (e.g., reduces, limits, or prevents) heated air located within the cooking chamber of the kettle grill from migrating upstream back through the interior duct 104 and the transfer duct 114 of the temperature control accessory 100 toward the various electrical and/or electromechanical component(s) of the control unit 108 of the temperature control accessory 100. Such components, which include the airflow generator 112, the user interface 120 (e.g., including the input device(s) 122 and the output device(s) 124), the network interface 126 (e.g., including the communication device(s) 128), the controller 130, the memory 132, and/or the power supply 134 of the control unit 108 are accordingly protected from exposure to undesirably hot and/or elevated temperatures while the airflow generator 112 of the control unit 108 is activated.

When the airflow generator 112 is deactivated, the airflow generator 112 no longer generates a pressurized flow of air (e.g., a positive airflow) that travels from the airflow generator 112 downstream through the transfer duct 114 and the interior duct 104 of the temperature control accessory 100 into the cooking chamber of the kettle grill. In the absence of such a pressurized flow of air traveling through the transfer duct 114 and the interior duct 104 of the temperature control accessory 100, heated air located within the cooking chamber of the kettle grill can potentially migrate upstream back through the interior duct 104 and the transfer duct 114 of the temperature control accessory 100 toward the various electrical and/or electromechanical component(s) of the control unit 108 of the temperature control accessory 100 which, as mentioned above, can include the airflow generator 112, the user interface 120 (e.g., including the input device(s) 122 and the output device(s) 124), the network interface 126 (e.g., including the communication device(s) 128), the controller 130, the memory 132, and/or the power supply 134 of the control unit 108. Such component(s) can therefore potentially be exposed to undesirably hot and/or elevated temperatures while the airflow generator 112 of the control unit 108 is deactivated.

To mitigate (e.g., prevent) the possibility of such adverse temperature exposure, the control unit 108 is equipped with a cooling system that can advantageously be activated, engaged, and/or otherwise implemented while the airflow generator 112 of the control unit 108 is not activated (e.g., while the airflow generator 112 is deactivated and/or turned “OFF”). In the illustrated example of FIG. 1, the cooling system of the control unit 108 is implemented via the shutter 116 of the control unit 108. In some examples, the shutter 116 is movable (e.g., slidable) relative to the transfer duct 114 of the control unit 108 between a non-blocking position and a blocking position. Positioning the shutter 116 in the non-blocking position causes an opening formed in a panel of the shutter 116 to be aligned with and/or to otherwise be in fluid communication with a flow chamber of the transfer duct 114. The alignment between the opening of the panel of the shutter 116 and the flow chamber of the transfer duct 114 enables a pressurized flow of air to travel through the flow chamber of the transfer duct 114 (e.g., from an inlet of the transfer duct 114 to an outlet of the transfer duct 114) without the pressurized flow of air being blocked, impeded, restricted, and/or otherwise obstructed by the panel of the shutter 116. It is accordingly advantageous for the shutter 116 to be positioned in the non-blocking position at times when the airflow generator 112 of the control unit 108 is activated and/or turned “ON.” Conversely, positioning the shutter 116 in the blocking position causes the opening of the panel of the shutter 116 to no longer be aligned with and/or to no longer be in fluid communication with the flow chamber of the transfer duct 114. The lack of alignment between the opening of the panel of the shutter 116 and the flow chamber of the transfer duct 114 results in a pressurized flow of air that would otherwise travel through the flow chamber of the transfer duct 114 (e.g., from the inlet of the transfer duct 114 to the outlet of the transfer duct 114) being blocked, impeded, restricted, and/or otherwise obstructed by the panel of the shutter 116. It is accordingly advantageous for the shutter 116 to be positioned in the blocking position at times when the airflow generator 112 of the control unit 108 is deactivated and/or turned “OFF,” thereby mitigating (e.g., eliminating) the possibility of any electrical and/or electromechanical component(s) of the control unit 108 being exposed to adverse temperature conditions.

In some examples, movement (e.g., sliding) of the shutter 116 of the control unit 108 relative to the transfer duct 114 of the control unit 108 between the non-blocking position and the blocking position is facilitated via a tab of the shutter 116. In this regard, the tab of the shutter 116 effectively functions as a switch (e.g., the shutter switch 118 of FIG. 1) that is movable between a first position (e.g., a pushed rearward position) associated with the non-blocking position of the shutter 116 and a second position (e.g., a pulled forward position) associated with the blocking position of the shutter 116. In some examples, the tab of the shutter 116 is preferably located along a portion of the control unit 108 that is readily accessible to a user of the control unit 108, such as a front portion of the external housing 110 of the control unit 108. In other examples, the tab of the shutter 116 can be omitted and/or eliminated entirely, with operation of the shutter 116 being automated by the controller 130 of the control unit 108. For example, the controller 130 of the control unit 108 can be configured to automatically command, instruct, signal, and/or otherwise cause (e.g., via one or more motor(s), one or more solenoid(s), etc.) the shutter 116 to assume the non-blocking position in response to the controller 130 determining and/or detecting that the airflow generator 112 of the control unit 108 has been activated and/or turned “ON,” and/or to automatically command, instruct, signal, and/or otherwise cause (e.g., via one or more motor(s), one or more solenoid(s), etc.) the shutter 116 to assume the blocking position in response to the controller 130 determining and/or detecting that the airflow generator 112 of the control unit 108 has been deactivated and/or turned “OFF.”

In some examples, movement of the tab of the shutter 116 from the first position toward and/or into the second position can be facilitated by a user pushing the tab toward the transfer duct 114 of the control unit 108. Pushing the tab toward the transfer duct 114 causes the panel of the shutter 116 to slide within a slot of the transfer duct 114 in a first direction that is crosswise (e.g., transverse) relative to a central axis of the flow chamber of the transfer duct 114, with such sliding movement continuing until the opening of the panel of the shutter 116 is positioned in alignment with the flow chamber of the transfer duct 114. Conversely, movement of the tab of the shutter 116 from the second position toward and/or into the first position can be facilitated by a user pulling the tab away from the transfer duct 114 of the control unit 108. Pulling the tab away from the transfer duct 114 causes the panel of the shutter 116 to slide within the slot of the transfer duct 114 in a second direction that is crosswise (e.g., transverse) relative to the central axis of the flow chamber of the transfer duct 114, with such sliding movement continuing until the opening of the panel of the shutter 116 is no longer positioned in alignment with the flow chamber of the transfer duct 114.

In implementations of the control unit 108 that include the shutter switch 118, the shutter switch 118 is configured to transition the shutter 116 of the control unit 108 between its non-blocking and blocking positions described above. In this regard, the shutter switch 118 of the control unit 108 is mechanically coupled (either directly or indirectly) to the shutter 116 of the control unit 108 such that a movement of the shutter switch 118 causes a corresponding or associated movement of the above-described panel of the shutter 116. In some examples, the shutter switch 118 is movable (e.g., slidable) between a first position and a second position. Positioning the shutter switch 118 in the first position causes the shutter 116 to assume the non-blocking position. Conversely, positioning the shutter switch 118 in the second position causes the shutter 116 to assume the blocking position. The shutter switch 118 of the control unit 108 is preferably located along a portion of the control unit 108 that is readily accessible to a user of the control unit 108, such as along a front portion or along a top portion of the external housing 110 of the control unit 108.

In some examples, the shutter 116 and the shutter switch 118 are mechanical components, with the respective position(s) of the shutter 116 being mechanically dependent upon the position of the shutter switch 118. In other examples, the shutter 116 and/or the shutter switch 118 can instead be implemented as one or more electromechanical component(s) that is/are operatively coupled to (e.g., in electrical communication with) the controller 130, with the shutter switch 118 not being mechanically coupled to the shutter 116. In such other examples, the shutter switch 118 permits the user of the control unit 108 and/or the temperature control accessory 100 to enter data, inputs, instructions, and/or commands associated with and/or indicative of one or more desired position(s) of the shutter 116. In response to receiving such data, inputs, instructions, and/or commands from the shutter switch 118, the controller 130 commands, instructs, signals, and/or otherwise causes the shutter 116 to assume the indicated position(s).

The user interface 120 of the control unit 108 of FIG. 1 enables a user of the control unit 108 and/or the temperature control accessory 100 to interact with the controller 130 of the control unit 108. In the illustrated example of FIG. 1, the user interface 120 is operatively coupled to (e.g., in electrical communication with) the controller 130 and/or the memory 132 of the control unit 108. In some examples, the user interface 120 is mechanically coupled to (e.g., fixedly connected to) the control unit 108. For example, the user interface 120 can be coupled and/or mounted to an external housing 110 of the control unit 108. The user interface 120 is preferably mounted to a portion of the control unit 108 that is readily accessible to a user of the control unit 108, such as a front portion or a top portion of the external housing 110 of the control unit 108. In some examples, respective ones of the input device(s) 122 and/or the output device(s) 124 of the user interface 120 can be mounted to different portions of the control unit 108 and/or, more generally, to different potions of the temperature control accessory 100. The architecture and/or operations of the user interface 120 can be distributed among any number of user interfaces respectively having any number of input device(s) 122 and/or output device(s) 124 located at and/or mounted to any portion of the control unit 108 and/or the temperature control accessory 100.

The input device(s) 122 of the user interface 120 of FIG. 1 permit(s) the user of the control unit 108 and/or the temperature control accessory 100 to enter data, information, selections, inputs, instructions, and/or commands into the controller 130. For example, the input device(s) 122 of the user interface 120 can permit the user of the control unit 108 to enter data, information, one or more selection(s), one or more input(s), one or more instruction(s), and/or one or more command(s) into the controller 130 that cause(s) the controller 130 to implement (e.g., to initiate, to execute, and/or to terminate) one or more process(es) (e.g., one or more process(es) and/or protocol(s) configured to control one or more operation(s)) of the control unit 108 and/or the temperature control accessory 100. The input device(s) 122 of the user interface 120 can be implemented, for example, by one or more of a touchscreen, a button, a dial, a knob, a switch, an audio sensor, a microphone, an image sensor, a camera, and/or a voice recognition system. The shutter switch 118 of the control unit 108 can also function as one of the input device(s) 122 of the user interface 120 in instances where the shutter switch 118 is implemented as an electrical or electromechanical component.

The output device(s) 124 of the user interface 120 of FIG. 1 facilitate(s) the presentation of data and/or information (e.g., data and/or information generated by the controller 130) to the user of the control unit 108 and/or the temperature control accessory 100. For example, the output device(s) 124 of the user interface 120 can facilitate the presentation (e.g., textually, graphically, and/or audibly) of data and/or information (e.g., one or more notification(s), alert(s), and/or message(s)) associated with implementing (e.g., initiating, executing, and/or terminating) one or more process(es) (e.g., one or more process(es) and/or protocol(s) configured to control one or more operation(s)) of the control unit 108 and/or the temperature control accessory 100. The output device(s) 124 of the user interface 120 can be implemented, for example, by one or more of a display device (e.g., a light emitting diode (LED), an organic light emitting diode (OLED), a liquid crystal display (LCD), a cathode ray tube (CRT) display, an in-plane switching (IPS) display, a touchscreen, etc.), a tactile output device, and/or a speaker.

The network interface 126 of the control unit 108 of FIG. 1 enables a user of the control unit 108 and/or the temperature control accessory 100 to remotely interact (e.g., via one or more of the remote device(s) 138) with the control unit 108 and/or the temperature control accessory 100. In the illustrated example of FIG. 1, the network interface 126 is operatively coupled to (e.g., in electrical communication with) the controller 130 and/or the memory 132 of the control unit 108. The network interface 126 of FIG. 1 includes one or more communication device(s) 128 (e.g., transmitter(s), receiver(s), transceiver(s), modem(s), gateway(s), wireless access point(s), etc.) to facilitate the exchange of data with external machines (e.g., computing devices of any kind, including the remote device(s) 138 of FIG. 1) by a wired or wireless communication network. Communications transmitted and/or received via the communication device(s) 128 and/or, more generally, via the network interface 126 can be made over and/or carried by, for example, an Ethernet connection, a digital subscriber line (DSL) connection, a telephone line connection, a coaxial cable system, a satellite system, a wireless system, a cellular telephone system, an optical connection, etc.

The controller 130 of the control unit 108 of FIG. 1 implements processor circuitry to control and/or manage one or more operation(s) associated with the control unit 108 of FIG. 1 and/or the components thereof, including the airflow generator 112, the user interface 120 (e.g., including the input device(s) 122 and the output device(s) 124), the network interface 126 (e.g., including the communication device(s) 128), the memory 132, and/or the power supply 134 of the control unit 108 of FIG. 1. The processor circuitry of the controller 130 of FIG. 1 includes any type(s) and/or any number(s) of processor(s), microprocessor(s), controller(s), microcontroller(s), ASIC(s), PLD(s), FPLD(s), FPGA(s), DSP(s), GPU(s), CPU(s), semiconductor-based (e.g., silicon-based) circuit(s), digital circuit(s), analog circuit(s), logic circuit(s), and/or integrated circuit(s) implemented by any type(s) and/or any number(s) of transistor(s), capacitor(s), diode(s), inductor(s), resistor(s), timer(s), counter(s), printed circuit board(s), connector(s), wire(s), and/or other electrical circuit component(s). In some examples, the controller 130 (e.g., including the processor circuitry thereof) is coupled to, located within, housed by, and/or carried by the external housing 110 of the control unit 108.

In the illustrated example of FIG. 1, the controller 130 is graphically represented as a single, discrete structure that manages and/or controls the operation(s) of various components of the control unit 108. It is to be understood, however, that in other examples, the architecture and/or operations of the controller 130 can be distributed among any number of controllers, with each separate controller having a dedicated subset of one or more operation(s) described herein. In some examples, the control unit 108 can include separate, distinct controllers for one or more of the airflow generator 112, the user interface 120 (e.g., including the input device(s) 122 and the output device(s) 124), the network interface 126 (e.g., including the communication device(s) 128), the controller 130, the memory 132, and/or the power supply 134 of the control unit 108 of FIG. 1.

In the illustrated example of FIG. 1, the controller 130 is operatively coupled to (e.g., in electrical communication with) one or more of the temperature sensor 106, the airflow generator 112, the user interface 120 (e.g., including the input device(s) 122 and the output device(s) 124), the network interface 126 (e.g., including the communication device(s) 128), the memory 132, and/or the power supply 134 of the control unit 108 and/or, more generally, the temperature control accessory 100 of FIG. 1. The controller 130 of FIG. 1 is also operatively coupled to (e.g., in wired or wireless electrical communication with) the remote device(s) 138 of FIG. 1 via the network interface 126 (e.g., including the communication device(s) 128) of the control unit 108 of FIG. 1. The controller 130 of FIG. 1 is configured to receive commands, instructions, signals, and/or data from, and/or to transmit commands, instructions, signals, and/or data to, the temperature sensor 106, the airflow generator 112, the user interface 120 (e.g., including the input device(s) 122 and the output device(s) 124), the network interface 126 (e.g., including the communication device(s) 128), the memory 132, and/or the power supply 134 of the control unit 108 and/or, more generally, the temperature control accessory 100 of FIG. 1 in connection with implementing (e.g., initiating, executing, and/or terminating) one or more protocol(s), process(es), program(s), sequence(s), subroutine(s), and/or method(s), as further described herein.

In some examples, the controller 130 of FIG. 1 controls, manages, executes, and/or performs one or more process(es), protocol(s), and/or program(s) associated with one or more operation(s) of the temperature control accessory 100. In some such process(es), protocol(s), and/or program(s), the controller 130 of FIG. 1 determines whether one or more control input(s) associated with one or more operation(s) of the temperature control accessory 100 of FIG. 1 has/have been received. For example, the controller 130 can determine whether the user interface 120 and/or the network interface 126 of the control unit 108 of FIG. 1 has/have received any commands, instructions, signals, inputs, and/or other data indicative of a control input associated with an operation of the temperature control accessory 100 (e.g., a desired ON/OFF state, a desired temperature, a desired airflow generator speed, a desired cooking mode, a desired cooking recipe, a desired cooking program, and/or any other state, setting, selection, mode, or program pertaining to an operation of the temperature control accessory 100).

If the controller 130 of FIG. 1 determines that one or more control input(s) associated with one or more operation(s) of the temperature control accessory 100 has/have been received, the controller 130 commands, instructs, signals, and/or otherwise causes one or more component(s) (e.g., the airflow generator 112) of the control unit 108 of FIG. 1 to operate in a manner that corresponds to, achieves, and/or otherwise implements respective ones of the received control input(s) which the controller 130 determined to be associated with the operation(s) of the temperature control accessory 100. For example, the controller 130 can command, instruct, signal, and/or otherwise cause the airflow generator 112 of the control unit 108 to operate at a specific rate and/or at specific rate(s) over one or more time interval(s) to achieve a controlled temperature within a cooking chamber of a kettle grill. In some examples, the controlled temperature is based on a temperature setpoint selected and/or otherwise indicated by a user of the temperature control accessory 100 and/or the kettle grill. In other examples, the controlled temperature may vary over time based on different steps of a cooking recipe, a cooking profile, or a cooking program that is conveyed to the controller 130 of the temperature control accessory 100. In some examples, the controller 130 considers and/or utilizes temperature data obtained from the temperature sensor 106 of the temperature control accessory 100 as an input to a control loop (e.g., a feedback input to a PID control loop) implemented by the controller 130 in connection with controlling the airflow generator 112 of the control unit 108 to achieve the controlled temperature within the cooking chamber of the kettle grill. In this regard, the controller 130 controls the operation of the airflow generator 112 to regulate a temperature measured from within the cooking chamber of the kettle grill relative to a specified temperature setpoint.

In some examples, the controller 130 of FIG. 1 additionally determines whether to continue operating the temperature control accessory 100. For example, the controller 130 can determine whether the user interface 120 and/or the network interface 126 of the control unit 108 of FIG. 1 has/have received any commands, instructions, signals, inputs, and/or other data indicative of a request to terminate one or more operation(s) of the temperature control accessory 100 (e.g., a request to cease operating the temperature control accessory 100). If the controller 130 determines that one or more operation(s) of the temperature control accessory 100 is/are to cease, the controller 130 causes such operation(s) to cease.

The memory 132 of the control unit 108 of FIG. 1 can be implemented by any type(s) and/or any number(s) of storage device(s) such as an optical storage device, a magnetic storage device, a floppy disk drive, a hard disk drive (HDD), a solid state storage device, a flash memory, a read-only memory (ROM), a random-access memory (RAM), a volatile memory, a non-volatile memory, a cache, a CD, a DVD, a Blu-ray disk, and/or any other tangible storage device or tangible storage disk in which information is stored for any duration (e.g., permanently, for extended time periods, for brief instances, for temporarily buffering, and/or for caching of the information). The information and/or data stored in the memory 132 of FIG. 1 can be stored in any file and/or data structure format, organization scheme, and/or arrangement. The memory 132 of FIG. 1 is accessible to one or more of the temperature sensor 106, the airflow generator 112, the user interface 120 (e.g., including the input device(s) 122 and the output device(s) 124), the network interface 126 (e.g., including the communication device(s) 128), the controller 130, and/or the power supply 134 of the control unit 108 and/or, more generally, the temperature control accessory 100 of FIG. 1. In some examples, the memory 132 is coupled to, located within, housed by, and/or carried by the external housing 110 of the control unit 108.

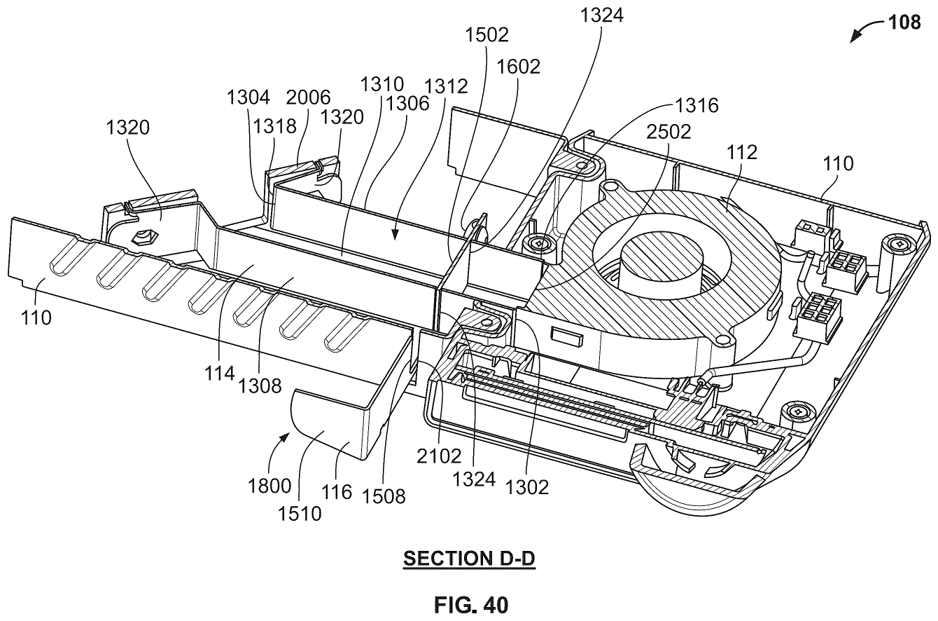

The memory 132 of the control unit 108 of FIG. 1 stores data sensed, measured, detected, generated, determined, computed, calculated, identified, presented, input, output, transmitted, and/or received by, to, and/or from the temperature sensor 106, the airflow generator 112, the user interface 120 (e.g., including the input device(s) 122 and the output device(s) 124), the network interface 126 (e.g., including the communication device(s) 128), the controller 130, and/or the power supply 134 of the control unit 108 and/or, more generally, the temperature control accessory 100 of FIG. 1. The memory 132 also stores instructions (e.g., computer-readable instructions) and associated data corresponding to one or more protocol(s), process(es), program(s), sequence(s), subroutine(s), and/or method(s) described below in connection with FIG. 40. The memory 132 can also store correlation data, threshold data, and/or settings data associated with such protocol(s), process(es), program(s), sequence(s), subroutine(s), and/or method(s).

The power supply 134 of the control unit 108 of FIG. 1 supplies power to one or more electrically-powered component(s) of the temperature control accessory 100, including the temperature sensor 106, the airflow generator 112, the user interface 120 (e.g., including the input device(s) 122 and the output device(s) 124), the network interface 126 (e.g., including the communication device(s) 128), the controller 130, and/or the memory 132 of FIG. 1. In some examples, the distribution of power from the power supply 134 to any of the aforementioned electrically-powered components of the temperature control accessory 100 can be controlled and/or managed by the user interface 120 and/or the controller 130. In some examples, the power supply 134 of FIG. 1 is implemented by a battery (or a plurality of batteries) dedicated to powering one or more of the aforementioned electrically-powered component(s) of the temperature control accessory 100. In other examples, the power supply 134 of FIG. 1 can instead be configured to receive AC power from an example AC line power source 136 (e.g., a wall outlet) to which the power supply 134 of the control unit 108 is electrically connected. In such other examples, the power supply 134 converts AC power received from the AC line power source 136 into DC power that can thereafter be supplied to one or more of the aforementioned electrically-powered component(s) of the temperature control accessory 100. In some examples, the power supply 134 is coupled to, located within, housed by, and/or carried by the external housing 110 of the control unit 108.

The remote device(s) 138 of FIG. 1 can be implemented by any type(s) and/or any number(s) of mobile or stationary computing devices. In this regard, examples of such remote device(s) 138 include a smartphone, a tablet, a laptop, a desktop, a cloud server, a wearable computing device, a wireless control hub, etc. The remote device(s) 138 of FIG. 1 facilitate(s) a remote (e.g., wired, or wireless) extension of the above-described user interface 120 of the control unit 108. In this regard, each remote device 138 includes one or more input device(s) and/or one or more output device(s) that mimic and/or enable a remotely-located version of the above-described functionality of the corresponding input device(s) 122 and/or the corresponding output device(s) 124 of the user interface 120 of the control unit 108. Accordingly, one or more input(s), selection(s), instruction(s), and/or command(s) received at the control unit 108 (e.g., via the communication device(s) 128 of the network interface 126 of the control unit 108) from the remote device(s) 138 can be entered and/or made via the input device(s) of the remote device(s) 138 much in the same way that such input(s), selection(s), instruction(s), and/or command(s) would be entered and/or made via the input device(s) 122 of the user interface 120 of the control unit 108. Similarly, one or more notification(s), prompt(s), request(s), and/or confirmation(s) transmitted from the control unit 108 (e.g., via the communication device(s) 128 of the network interface 126 of the control unit 108) to the remote device(s) 138 can be presented via the output device(s) of the remote device(s) 138 much in the same way that such notification(s), prompt(s), request(s), and/or confirmation(s) would be presented via the output device(s) 124 of the user interface 120 of the control unit 108.

While an example manner of implementing the temperature control accessory 100 is illustrated in FIG. 1, one or more of the elements, processes, and/or devices illustrated in FIG. 1 may be combined, divided, re-arranged, omitted, eliminated, and/or implemented in any other way. Further, the temperature sensor 106, the airflow generator 112, the user interface 120 (e.g., including the input device(s) 122 and the output device(s) 124), the network interface 126 (e.g., including the communication device(s) 128), the controller 130, the memory 132, the power supply 134, and/or, more generally, the control unit 108 and/or the temperature control accessory 100 of FIG. 1, may be implemented by hardware alone or by hardware in combination with software and/or firmware. Thus, for example, any of the temperature sensor 106, the airflow generator 112, the user interface 120 (e.g., including the input device(s) 122 and the output device(s) 124), the network interface 126 (e.g., including the communication device(s) 128), the controller 130, the memory 132, and/or the power supply 134 of FIG. 1 could be implemented at least in part by processor circuitry including any type(s) and/or any number(s) of processor(s), microprocessor(s), controller(s), microcontroller(s), ASIC(s), PLD(s), FPLD(s), FPGA(s), DSP(s), GPU(s), CPU(s), semiconductor-based (e.g., silicon-based) circuit(s), digital circuit(s), analog circuit(s), logic circuit(s), and/or integrated circuit(s) implemented by any type(s) and/or any number(s) of transistor(s), capacitor(s), diode(s), inductor(s), resistor(s), timer(s), counter(s), printed circuit board(s), connector(s), wire(s), and/or other electrical circuit component(s). Further still, the temperature control accessory 100 of FIG. 1 may include one or more element(s), component(s), and/or device(s) in addition to, or instead of, those illustrated in FIG. 1, and/or may include more than one of any or all of the illustrated element(s), component(s), and/or device(s).

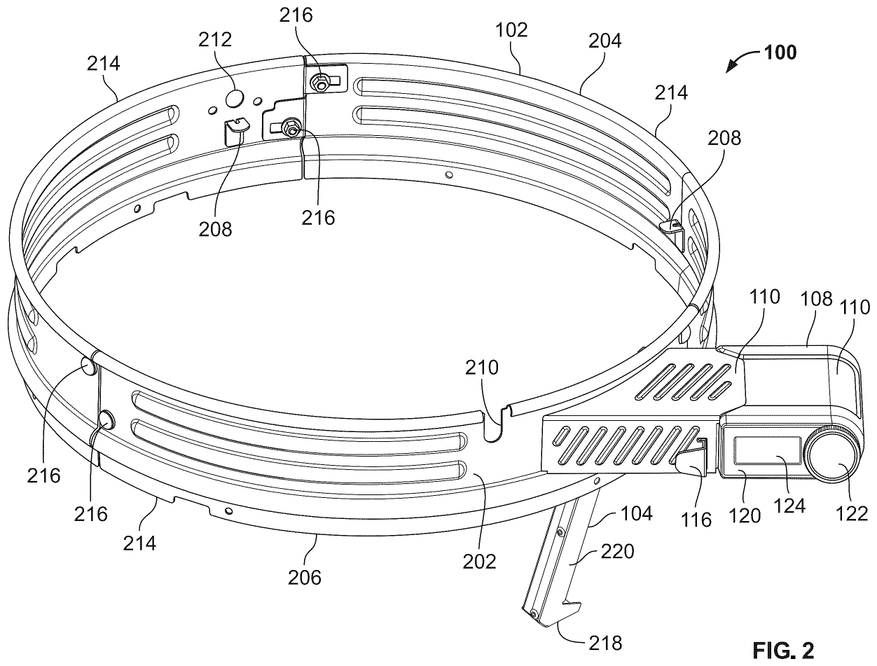

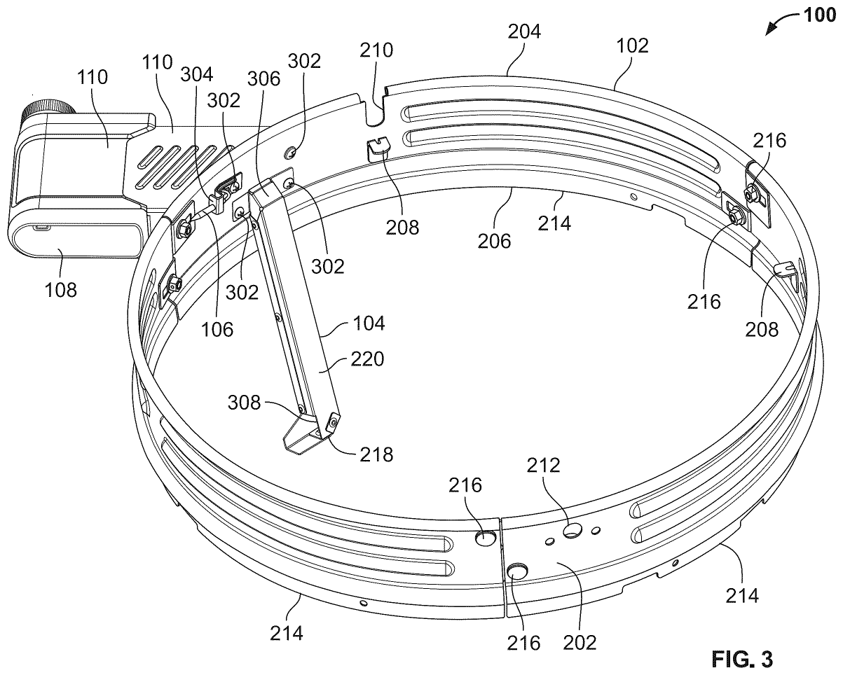

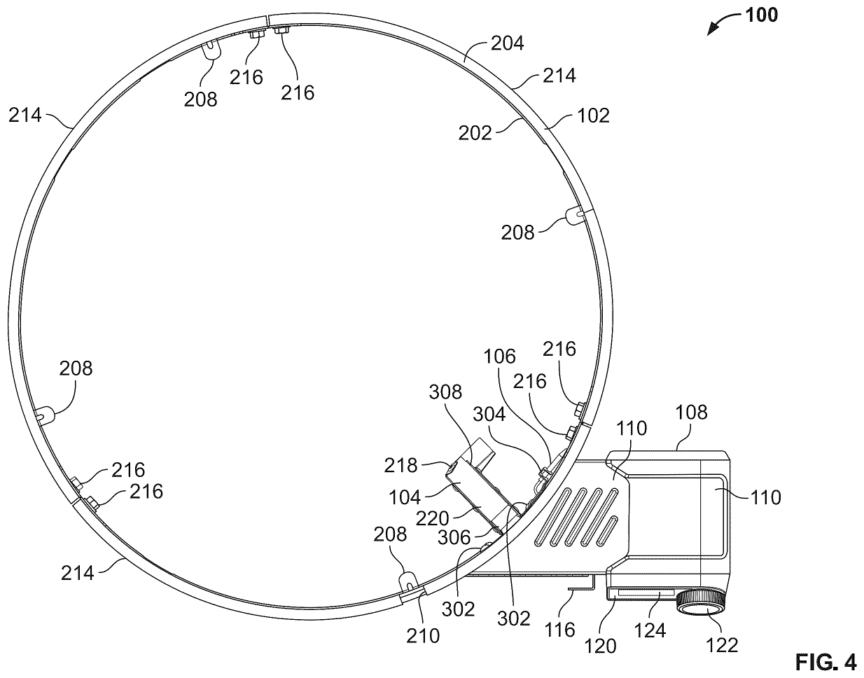

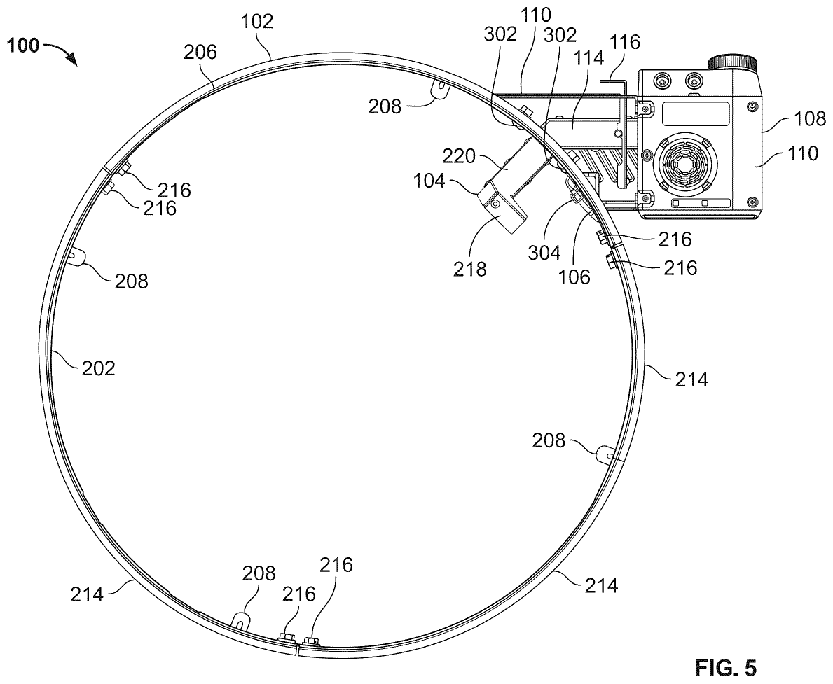

FIG. 2 is a first perspective view of an example implementation of the temperature control accessory 100 of FIG. 1. FIG. 3 is a second perspective view of the temperature control accessory 100 as shown in FIG. 2. FIG. 4 is a top view of the temperature control accessory 100 as shown in FIGS. 2 and 3. FIG. 5 is a bottom view of the temperature control accessory 100 as shown in FIGS. 2-4. The temperature control accessory 100 as shown in FIGS. 2-5 is configured for use with and/or installation on a charcoal-fueled kettle grill, as further described herein. As shown in FIGS. 2-5, the temperature control accessory 100 includes an example support ring 102, an example interior duct 104, and an example control unit 108. The control unit 108 includes an external housing 110 that houses, supports, and/or carries one or more component(s) of the control unit 108, as further described herein. When the temperature control accessory 100 shown in FIGS. 2-5 is used with and/or installed on a kettle grill, the support ring 102 interposes and/or extends between a firebox and a lid of the kettle grill, the interior duct 104 extends from and/or is located internally relative to (e.g., radially inward from) the support ring 102, a sensing portion of an example temperature sensor 106 (e.g., as described above in connection with FIG. 1) extends from and/or is located internally relative to (e.g., radially inward from) the support ring 102, and the external housing 110 of the control unit 108 extends from and/or is located externally relative to (e.g., radially outward from) the support ring 102 and/or externally relative to an exterior surface of the firebox of the kettle grill. In addition to being located internally relative to the support ring 102, the interior duct 104 is also located internally relative to (e.g., radially inward from) an interior surface of the firebox of the kettle grill, with the interior duct 104 extending downwardly from the support ring 102 along the interior surface of the firebox.

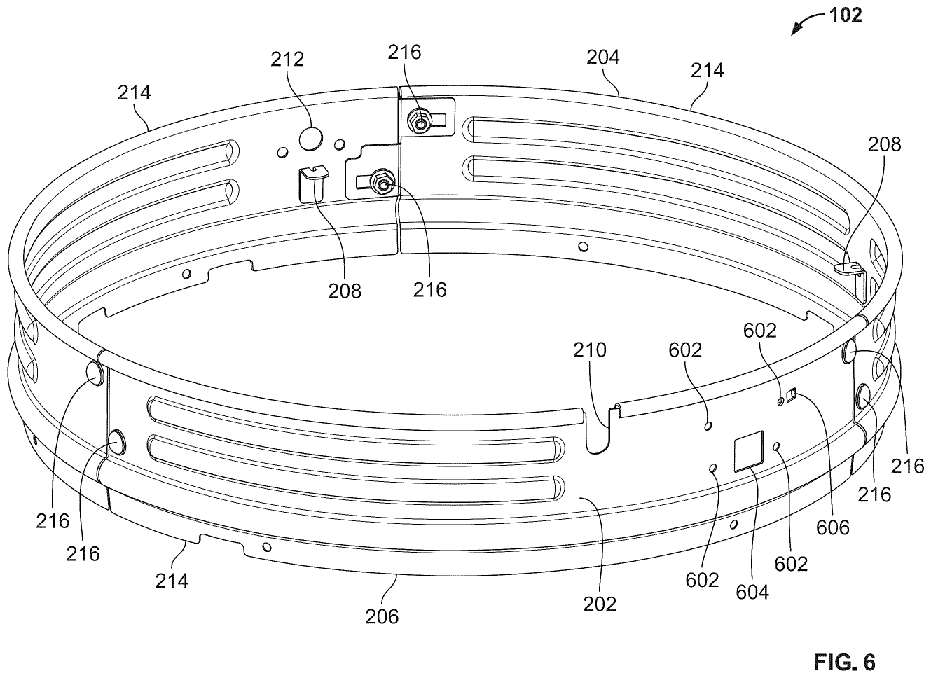

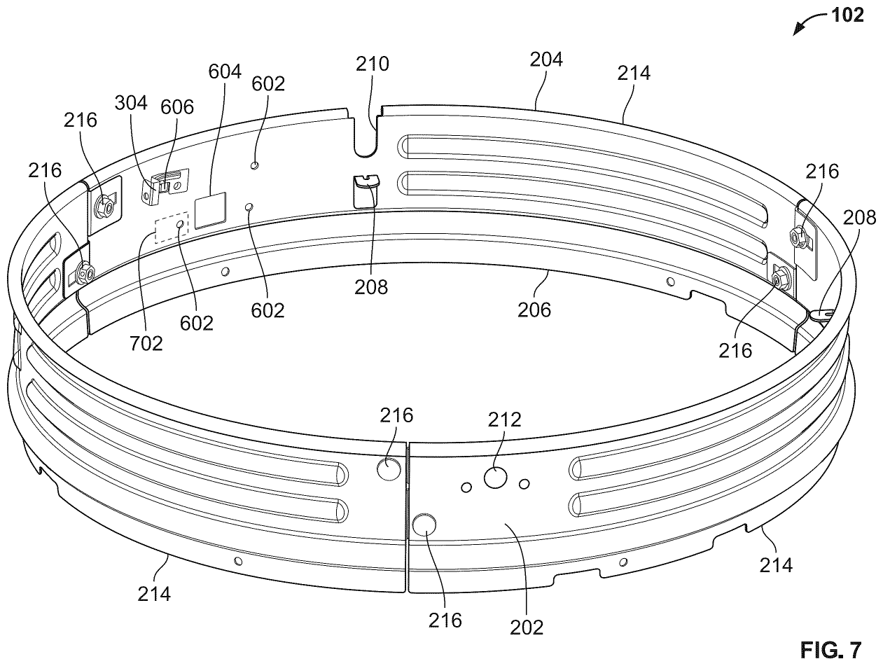

FIG. 6 is a first perspective view of the support ring 102 of the temperature control accessory 100 shown in FIGS. 2-5, with the support ring shown in isolation. FIG. 7 is a second perspective view of the support ring 102 as shown in FIG. 6. As shown in FIGS. 2-7, the support ring 102 of the temperature control accessory 100 includes an example sidewall 202, an example upper rim 204, and an example lower rim 206, with the lower rim 206 being located opposite the upper rim 204. The sidewall 202 of the support ring 102 extends between, terminates in, and/or defines the upper rim 204 and the lower rim 206 of the support ring 102. As shown in FIGS. 2-7, the support ring 102 is configured as an open cylinder, with the upper rim 204 and the lower rim 206 constituting the open ends of the open cylinder. As further shown in FIGS. 2-7, the sidewall 202 of the support ring 102 defines an outer diameter and/or an outer circumference of the support ring 102. The sidewall 202 of the support ring 102 of FIG. 1 is configured to support and/or carry the interior duct 104, a portion of the temperature sensor 106, and/or the control unit 108 of the temperature control accessory 100.

In the illustrated example of FIGS. 2-7, the support ring 102 includes one or more example first opening(s) 602 (e.g., one or more first through hole(s)) formed in and/or extending through the sidewall 202 of the support ring 102, with the one or more first opening(s) 602 being configured to receive a corresponding one or more example fastener(s) 302 to couple and/or mount the interior duct 104 and/or the control unit 108 to the sidewall 202 of the support ring 102. The support ring 102 further includes an example second opening 604 (e.g., a second through hole) formed in and/or extending through the sidewall 202 of the support ring 102, with the second opening 604 being configured to enable a pressurized flow of air generated by the control unit 108 (e.g., by an airflow generator of the control unit 108) to travel along an airflow pathway extending from an outlet of the control unit 108, through the second opening 604 formed in the sidewall 202 of the support ring 102, and into an inlet of the interior duct 104. In this regard, the control unit 108 is generally located externally relative to (e.g., radially outward from) the sidewall 202 of the support ring 102, and the interior duct 104 is generally located to the interior of (e.g., radially inward from) the sidewall 202 of the support ring 102. The support ring 102 further includes an example third opening 606 (e.g., a third through hole) formed in and/or extending through the sidewall 202 of the support ring 102, with the third opening 606 being configured to receive a cable of the temperature sensor 106 of the temperature control accessory 100.

In the illustrated example of FIGS. 2-7, the support ring 102 further includes an example sensor mounting bracket 304 coupled to and located internally relative to (e.g., radially inward from) the sidewall 202 of the support ring 102. The sensor mounting bracket 304 is configured to support and/or carry a portion of the temperature sensor 106 as described above in connection with FIG. 1. When the temperature sensor 106 is coupled to the sensor mounting bracket 304, a sensing portion (e.g., a sensing tip) of the temperature sensor 106 is located internally relative to (e.g., radially inward from) the sidewall 202 of the support ring 102. The temperature sensor 106 (e.g., implemented as a thermocouple) is accordingly able to sense, measure, and/or detect a temperature within a cooking chamber that is formed in part by the support ring 102 when the temperature control accessory 100 of FIGS. 2-5 is used with and/or installed on a kettle grill. The sensor mounting bracket 304 may be located at any position (e.g., any height) along the sidewall 202 of the support ring 102. For example, as shown in FIGS. 3 and 7, the sensor mounting bracket 304 is located more proximal to the upper rim 204 of the support ring 102. In other examples, the sensor mounting bracket 304 can instead be located more proximal to the lower rim 206 of the support ring 102 (e.g., below the top of the interior duct 104), such as at the example alternate position 702 shown in FIG. 7.

In the illustrated example of FIGS. 2-7, the support ring 102 further includes a plurality of example support flanges 208 coupled to and extending internally relative to (e.g., radially inward from) the sidewall 202 of the support ring 102. The support flanges 208 are individually and/or collectively configured to support a cooking surface (e.g., a cooking grate) within the support ring 102 at a location between the upper rim 204 and the lower rim 206 of the support ring 102. As shown in FIGS. 2-7, the support flanges 208 are configured to position the cooking surface at a location (e.g., a height) that is above the top of the interior duct 104. As further shown in FIGS. 2-7, the sensor mounting bracket 304 is located above the support flanges 208. In other examples, the sensor mounting bracket 304 can instead be located below the support flanges 208, such as at the alternate position 702 shown in FIG. 7. In some examples, locating the sensor mounting bracket 304 at the alternate position 702 (e.g., below the support flanges 208) prevents the sensor mounting bracket 304 and/or the temperature sensor 106 from interfering with a cooking surface (e.g., a cooking grate) when the cooking surface is in the process of being seated on and/or removed from the support flanges 208.

In the illustrated example of FIGS. 2-7, the support ring 102 further includes an example fourth opening 210 and an example fifth opening 212 formed in and/or extending through the sidewall 202 of the support ring 102, with the fourth opening 210 and the fifth opening 212 being circumferentially opposed relative to one another about the circumference of the support ring 102. The circumferentially opposed fourth opening 210 and fifth opening 212 are configured to receive a rotisserie spit of a rotisserie system that can be incorporated into and/or otherwise used with the temperature control accessory 100 shown in FIGS. 2-5.

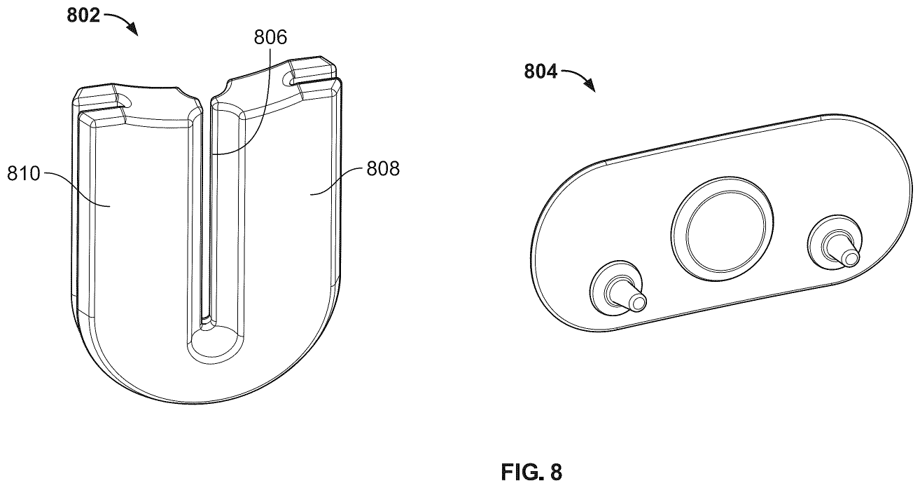

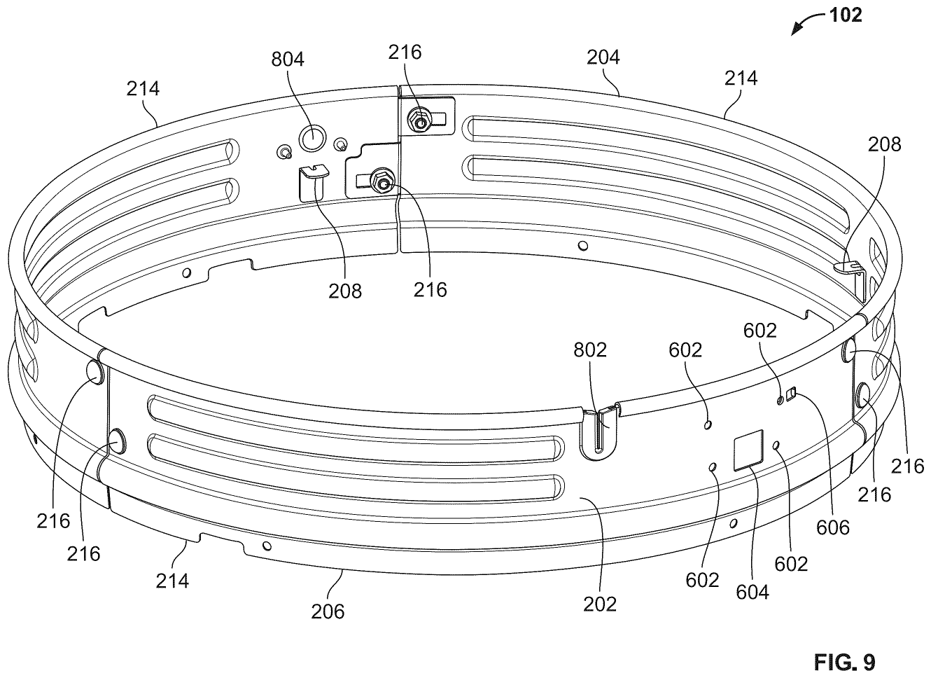

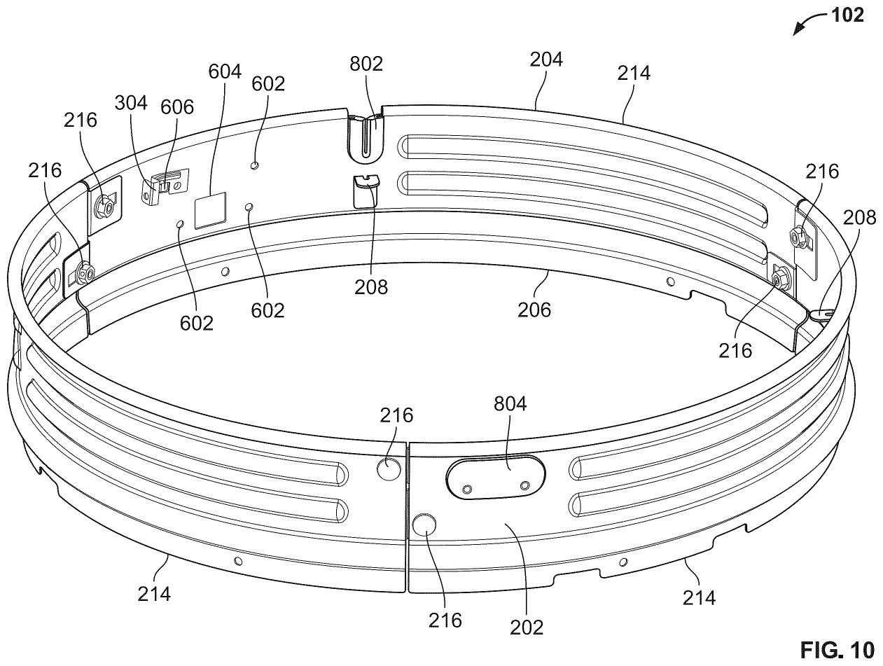

When the rotisserie spit and/or, more generally, the rotisserie system, is not incorporated into and/or used with the temperature control accessory 100, it is advantageous for the fourth opening 210 and the fifth opening 212 to each be plugged and/or sealed, thereby minimizing (e.g., preventing) heated air from passing outwardly therethrough (e.g., from within the support ring 102 outwardly into a surrounding ambient environment). FIG. 8 is a perspective view of an example first seal 802 and an example second seal 804 that are couplable to the support ring 102 of the temperature control accessory 100 as shown in FIGS. 2-7. FIG. 9 is a first perspective view of the support ring 102 as shown in FIGS. 2-7, with the first seal 802 and the second seal 804 of FIG. 8 shown coupled to the support ring 102. FIG. 10 is a second perspective view of the support ring 102 as shown in FIG. 9. In the illustrated example of FIGS. 8-10, the first seal 802 is configured to be removably couplable to the fourth opening 210 of the support ring 102 such that the first seal 802 substantially plugs, seals, and/or otherwise occupies the fourth opening 210 of the support ring 102 when coupled thereto. Similarly, the second seal 804 is configured to be removably couplable to the fifth opening 212 of the support ring 102 such that the second seal 804 substantially plugs, seals, and/or otherwise occupies the fifth opening 212 of the support ring 102 when coupled thereto. In some examples, the first seal 802 and the second seal 804 are fabricated from a flexible material (e.g., silicone). In other examples, the first seal 802 and/or the second seal 804 can instead be fabricated from a rigid material (e.g., hardened plastic, metal, etc.). In the illustrated example of FIGS. 8-10, the first seal 802 includes an example slot 806 (e.g., formed as an open-ended slot having a vertical orientation) located between an example first arm 808 and an example second arm 810 of the first seal 802. The slot 806 of the first seal 802 is configured to receive one or more cable(s) of one or more food temperature probe(s) that may be used in connection with the temperature control accessory 100, as further described herein. In some examples, the slot 806 of the first seal 802 and the cable(s) of the food temperature probe(s) are respectively configured such that a friction fit is formed when the cable(s) is/are positioned within the slot 806.

Returning to the illustrated example of FIGS. 2-7, the sidewall 202 of the support ring 102 is formed by a plurality of example curved sections 214 that are coupled together via a plurality of example fasteners 216 to form the circular shape of the sidewall 202. As shown in FIGS. 2-7, the sidewall 202 of the support ring 102 is formed by a total of three such curved sections 214. In other examples, the sidewall 202 of the support ring 102 can instead be formed by a different number (e.g., two, four, etc.) of such curved sections 214. In still other examples, the sidewall 202 of the support ring 102 can instead be formed as a unitary ring that is not separable into separate curved sections.

When the temperature control accessory 100 of FIGS. 2-5 is used with and/or installed on a kettle grill having a firebox and a lid, the sidewall 202 of the support ring 102 as shown in FIGS. 2-7 is located and/or extends between the firebox and the lid, with the support ring 102 being seated on and/or otherwise supported by the firebox of the kettle grill, and with the lid of the kettle grill being seated on and/or otherwise supported by the support ring 102. In some examples, the firebox of the kettle grill is a bowl-shaped firebox having an upper rim, and the lid of the kettle grill is a dome-shaped lid having a lower rim. In some such examples, the lower rim 206 of the support ring 102 is configured to interface with the firebox, and the upper rim 204 of the support ring 102 is configured to interface with the lid. In some such examples, the lower rim 206 of the support ring 102 is configured to be seated onto, circumscribed by, and/or nested within the upper rim of the firebox, and the upper rim 204 of the support ring 102 is configured to be seated under, circumscribed by, and/or nested within the lower rim of the lid. In other examples, the lower rim 206 of the support ring 102 can instead be configured to circumscribe the upper rim of the firebox, and/or the upper rim 204 of the support ring 102 can instead be configured to circumscribe the lower rim of the lid. As shown in FIGS. 2-7, the upper rim 204 and the lower rim 206 of the support ring 102 each have a circular shape. In some examples, the upper rim of the firebox and the lower rim of the lid also each have a circular shape.

The interior duct 104 of the temperature control accessory 100 of FIGS. 2-5 is coupled (e.g., via one or more of the fastener(s) 302) to the sidewall 202 of the support ring 102, with the interior duct 104 being located internally relative to (e.g., radially inward from) the sidewall 202 of the support ring 102. The interior duct 104 is configured to receive a pressurized flow of air generated by the control unit 108 of the temperature control accessory 100 of FIGS. 2-5 (e.g., by an airflow generator of the control unit 108), and to thereafter guide, direct, and/or otherwise carry the received pressurized flow of air to and/or toward charcoal fuel (e.g., charcoal briquettes) located within a firebox of a kettle grill.

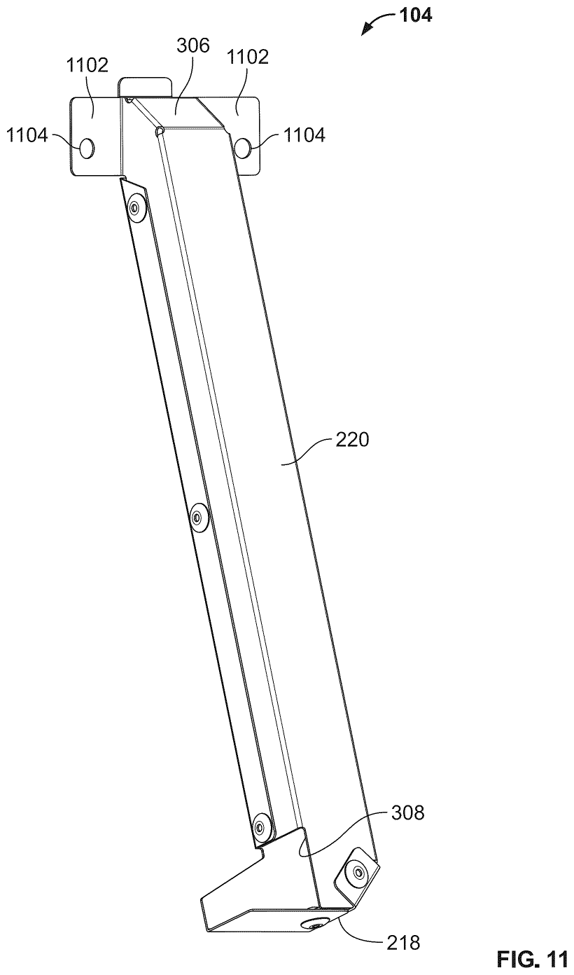

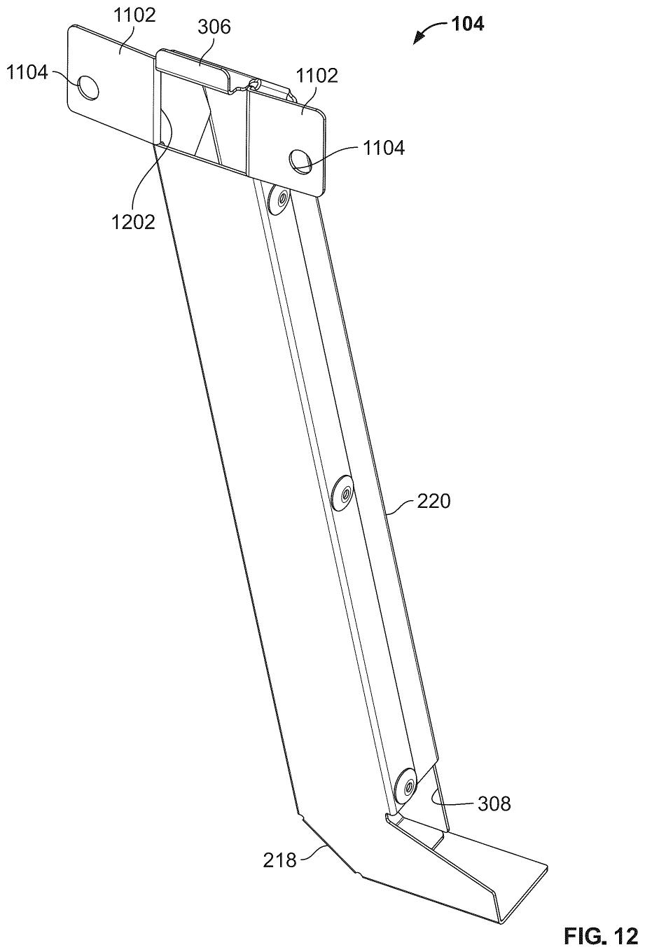

FIG. 11 is a first perspective view of the interior duct 104 of the temperature control accessory 100 shown in FIGS. 2-5, with the interior duct 104 shown in isolation. FIG. 12 is a second perspective view of the interior duct 104 as shown in FIG. 11. As shown in FIGS. 2-5, 11, and 12, the interior duct 104 includes an example first end 306, an example second end 218 located opposite the first end 306, and an example sidewall 220 extending between the first end 306 and the second end 218. The first end 306 of the interior duct 104 includes an example inlet 1202 configured to receive the pressurized flow of air generated by the control unit 108. The second end 218 of the interior duct 104 includes an example outlet 308 configured to expel the pressurized flow of air as it reaches the second end 218 of the interior duct 104. In this regard, the first end 306 and/or the inlet 1202 of the interior duct 104 is/are located proximate to (e.g., adjacent to or in contact with) the sidewall 202 of the support ring 102, with the inlet 1202 of the interior duct 104 being aligned with and/or otherwise being in fluid communication with the second opening 604 formed in the sidewall 202 of the support ring 102. The interior duct 104 further includes a pair of example mounting flanges 1102 located at the first end 306 of the interior duct 104. The mounting flanges 1102 of the interior duct 104 are configured to facilitate coupling the interior duct 104 to the sidewall 202 of the support ring 102. In this regard, the mounting flanges 1102 of the interior duct 104 include one or more example opening(s) 1104 configured to be aligned with corresponding ones of the first opening(s) 602 formed in the sidewall 202 of the support ring 102 such that the interior duct 104 can be securely coupled to the support ring 102 by the fastener(s) 302, with said fastener(s) 302 extending though the opening(s) 1104 formed in the mounting flanges 1102 of the interior duct 104 and further extending through the first opening(s) 602 formed in the sidewall 202 of the support ring 102.

The sidewall 220 of the interior duct 104 of FIGS. 2-5, 11, and 12 extends downwardly from the support ring 102 such that the second end 218 and/or the outlet 308 of the interior duct 104 is/are located below (e.g., axially downward from) the support ring 102 (e.g., below the lower rim 206 of the support ring 102). The outlet 308 of the interior duct 104 guides, directs, and/or otherwise supplies the pressurized flow of air to or toward charcoal fuel (e.g., charcoal briquettes) located within (e.g., near the bottom of) a firebox of a kettle grill. As shown in FIGS. 2-5, 11, and 12, the outlet 308 of the interior duct 104 is configured to be vertically oriented at a normal angle (e.g., perpendicular) relative to a surrounding area of an interior surface of the firebox of the kettle grill such that the outlet 308 and/or, more generally, the interior duct 104 generates a cyclonic pressurized flow of air within the firebox. In the illustrated example of FIGS. 2-5, 11, and 12, the interior duct 104 is configured as a rigid (e.g., non-flexible) conduit having a generally rectangular cross-sectional profile along the length of the sidewall 220 of the interior duct 104 (e.g., moving from the first end 306 and/or the inlet 1202 of the interior duct 104 toward the second end 218 and/or the outlet 308 of the interior duct 104).

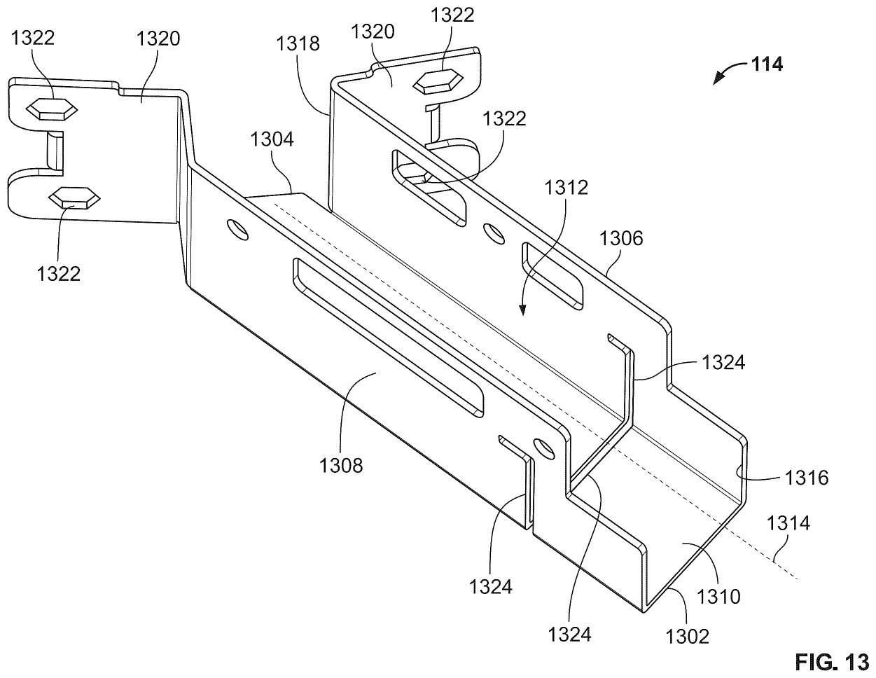

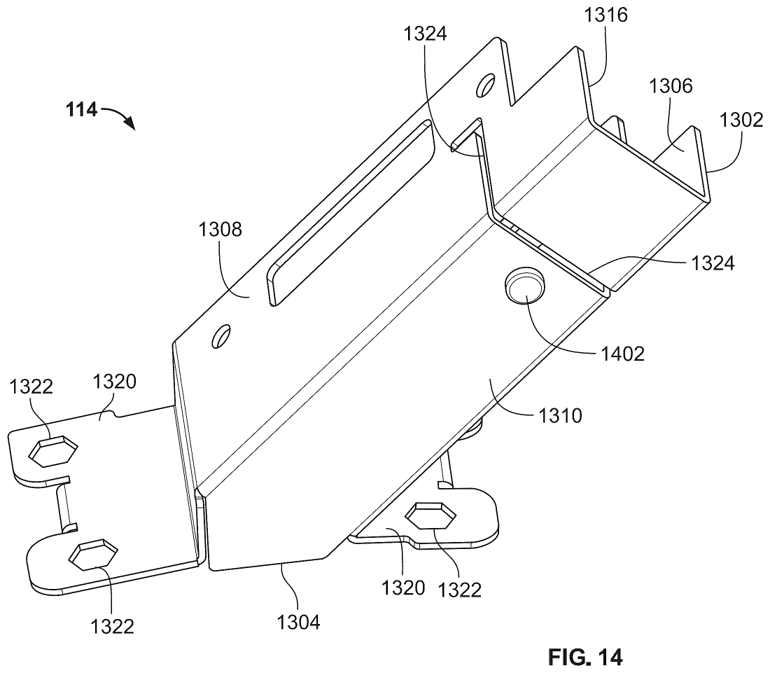

FIG. 13 is a first perspective view of an example transfer duct 114 configured to be implemented by the temperature control accessory 100 shown in FIGS. 2-5, with the transfer duct 114 shown in isolation. FIG. 14 is a second perspective view of the transfer duct 114 as shown in FIG. 13. As shown in FIGS. 13 and 14, the transfer duct 114 includes an example first end 1302 and an example second end 1304 located opposite the first end 1302. The transfer duct 114 further includes an example first sidewall 1306, an example second sidewall 1308 located opposite the first sidewall 1306, and an example bottom wall 1310 extending between the first sidewall 1306 and the second sidewall 1308. The transfer duct 114 further includes and/or is defined by an example top wall (not shown in FIGS. 13 and 14) located opposite the bottom wall 1310 of the transfer duct 114, with the top wall being configured to extending between the first sidewall 1306 and the second sidewall 1308 of the transfer duct 114. The first sidewall 1306, the second sidewall 1308, the bottom wall 1310, and the top wall of the transfer duct 114 respectively extend between the first end 1302 and the second end 1304, thereby forming and/or defining an example flow chamber 1312 of the transfer duct 114. As shown in FIG. 13, the flow chamber 1312 extends from the first end 1302 to the second end 1304 of the transfer duct 114, with the flow chamber 1312 having and/or defining an example central axis 1314.

In the illustrated example of FIGS. 13 and 14, the first end 1302 of the transfer duct 114 includes an example inlet 1316 associated with the flow chamber 1312, and the second end 1304 of the transfer duct 114 includes an example outlet 1318 associated with the flow chamber 1312. The inlet 1316 of the transfer duct 114 is configured to receive a pressurized flow of air (e.g., as generated by the airflow generator 112 of the control unit 108). The outlet 1318 of the transfer duct 114 is configured to expel the pressurized flow of air as it reaches the second end 1304 of the transfer duct 114. The outlet 1318 of the transfer duct 114 is configured to be aligned and/or otherwise in fluid communication with the second opening 604 formed in the sidewall 202 of the support ring 102. The transfer duct 114 further includes a pair of example mounting flanges 1320 located at the second end 1304 of the transfer duct 114. The mounting flanges 1320 of the transfer duct 114 are configured to facilitate coupling the transfer duct 114 to the sidewall 202 of the support ring 102. In this regard, the mounting flanges 1320 of the transfer duct 114 include one or more example opening(s) 1322 configured to be aligned with corresponding ones of the first opening(s) 602 formed in the sidewall 202 of the support ring 102 such that the transfer duct 114 can be securely coupled to the support ring 102 by the fastener(s) 302, with said fastener(s) 302 extending though the first opening(s) 602 formed in the sidewall 202 of the support ring 102 and further extending through the opening(s) 1322 formed in the mounting flanges 1320 of the transfer duct 114.

In the illustrated example of FIGS. 13 and 14, the transfer duct 114 further includes an example slot 1324 formed in and/or extending through the first sidewall 1306, the second sidewall 1308, and the bottom wall 1310 of the transfer duct 114. The slot 1324 of the transfer duct 114 is configured to receive one or more portion(s) (e.g., a panel and an upper flange) of the shutter 116 such that the shutter 116 is slidable within the slot 1324 to facilitate movement (e.g., sliding) of the shutter 116 relative to the transfer duct 114 in a direction that is generally crosswise (e.g., transverse) to the central axis 1314 of the flow chamber 1312 of the transfer duct 114, as further described herein. The transfer duct 114 further includes an example protrusion 1402 formed along and projecting downwardly from the underside of the bottom wall 1310 of the transfer duct 114. In the illustrated example of FIGS. 13 and 14, the protrusion 1402 has a cylindrical shape and/or a circular profile. In other examples, the shape and/or the profile of the protrusion 1402 may differ from the shape and/or the profile shown in FIGS. 13 and 14. The protrusion 1402 of the transfer duct 114 is configured to be engaged by and/or to be received within one or more detent(s) formed along a lower flange of the shutter 116, as further described herein.

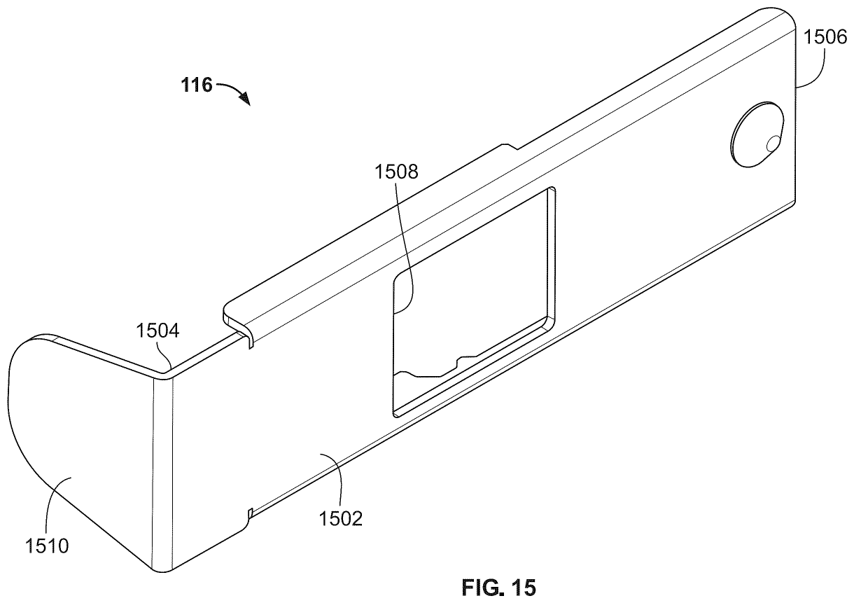

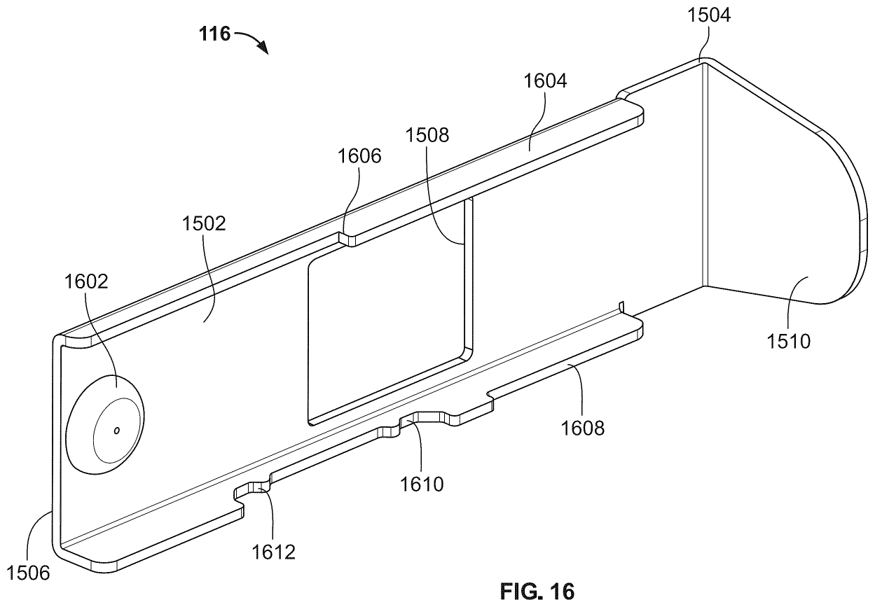

FIG. 15 is a first perspective view of an example shutter 116 configured to be implemented by the temperature control accessory 100 shown in FIGS. 2-5, with the shutter 116 shown in isolation. FIG. 16 is a second perspective view of the shutter 116 as shown in FIG. 15. As shown in FIGS. 15 and 16, the shutter 116 includes an example panel 1502 having an example first end 1504, an example second end 1506, and an example opening 1508. The second end 1506 of the panel 1502 is located opposite the first end 1504 of the panel 1502. The opening 1508 is formed in and/or extends through the panel 1502. In the illustrated example of FIGS. 15 and 16, the opening 1508 is located approximately midway between the first end 1504 and the second end 1506 of the panel 1502. In other examples, the opening 1508 can instead be located more proximal to the first end 1504 of the panel 1502, or more proximal to the second end 1506 of the panel 1502. The panel 1502 of the shutter 116 is configured to be received within the slot 1324 of the transfer duct 114 such that the panel 1502 and its associated opening 1508 are movable (e.g., slidable) relative to the transfer duct 114 in a direction that is crosswise (e.g., transverse) to the central axis 1314 of the flow chamber 1312 of the transfer duct 114, with such movement causing the opening 1508 of the panel 1502 to selectively move into or out of alignment with the flow chamber 1312 of the transfer duct 114, as further described herein.

The shutter 116 of FIGS. 15 and 16 further include an example tab 1510 located at and/or proximal to the first end 1504 of the panel 1502 of the shutter 116. In the illustrated example of FIGS. 15 and 16, the tab 1510 extends away from and is oriented at an angle (e.g., transverse) relative to the panel 1502. As shown in FIGS. 15 and 16, the tab 1510 of the shutter 116 is integrally formed with the panel 1502 of the shutter 116. In other examples, the tab 1510 of the shutter 116 can instead be coupled to the panel 1502 of the shutter 116 via one or more fastener(s). The tab 1510 is configured to be gripped, grasped, pushed, pulled, and/or otherwise engaged by a user of the temperature control accessory 100 in connection with the user moving (e.g., sliding) the shutter 116 between a non-blocking position and a blocking position, as further described herein.

The shutter 116 of FIGS. 15 and 16 further include an example stopper 1602 located at and/or proximal to the second end 1506 of the panel 1502 of the shutter 116. In the illustrated example of FIGS. 15 and 16, the stopper 1602 projects and/or extends away from the panel 1502. The stopper 1602 is configured to selectively contact and/or otherwise engage an exterior surface of the transfer duct 114 (e.g., an exterior surface of the first sidewall 1306 of the transfer duct 114) to prevent the panel 1502 and/or, more generally, the shutter 116 from inadvertently being withdrawn from (e.g., pulled out of) the slot 1324 of the transfer duct 114 by a user of the temperature control accessory 100 in connection with the user moving (e.g., sliding) the shutter 116 from a non-blocking position into a blocking position, as further described herein.

The shutter 116 of FIGS. 15 and 16 further include an example upper flange 1604 located at and/or proximal to an upper edge of the panel 1502 of the shutter 116. In the illustrated example of FIGS. 15 and 16, the upper flange 1604 extends away from and is oriented at an angle (e.g., transverse) relative to the panel 1502. As shown in FIGS. 15 and 16, the upper flange 1604 of the shutter 116 is integrally formed with the panel 1502 of the shutter 116. In other examples, the upper flange 1604 of the shutter 116 can instead be coupled to the panel 1502 of the shutter 116 via one or more fastener(s). The upper flange 1604 is configured to be received within the slot 1324 of the transfer duct 114 such that the upper flange 1604 is movable (e.g., slidable) in unison with the panel 1502 relative to the transfer duct 114 in a direction that is crosswise (e.g., transverse) to the central axis 1314 of the flow chamber 1312 of the transfer duct 114, as further described herein. In the illustrated example of FIGS. 15 and 16, the upper flange 1604 of the shutter 116 includes an example stepped portion 1606 that is configured to selectively contact and/or otherwise engage an interior surface of the transfer duct 114 (e.g., an interior surface of the first sidewall 1306 of the transfer duct 114) to prevent the panel 1502 and/or, more generally, the shutter 116 from inadvertently being overextended through (e.g., pushed too far within) the slot 1324 of the transfer duct 114 by a user of the temperature control accessory 100 in connection with the user moving (e.g., sliding) the shutter 116 from a blocking position into a non-blocking position, as further described herein.

The shutter 116 of FIGS. 15 and 16 further include an example lower flange 1608 located at and/or proximal to a lower edge of the panel 1502 of the shutter 116. In this regard, the lower flange 1608 of the shutter 116 is located opposite the upper flange 1604 of the shutter 116. In the illustrated example of FIGS. 15 and 16, the lower flange 1608 extends away from and is oriented at an angle (e.g., transverse) relative to the panel 1502. As shown in FIGS. 15 and 16, the lower flange 1608 of the shutter 116 is integrally formed with the panel 1502 of the shutter 116. In other examples, the lower flange 1608 of the shutter 116 can instead be coupled to the panel 1502 of the shutter 116 via one or more fastener(s). The lower flange 1608 is configured to be positioned below the bottom wall 1310 of the transfer duct 114 such that the lower flange 1608 is movable (e.g., slidable) in unison with the panel 1502 relative to the transfer duct 114 in a direction that is crosswise (e.g., transverse) to the central axis 1314 of the flow chamber 1312 of the transfer duct 114, as further described herein.

In the illustrated example of FIGS. 15 and 16, the lower flange 1608 of the shutter 116 includes and/or defines an example first detent 1610 and an example second detent 1612. The first detent 1610 is associated with a non-blocking position of the shutter 116. The second detent 1612, which is spaced apart from the first detent 1610, is associated with a blocking position of the shutter 116. The first detent 1610 and the second detent 1612 are respectively configured to selectively receive the protrusion 1402 that is formed on the underside of the bottom wall 1310 of the transfer duct 114 as the shutter 116 moves (e.g., slides) relative to the transfer duct 114 between the non-blocking position and the blocking position, as further described herein. The first detent 1610 and the second detent 1612 advantageously provide a user of the temperature control accessory 100 with sensory (e.g., tactile) feedback regarding the position of the shutter 116 relative to the transfer duct 114 as the shutter 116 moves (e.g., slides) relative to the transfer duct 114 between the non-blocking position and the blocking position.

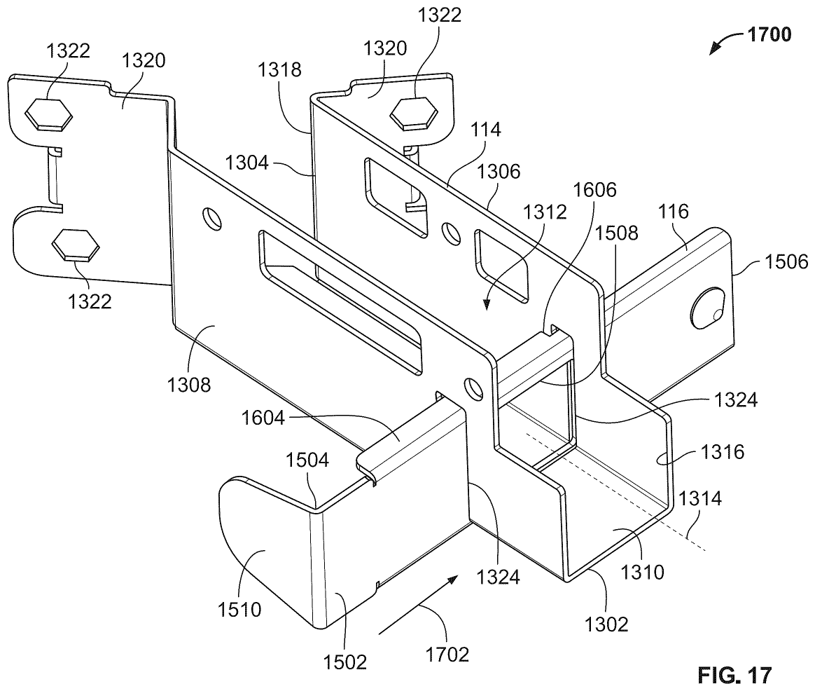

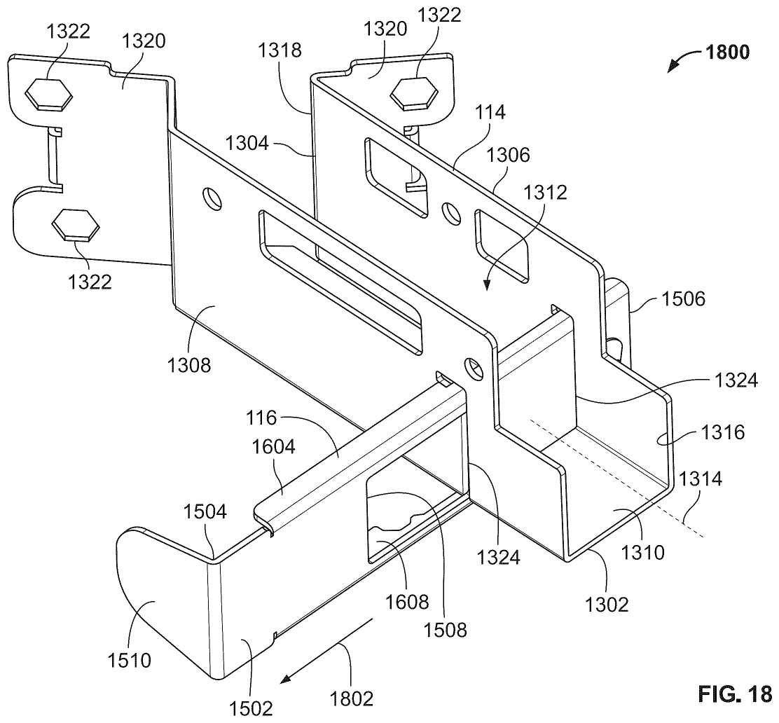

FIG. 17 is a perspective view of the shutter 116 as shown in FIGS. 14 and 15 assembled relative to the transfer duct 114 as shown in FIGS. 12 and 13, with the shutter 116 positioned in an example non-blocking position 1700. When the shutter 116 is positioned in the non-blocking position 1700 shown in FIG. 17, the opening 1508 formed in the panel 1502 of the shutter 116 is aligned with and is in fluid communication with the flow chamber 1312 of the transfer duct 114 such that the panel 1502 does not block, impede, restrict, and/or otherwise obstruct a flow of pressurized air traveling though the flow chamber 1312 from the inlet 1316 of the transfer duct 114 to and/or towards the outlet 1318 of the transfer duct 114. The shutter 116 can be repositioned from a blocking position (e.g., the blocking position 1800 of FIG. 18 described below) into the non-blocking position 1700 of FIG. 17 by moving (e.g., pushing) the tab 1510 of the shutter 116 toward the transfer duct 114, which in turn causes the panel 1502 of the shutter to move (e.g., slide) through the slot 1324 of the transfer duct 114 in an example first crosswise direction 1702 that is transverse to the central axis 1314 of the flow chamber 1312 of the transfer duct 114.

In the illustrated example of FIG. 17, the stepped portion 1606 of the upper flange 1604 of the shutter 116 contacts and/or otherwise engages an interior surface of the first sidewall 1306 of the transfer duct 114 when the shutter 116 is in the non-blocking position 1700, thereby preventing the panel 1502 and/or, more generally, the shutter 116 from inadvertently being overextended through (e.g., pushed too far within) the slot 1324 of the transfer duct 114 by a user of the temperature control accessory 100 in connection with the user moving (e.g., sliding) the shutter 116 into the non-blocking position 1700. When the shutter 116 is positioned in the non-blocking position 1700 of FIG. 17, the stopper 1602 of the shutter 116 is spaced apart from an exterior surface of the first sidewall 1306 of the transfer duct 114, and the protrusion 1402 of the transfer duct 114 is positioned within and/or received by the first detent 1610 of the lower flange 1608 of the shutter 116.

FIG. 18 is a perspective view of the shutter 116 as shown in FIGS. 14 and 15 assembled relative to the transfer duct 114 as shown in FIGS. 12 and 13, with the shutter 116 positioned in an example blocking position 1800. When the shutter 116 is positioned in the blocking position 1800 shown in FIG. 18, the opening 1508 formed in the panel 1502 of the shutter 116 is not aligned with and is not in fluid communication with the flow chamber 1312 of the transfer duct 114, thereby causing the panel 1502 to block, impede, restrict, and/or otherwise obstruct a flow of pressurized air traveling though the flow chamber 1312 from the inlet 1316 of the transfer duct 114 to and/or towards the outlet 1318 of the transfer duct 114. The shutter 116 can be repositioned from the non-blocking position 1700 of FIG. 17 into the blocking position 1800 of FIG. 18 by moving (e.g., pulling) the tab 1510 of the shutter 116 away from the transfer duct 114, which in turn causes the panel 1502 of the shutter to move (e.g., slide) through the slot 1324 of the transfer duct 114 in an example second crosswise direction 1802 (e.g., opposite the first crosswise direction 1702 of FIG. 17) that is transverse to the central axis 1314 of the flow chamber 1312 of the transfer duct 114.

In the illustrated example of FIG. 18, the stopper 1602 of the shutter 116 contacts and/or otherwise engages an exterior surface of the first sidewall 1306 of the transfer duct 114 when the shutter 116 is in the blocking position 1800, thereby preventing the panel 1502 and/or, more generally, the shutter 116 from inadvertently being withdrawn from (e.g., pulled out of) the slot 1324 of the transfer duct 114 by a user of the temperature control accessory 100 in connection with the user moving (e.g., sliding) the shutter 116 into the blocking position 1800. When the shutter 116 is positioned in the blocking position 1800 of FIG. 18, the stepped portion 1606 of the upper flange 1604 of the shutter 116 is spaced apart from an interior surface of the first sidewall 1306 of the transfer duct 114, and the protrusion 1402 of the transfer duct 114 is positioned within and/or received by the second detent 1612 of the lower flange 1608 of the shutter 116.

The control unit 108 of the temperature control accessory 100 of FIGS. 2-5 is configured to control a temperature within a cooking chamber of a charcoal-fueled kettle grill by regulating a measured temperature sensed and/or detected (e.g., via the temperature sensor 106) from within the cooking chamber relative to a temperature setpoint (e.g., as selected and/or otherwise indicated via a user of the temperature control accessory 100). As shown in FIGS. 2-5, the control unit 108 includes an example external housing 110, an example airflow generator 112, an example transfer duct 114 (e.g., as described above in connection with FIGS. 13, 14, 17, and 18), an example shutter 116 (e.g., as described above in connection with FIGS. 15-18), and an example user interface 120 (e.g., including one or more example input device(s) 122 and one or more example output device(s) 124). The control unit 108 of FIGS. 2-5 further includes the network interface 126 (e.g., including one or more communication device(s) 128), the controller 130, memory 132, and the power supply 134 as described above in connection with FIG. 1. One or more component(s) (e.g., the external housing 110 and/or the transfer duct 114) of the control unit 108 of the temperature control accessory 100 of FIGS. 2-5 is/are coupled (e.g., via one or more fastener(s)) to the sidewall 202 of the support ring 102, with at least the external housing 110 of the control unit 108 being located externally relative to the sidewall 202 of the support ring 102 and/or externally relative to an exterior surface of the firebox of the kettle grill. In the illustrated example of FIGS. 2-5, the external housing 110 of the control unit 108 is located radially outward from the sidewall 202 of the support ring 102. In other examples, the external housing 110 of the control unit 108 can instead be coupled to and/or located along the exterior surface of the firebox of the kettle grill, or coupled to and/or located along a component (e.g., a handle, an ash catcher, etc.) that itself is coupled and/or located along the exterior surface of the firebox of the kettle grill.

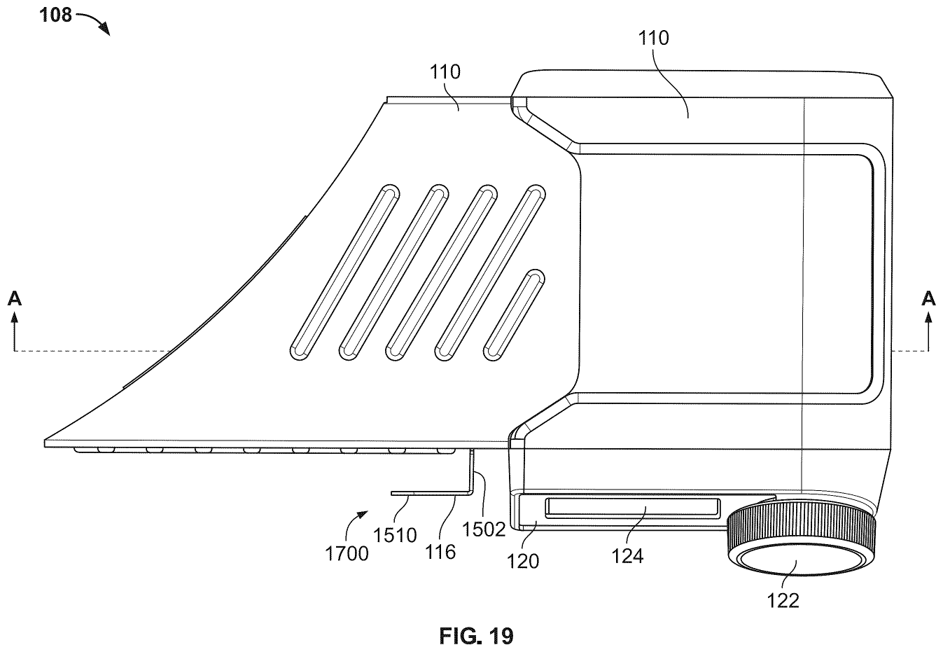

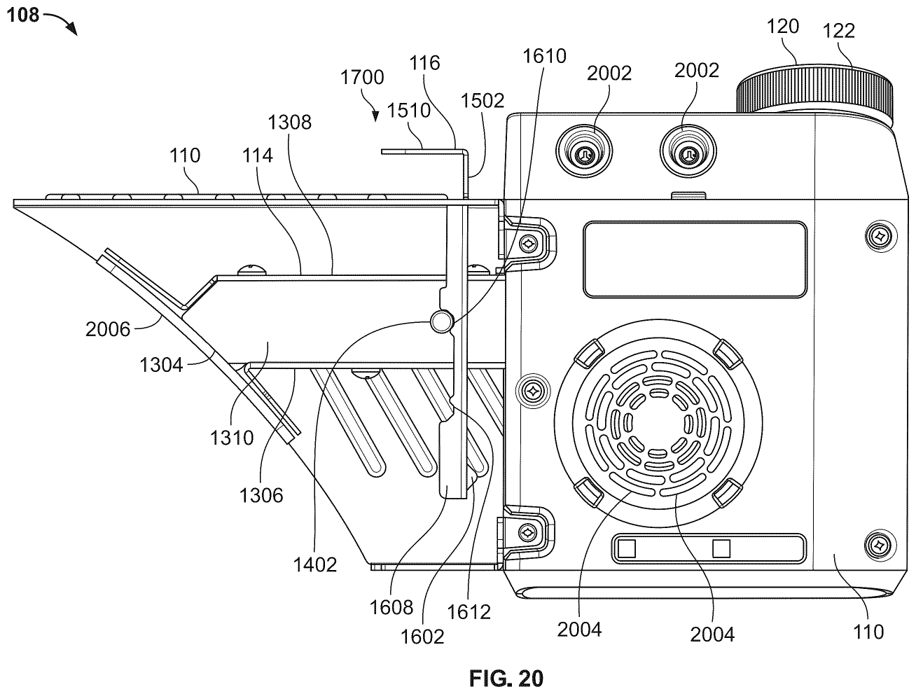

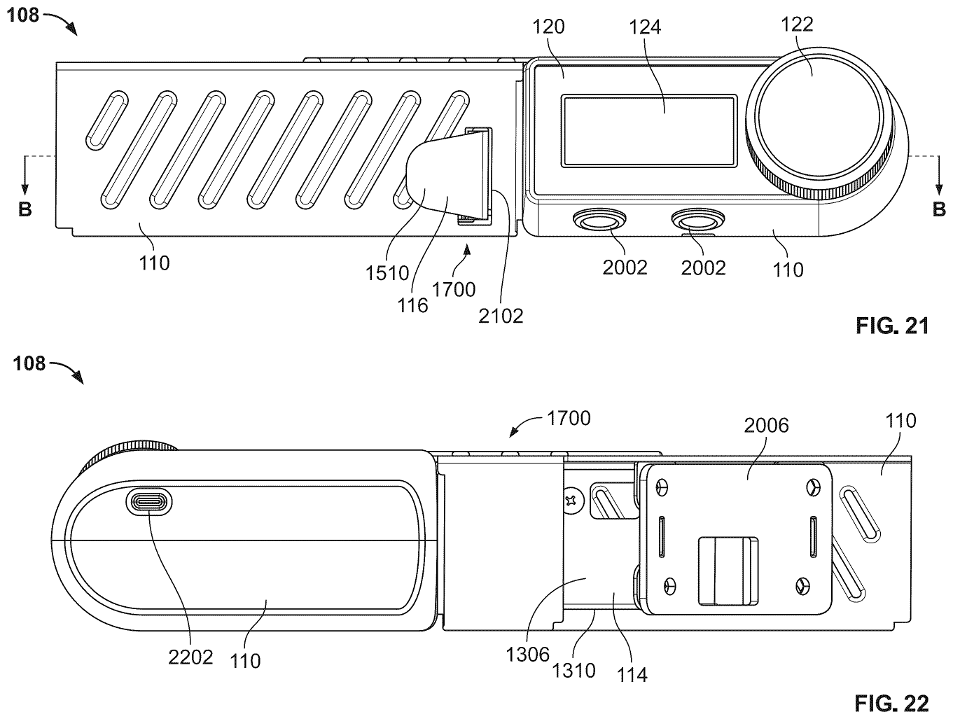

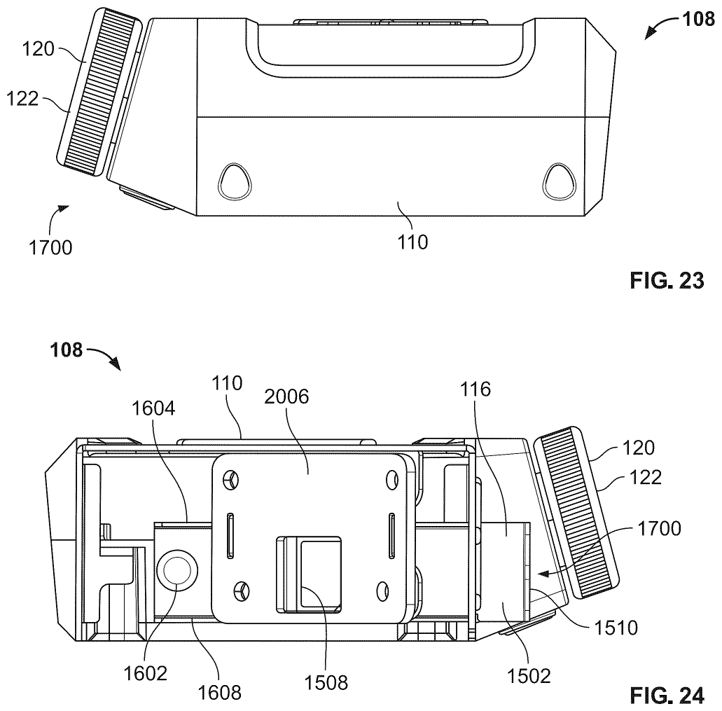

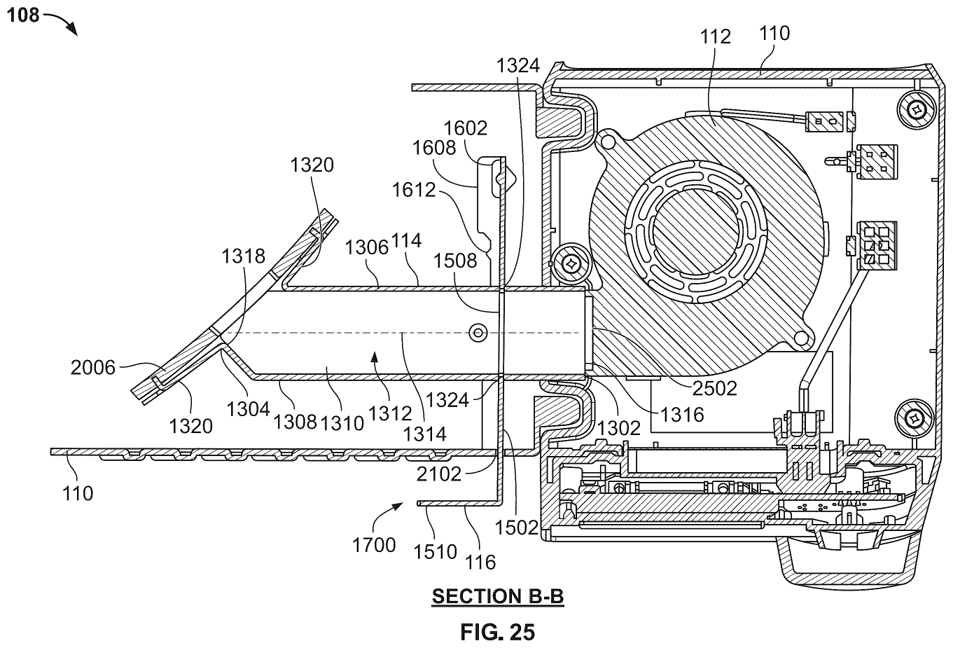

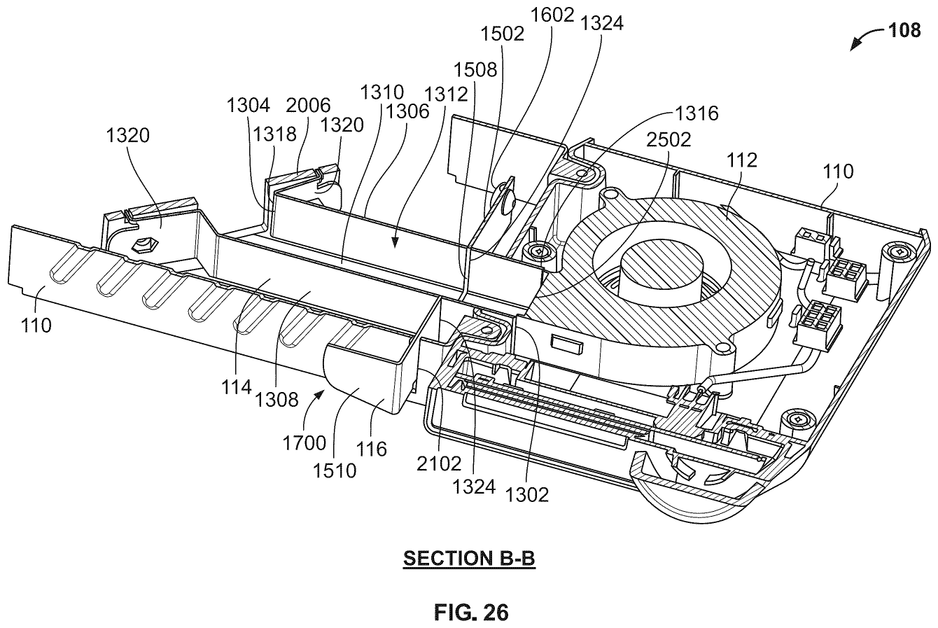

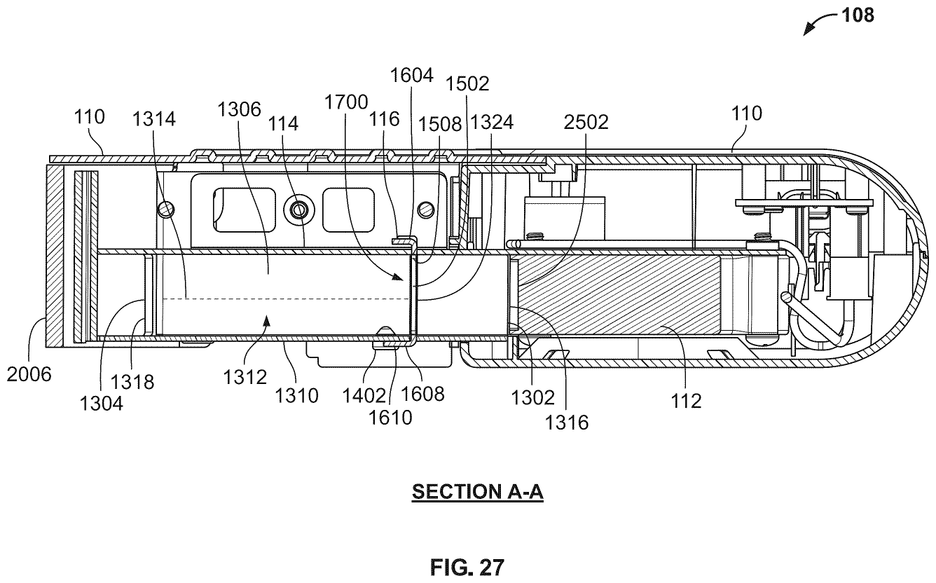

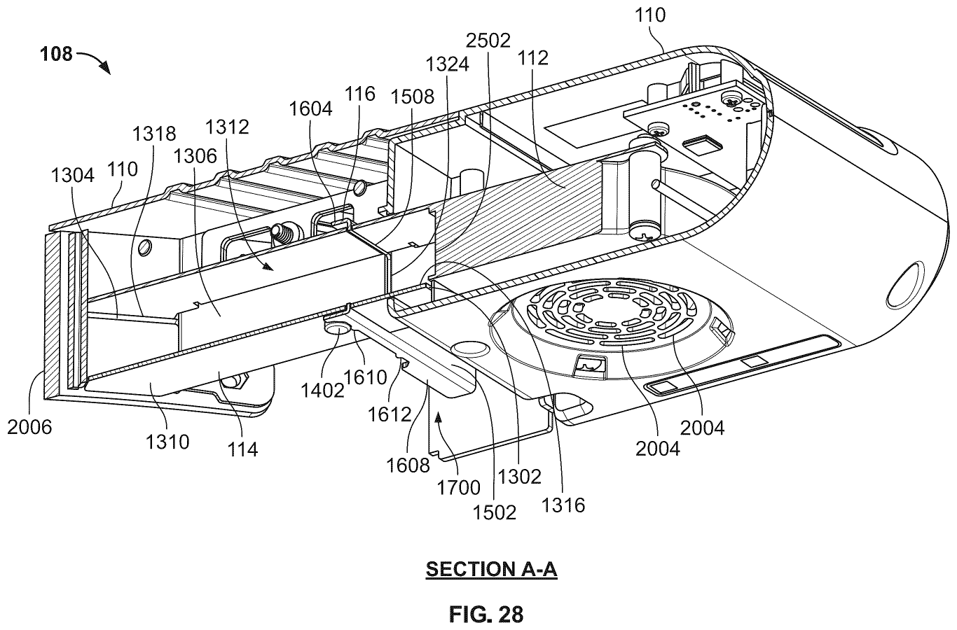

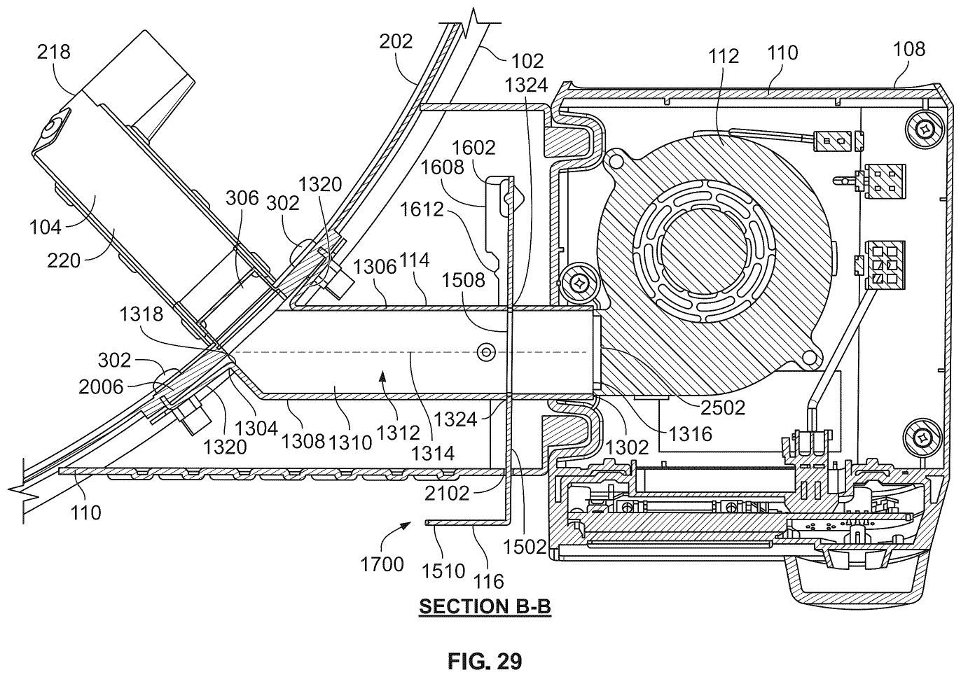

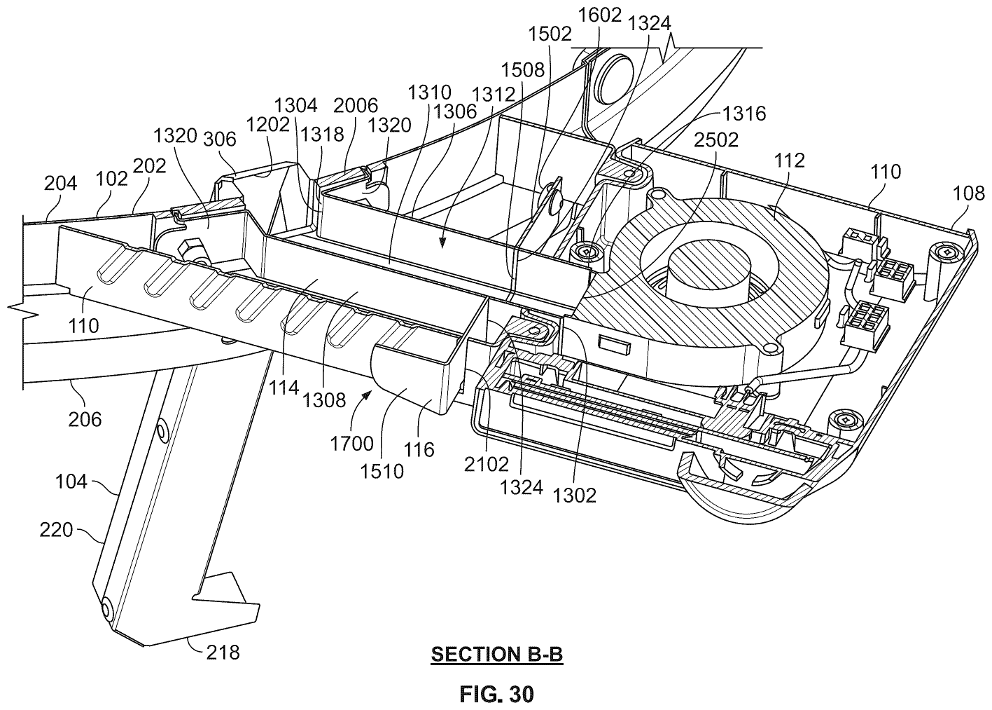

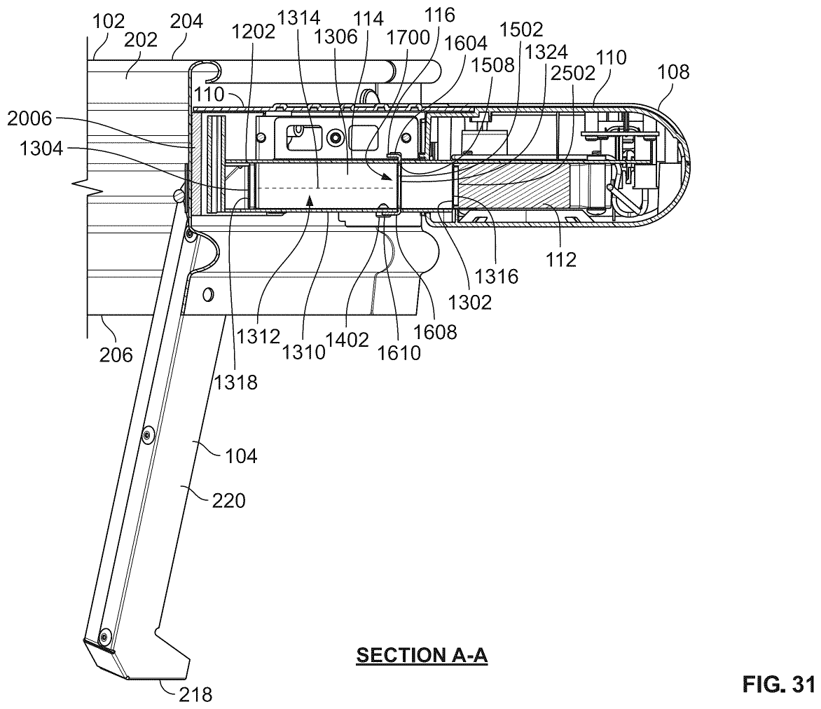

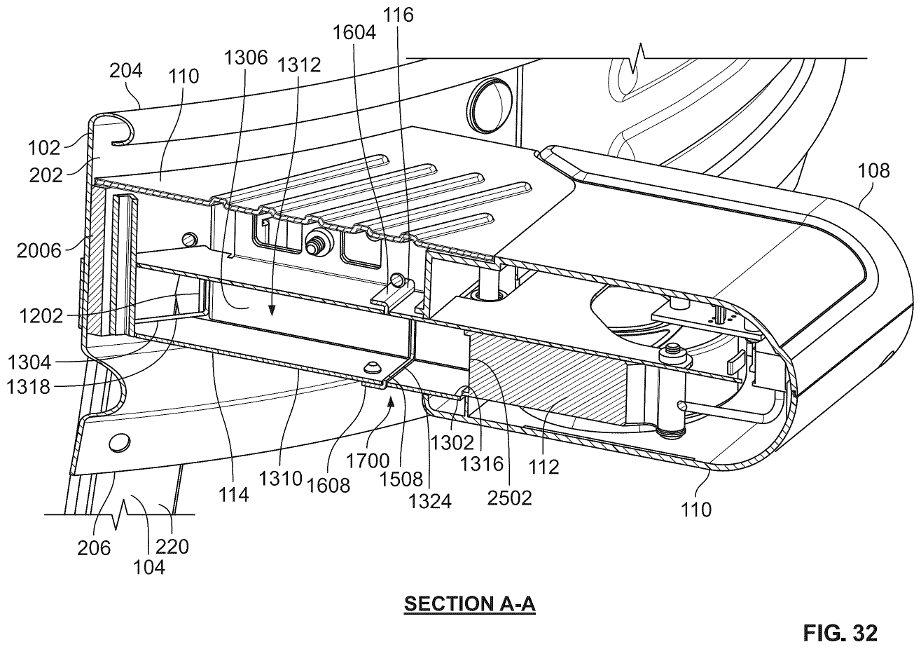

FIG. 19 is a top view of an example control unit 108 of the temperature control accessory 100 shown in FIGS. 2-5, with the control unit 108 shown in isolation, and with the shutter 116 of the control unit 108 positioned in the non-blocking position 1700 as shown in FIG. 17. FIG. 20 is a bottom view of the control unit 108 as shown in FIG. 19. FIG. 21 is a front view of the control unit 108 as shown in FIGS. 19 and 20. FIG. 22 is a rear view of the control unit 108 as shown in FIGS. 19-21. FIG. 23 is a right side view of the control unit 108 as shown in FIGS. 19-22. FIG. 24 is a left side view of the control unit 108 as shown in FIGS. 19-23. FIG. 25 is a cross-sectional view of the control unit 108 as shown in FIGS. 19-24, taken along section B-B of FIG. 21. FIG. 26 is a perspective view of the cross-sectional shown in FIG. 25. FIG. 27 is a cross-sectional view of the control unit 108 as shown in FIGS. 19-24, taken along section A-A of FIG. 19. FIG. 28 is a perspective view of the cross-sectional view shown in FIG. 27. FIG. 29 is a cross-sectional view of the control unit 108 as shown in FIGS. 19-24, taken along section B-B of FIG. 21, with the control unit 108 shown coupled to the support ring 102 and/or the interior duct 104 of the temperature control accessory 100 of FIGS. 2-5. FIG. 30 is a perspective view of the cross-sectional view shown in FIG. 29. FIG. 31 is a cross-sectional view of the control unit 108 as shown in FIGS. 19-24, taken along section A-A of FIG. 19, with the control unit 108 shown coupled to the support ring 102 and/or the interior duct 104 of the temperature control accessory 100 of FIGS. 2-5. FIG. 32 is a perspective view of the cross-sectional view shown in FIG. 31.

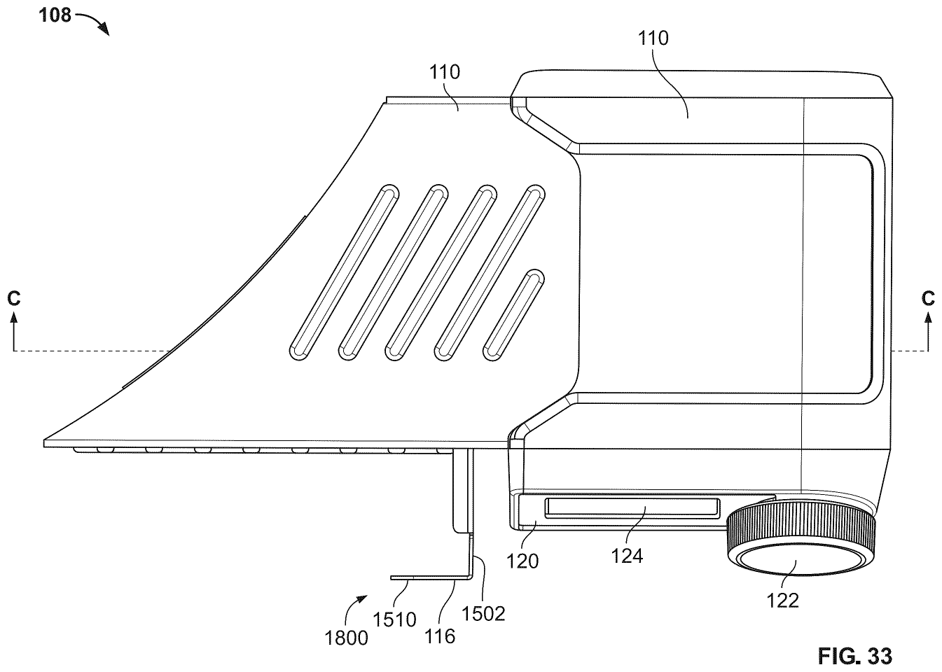

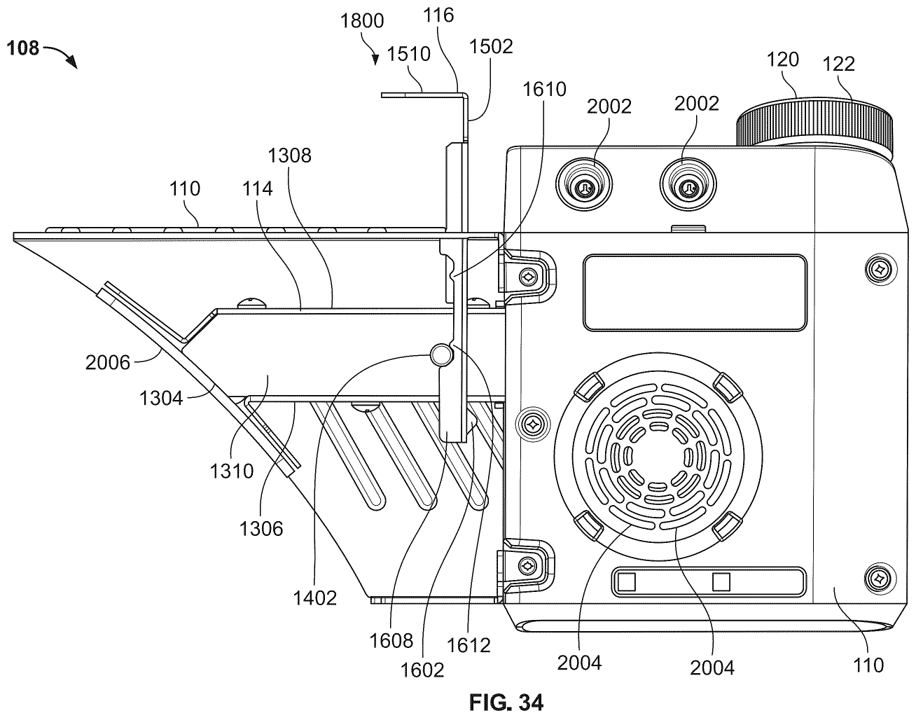

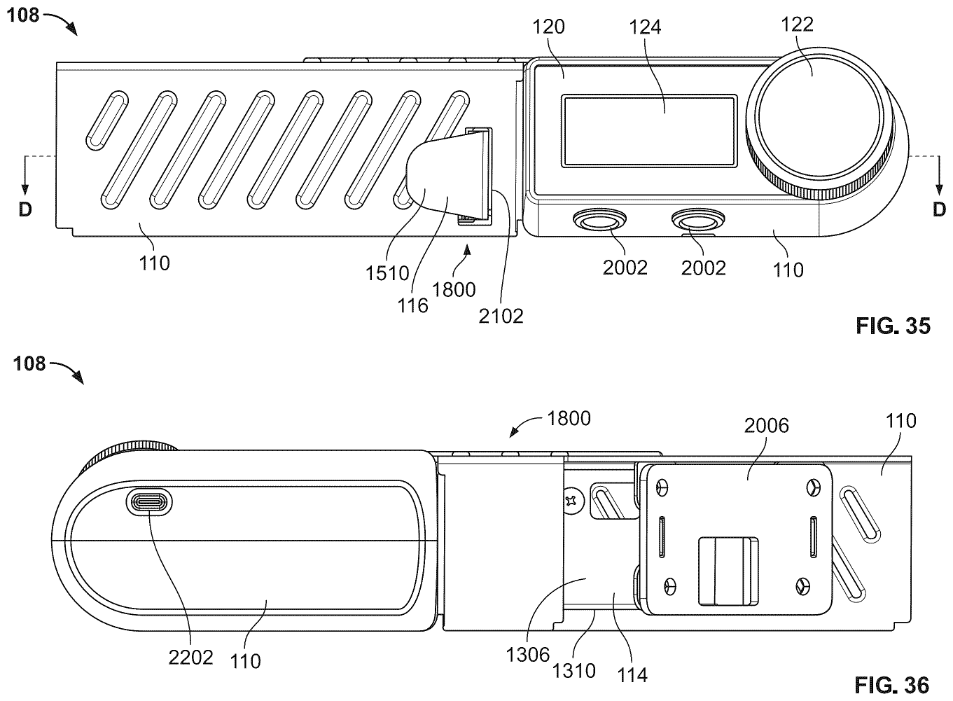

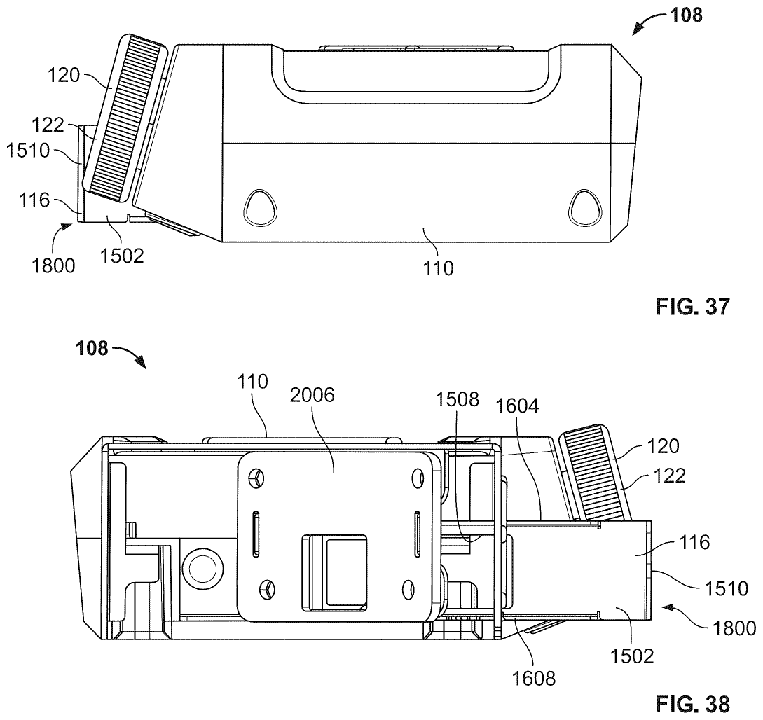

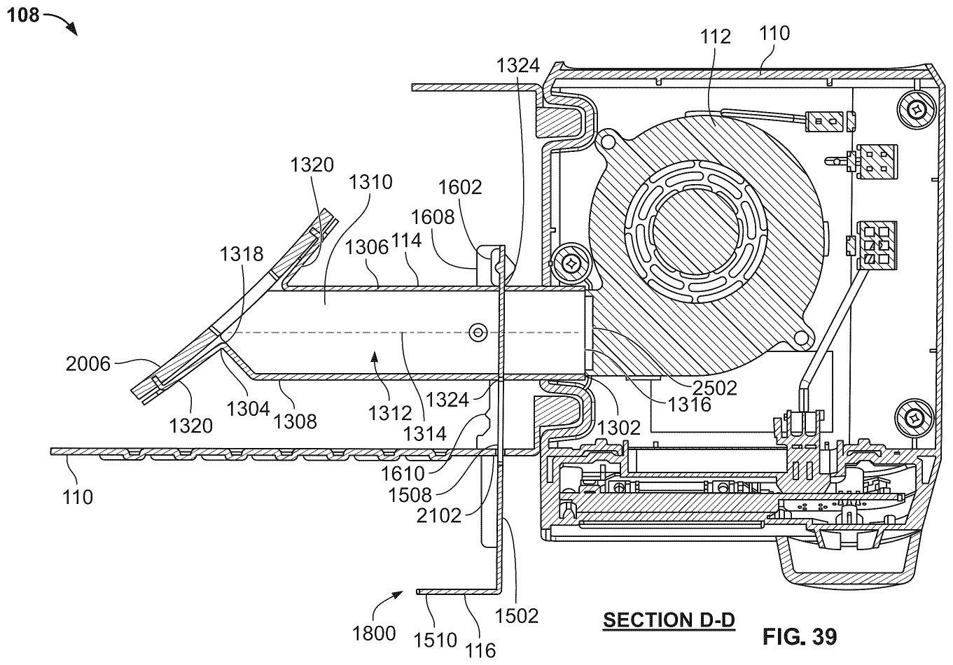

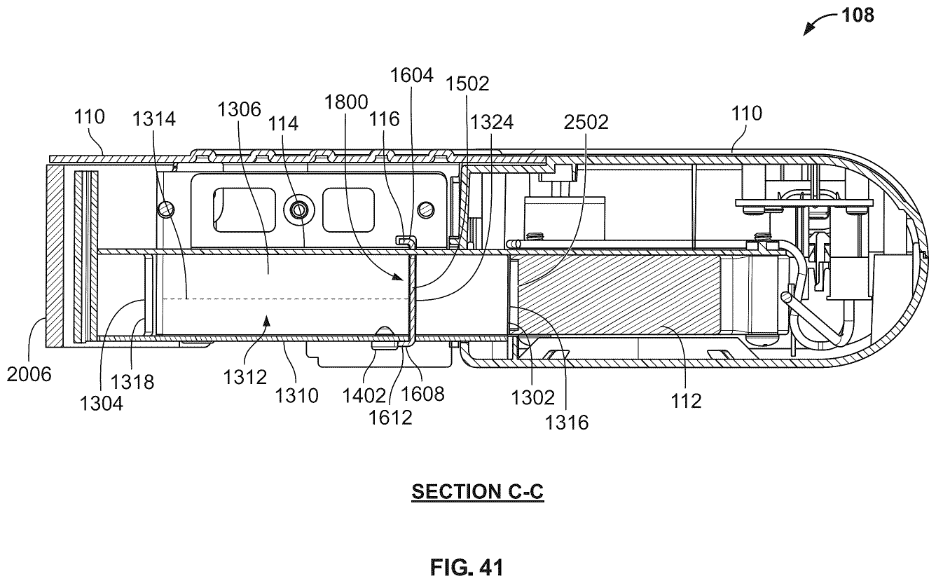

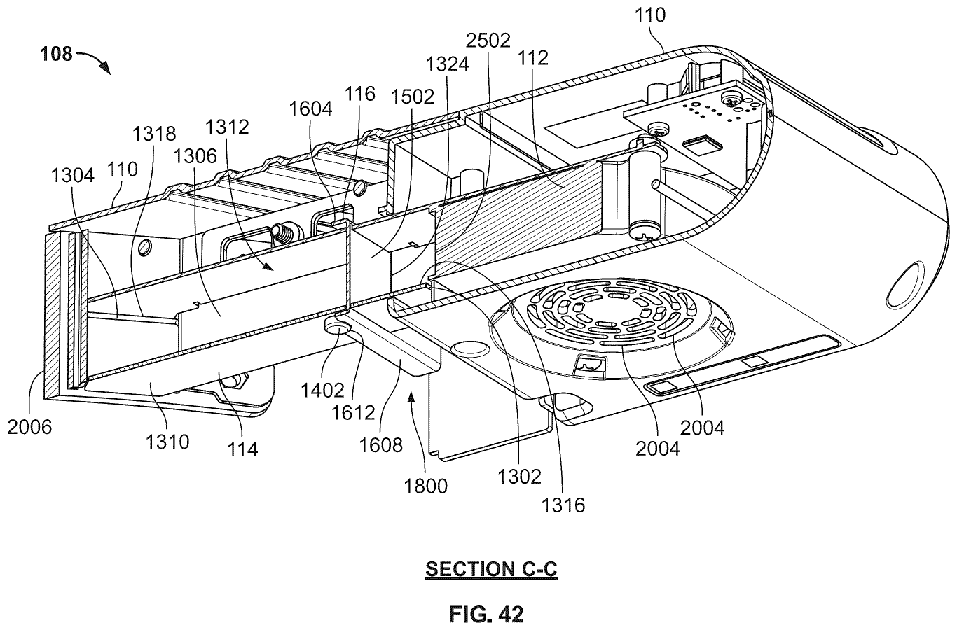

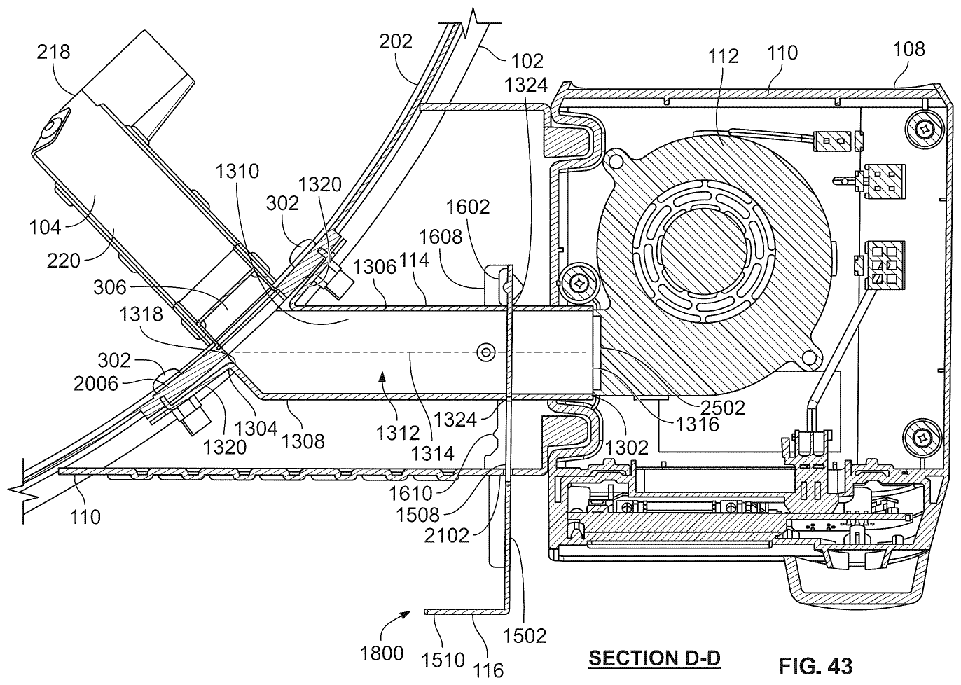

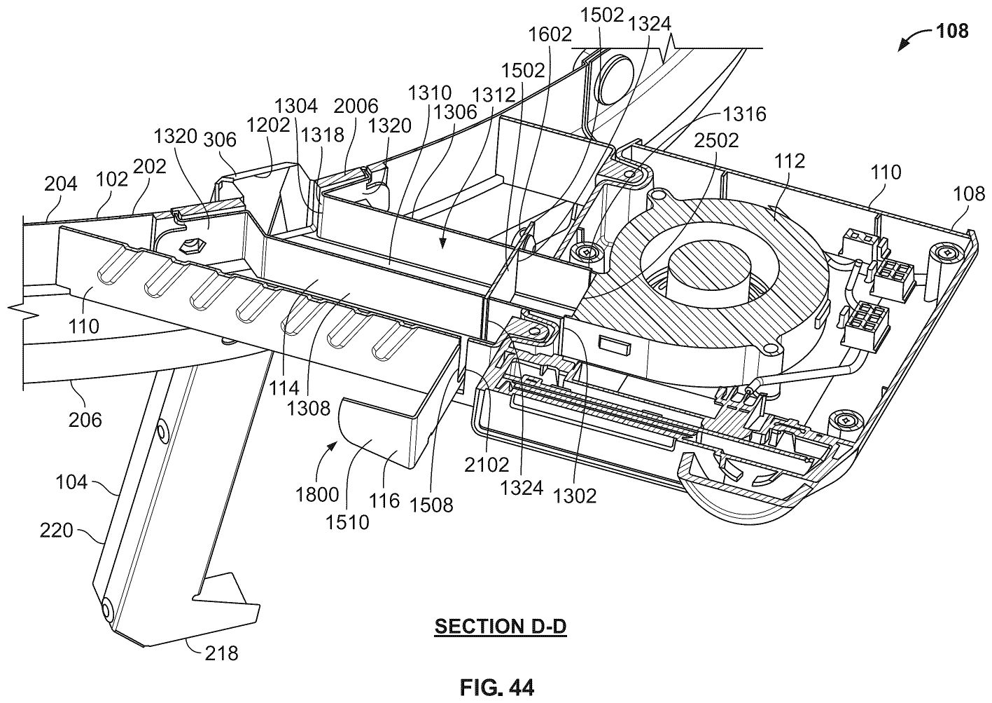

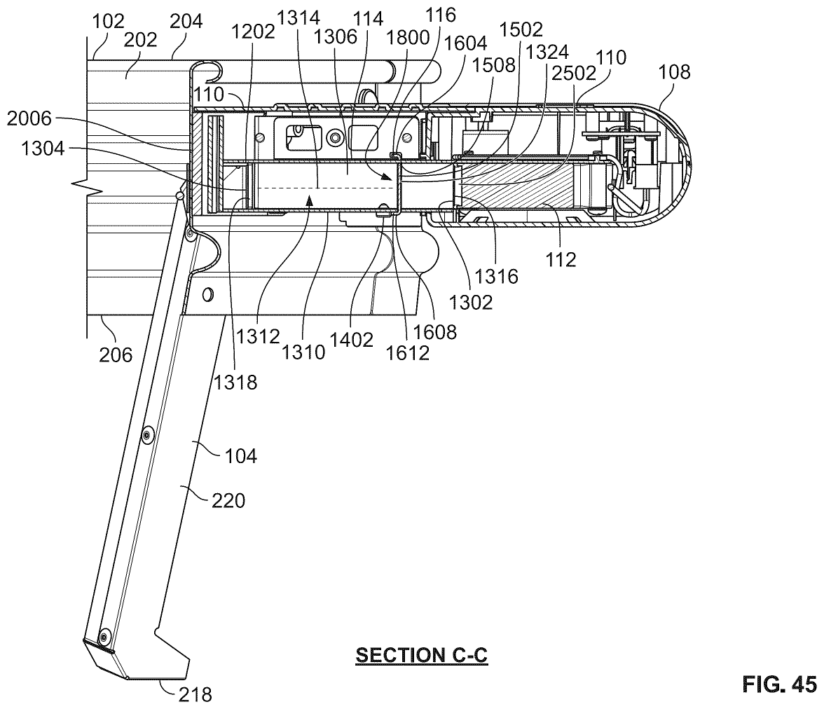

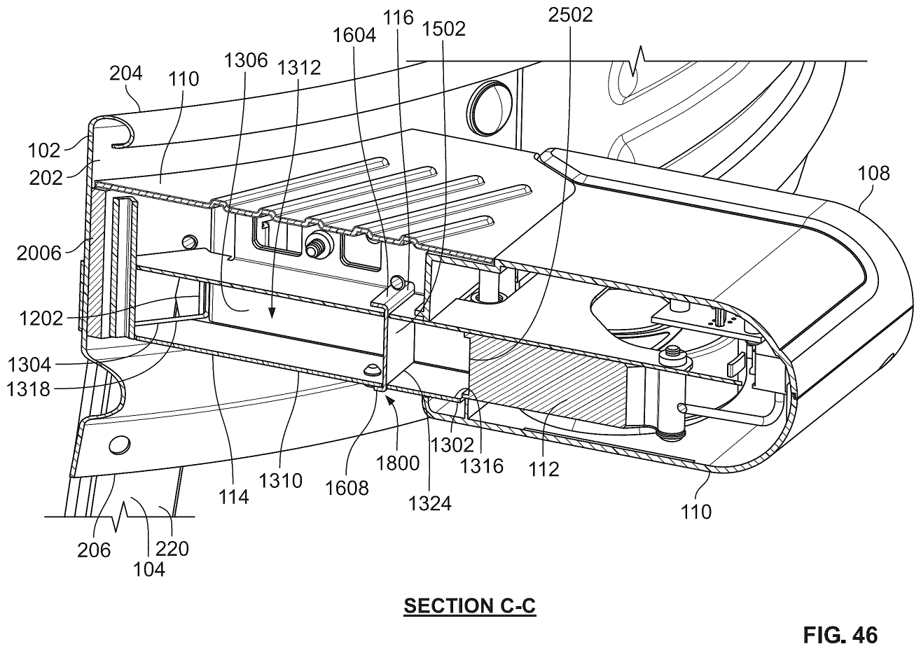

FIG. 33 is a top view of the control unit 108 of the temperature control accessory 100 shown in FIGS. 2-5 and 19-32, with the control unit 108 shown in isolation, and with the shutter 116 of the control unit 108 positioned in the blocking position 1800 as shown in FIG. 18. FIG. 34 is a bottom view of the control unit 108 as shown in FIG. 33. FIG. 35 is a front view of the control unit 108 as shown in FIGS. 33 and 34. FIG. 36 is a rear view of the control unit 108 as shown in FIGS. 33-35. FIG. 37 is a right side view of the control unit 108 as shown in FIGS. 33-36. FIG. 38 is a left side view of the control unit 108 as shown in FIGS. 33-37. FIG. 39 is a cross-sectional view of the control unit 108 as shown in FIGS. 33-38, taken along section D-D of FIG. 35. FIG. 40 is a perspective view of the cross-sectional shown in FIG. 39. FIG. 41 is a cross-sectional view of the control unit 108 as shown in FIGS. 33-38, taken along section C-C of FIG. 33. FIG. 42 is a perspective view of the cross-sectional view shown in FIG. 41. FIG. 43 is a cross-sectional view of the control unit 108 as shown in FIGS. 33-38, taken along section D-D of FIG. 35, with the control unit 108 shown coupled to the support ring 102 and/or the interior duct 104 of the temperature control accessory 100 of FIGS. 2-5. FIG. 44 is a perspective view of the cross-sectional view shown in FIG. 43. FIG. 45 is a cross-sectional view of the control unit 108 as shown in FIGS. 33-38, taken along section C-C of FIG. 33, with the control unit 108 shown coupled to the support ring 102 and/or the interior duct 104 of the temperature control accessory 100 of FIGS. 2-5. FIG. 46 is a perspective view of the cross-sectional view shown in FIG. 45.

The external housing 110 of the control unit 108 of FIGS. 2-5 and 19-46 is configured to cover, conceal, and/or house portions of one or more component(s) of the control unit 108. For example, as shown in FIGS. 2-5 and 19-46, the external housing 110 covers, conceals, and/or houses portions of the airflow generator 112, the transfer duct 114, the shutter 116, the user interface 120, the network interface 126, the controller 130, the memory 132, and/or the power supply 134 of the control unit 108. In the illustrated example of FIGS. 2-5 and 19-46, the external housing 110 includes an example slot 2102 formed in and/or extending through a front surface of the external housing 110. The slot 2102 of the external housing 110 is in alignment with the slot 1324 of the transfer duct 114 such the shutter 116 of the control unit 108 is slidingly received within both the slot 2102 of the external housing 110 and the slot 1324 of the transfer duct 114. The configuration of the external housing 110 shown in FIGS. 2-5 and 19-46 results in some portions of the panel 1502 (e.g., the second end 1506, the opening 1508) and/or some portions of the shutter 116 (the stopper 1602) of the control unit 108 being located within the external housing 110, while other portions of the panel 1502 (e.g., the first end 1504) and/or other portions of the shutter 116 (e.g., the tab 1510) of the control unit 108 remain located outside of the external housing 110.

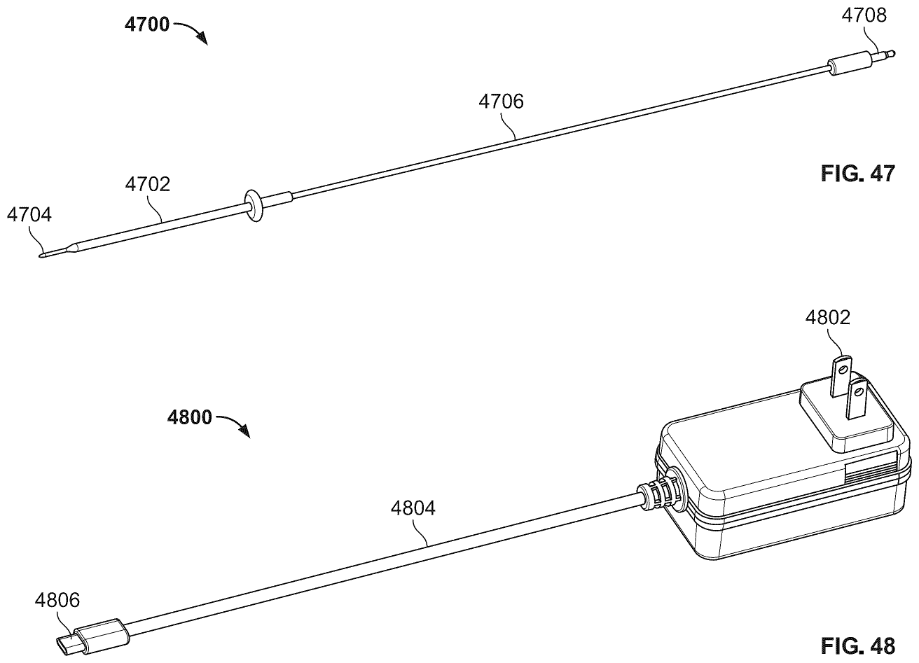

In the illustrated example of FIGS. 2-5 and 19-46, the external housing 110 of the control unit 108 further includes an example first opening 2202 (e.g., a first through hole) formed in and/or extending through a rear surface of the external housing 110, with said first opening 2202 being configured to receive a connector of a power cord (e.g., the power cord 4800 of FIG. 48) to facilitate operatively coupling the power cord to the power supply 134 of the control unit 108, as further described herein. In the illustrated example of FIGS. 2-5 and 19-46, the external housing 110 of the control unit 108 further includes one or more example second opening(s) 2002 (e.g., one or more second through hole(s)) formed in and/or extending through a bottom surface of the external housing 110, with each one of said second opening(s) 2002 being configured to receive a jack plug of a food temperature probe (e.g., the food temperature probe 4700 of FIG. 47) to facilitate operatively coupling the food temperature probe to a jack of the control unit 108 positioned in alignment with a corresponding one of the second opening(s) 2002, as further described herein. In the illustrated example of FIGS. 2-5 and 19-46, the external housing 110 further includes one or more example third opening(s) 2004 (e.g., one or more third through hole(s)) formed in and/or extending through a bottom surface of the external housing 110, with said third opening(s) 2004 being configured to enable air from the surrounding atmosphere to be drawn into the airflow generator 112 of the control unit 108, as further described herein.

The airflow generator 112 of the control unit 108 of FIGS. 2-5 and 19-46 generates a pressurized flow of air that is directed and/or transferred from an example outlet 2502 of the airflow generator 112 toward and/or through the inlet 1316 of the transfer duct 114 of the control unit 108. In the illustrated example of FIGS. 2-5 and 19-46, the airflow generator 112 of the control unit 108 is implemented as a blower. In some examples, the blower is implemented as a DC-powered, variable speed blower that is powered by the power supply 134 of the control unit 108 and controlled by the controller 130 of the control unit 108. In other examples, the airflow generator 112 of the control unit 108 can instead be implemented as a fan. In some such other examples, the fan is implemented as a DC-powered, variable speed fan that is powered by the power supply 134 of the control unit 108 and controlled by the controller 130 of the control unit 108. As shown in FIGS. 2-5 and 19-46, the airflow generator 112 is coupled to, located within, housed by, and/or carried by the external housing 110 of the control unit 108. Operation of the airflow generator 112 causes air from the atmosphere surrounding the control unit 108 to be drawn into the airflow generator 112 via the third opening(s) 2004 formed in the bottom surface of the external housing 110 of the control unit 108, with the operation of the airflow generator 112 thereafter causing such drawn in air to be expelled from the outlet 2502 of the airflow generator 112 as a pressurized flow of air.

The transfer duct 114 of the control unit 108 of FIGS. 2-5 and 19-36 extends between the outlet of the airflow generator 112 of the control unit 108 and the sidewall 202 of the support ring 102. In the illustrated example of FIGS. 2-5 and 19-46, the transfer duct 114 of the control unit 108 is coupled (e.g., via one or more of the fastener(s) 302) to the sidewall 202 of the support ring 102 and/or to the interior duct 104, with the transfer duct 114 being located externally relative to (e.g., radially outward from) the sidewall 202 of the support ring 102. As further shown in FIGS. 2-5 and 19-46, the transfer duct 114 is coupled to, located within, housed by, and/or carried by the external housing 110 of the control unit 108. The transfer duct 114 is configured to receive the pressurized flow of air generated by the airflow generator 112 of the control unit 108, and to thereafter transport, guide, direct, and/or otherwise carry the received pressurized flow of air to and/or toward the sidewall 202 of the support ring 102 and/or the inlet 1202 of the interior duct 104 of the temperature control accessory 100. In some examples, an example thermal gasket 2006 is positioned between the transfer duct 114 of the control unit 108 and the sidewall 202 of the support ring 102, with the thermal gasket 2006 being configured to insulate the junction between the transfer duct 114 and the sidewall 202.

As shown in FIGS. 2-5 and 19-46, the inlet 1316 located at the first end 1302 of the transfer duct 114 is configured to receive the pressurized flow of air generated by the airflow generator 112. The inlet 1316 of the transfer duct 114 is accordingly in fluid communication with the outlet 2502 of the airflow generator 112. The outlet 1318 located at the second end 1304 of the transfer duct 114 is configured to expel the pressurized flow of air as it reaches the second end 1304 of the transfer duct 114. In this regard, the outlet 1318 of the transfer duct 114 is located proximate to (e.g., adjacent to or in contact with) the sidewall 202 of the support ring 102, with the outlet 1318 of the transfer duct 114 being aligned with and/or otherwise being in fluid communication with the second opening 604 formed in the sidewall 202 of the support ring 102. The outlet 1318 of the transfer duct 114 is also aligned with and/or is otherwise in fluid communication with the inlet 1202 of the interior duct 104 such that the pressurized flow of air generated by the airflow generator 112 of the control unit 108 travels, passes, and/or is directed along an airflow pathway (e.g., defined in part by the flow chamber 1312 of the transfer duct 114) extending from the outlet 2502 of the airflow generator 112 toward and/or into the inlet 1316 of the transfer duct 114, from the inlet 1316 of the transfer duct 114 toward and/or into the outlet 1318 of the transfer duct 114, from the outlet 1318 of the transfer duct 114 through the second opening 604 formed in the sidewall 202 of the support ring 102 toward and/or into the inlet 1202 of the interior duct 104, from the inlet 1202 of the interior duct 104 toward and/or into the outlet 308 of the interior duct 104, and from the outlet 308 of the interior duct 104 toward and/or into a cooking chamber of a kettle grill on which the temperature control accessory 100 is installed.

Once the temperature control accessory 100 has been installed on a kettle grill, the airflow generator 112 of the control unit 108 of FIGS. 2-5 and 19-46 can selectively be activated (e.g., turned “ON”) or deactivated (e.g., turned “OFF”) via one or more command(s), instruction(s), and/or signal(s) transmitted to the airflow generator 112 from the controller 130. When the airflow generator 112 is activated, the airflow generator 112 generates a pressurized flow of air (e.g., a positive airflow) that travels from the airflow generator 112 downstream through the transfer duct 114 and the interior duct 104 of the temperature control accessory 100 into the cooking chamber of the kettle grill. The pressurized flow of air generated by the activated airflow generator 112 minimizes (e.g., reduces, limits, or prevents) heated air located within the cooking chamber of the kettle grill from migrating upstream back through the interior duct 104 and the transfer duct 114 of the temperature control accessory 100 toward the various electrical and/or electromechanical component(s) of the control unit 108 of the temperature control accessory 100. Such components, which include the airflow generator 112, the user interface 120 (e.g., including the input device(s) 122 and the output device(s) 124), the network interface 126 (e.g., including the communication device(s) 128), the controller 130, the memory 132, and/or the power supply 134 of the control unit 108 are accordingly protected from exposure to undesirably hot and/or elevated temperatures while the airflow generator 112 of the control unit 108 is activated.

When the airflow generator 112 of the control unit 108 of FIGS. 2-5 and 19-46 is deactivated, the airflow generator 112 no longer generates a pressurized flow of air (e.g., a positive airflow) that travels from the airflow generator 112 downstream through the transfer duct 114 and the interior duct 104 of the temperature control accessory 100 into the cooking chamber of the kettle grill. In the absence of such a pressurized flow of air traveling through the transfer duct 114 and the interior duct 104 of the temperature control accessory 100, heated air located within the cooking chamber of the kettle grill can potentially migrate upstream back through the interior duct 104 and the transfer duct 114 of the temperature control accessory 100 toward the various electrical and/or electromechanical component(s) of the control unit 108 of the temperature control accessory 100 which, as mentioned above, can include the airflow generator 112, the user interface 120 (e.g., including the input device(s) 122 and the output device(s) 124), the network interface 126 (e.g., including the communication device(s) 128), the controller 130, the memory 132, and/or the power supply 134 of the control unit 108. Such component(s) can therefore potentially be exposed to undesirably hot and/or elevated temperatures while the airflow generator 112 of the control unit 108 is deactivated.

To mitigate (e.g., prevent) the possibility of such adverse temperature exposure, the control unit 108 of FIGS. 2-5 and 19-46 is equipped with a cooling system that can advantageously be activated, engaged, and/or otherwise implemented while the airflow generator 112 of the control unit 108 is not activated (e.g., while the airflow generator 112 is deactivated and/or turned “OFF”). The cooling system of the control unit 108 of FIGS. 2-5 and 19-46 is implemented via the shutter 116 of the control unit 108. As described above in connection with FIGS. 13-18, the shutter 116 of the control unit 108 is movable (e.g., slidable) relative to the transfer duct 114 of the control unit 108 between the non-blocking position 1700 shown in FIGS. 17 and 19-32 and the blocking position 1800 shown in FIGS. 18 and 33-46.

Positioning the shutter 116 of the control unit 108 in the non-blocking position 1700 shown in FIGS. 17 and 19-32 causes the opening 1508 formed in the panel 1502 of the shutter 116 to be aligned with and/or to otherwise be in fluid communication with the flow chamber 1312 of the transfer duct 114. The alignment between the opening 1508 of the panel 1502 of the shutter 116 and the flow chamber 1312 of the transfer duct 114 enables a pressurized flow of air to travel through the flow chamber 1312 of the transfer duct 114 (e.g., from the inlet 1316 of the transfer duct 114 to the outlet 1318 of the transfer duct 114) without the pressurized flow of air being blocked, impeded, restricted, and/or otherwise obstructed by the panel 1502 of the shutter 116. It is accordingly advantageous for the shutter 116 of the control unit 108 to be positioned in the non-blocking position 1700 of FIGS. 17 and 19-32 at times when the airflow generator 112 of the control unit 108 is activated and/or turned “ON.”

Conversely, positioning the shutter 116 of the control unit 108 in the blocking position 1800 shown in FIGS. 18 and 33-46 causes the opening 1508 formed in the panel 1502 of the shutter 116 to no longer be aligned with and/or to no longer be in fluid communication with the flow chamber 1312 of the transfer duct 114. The lack of alignment between the opening 1508 of the panel 1502 of the shutter 116 and the flow chamber 1312 of the transfer duct 114 results in a pressurized flow of air that would otherwise travel through the flow chamber 1312 of the transfer duct 114 (e.g., from the inlet 1316 of the transfer duct 114 to the outlet 1318 of the transfer duct 114) being blocked, impeded, restricted, and/or otherwise obstructed by the panel 1502 of the shutter 116. It is accordingly advantageous for the shutter 116 of the control unit 108 to be positioned in the blocking position 1800 of FIGS. 18 and 33-46 at times when the airflow generator 112 of the control unit 108 is deactivated and/or turned “OFF,” thereby mitigating (e.g., eliminating) the possibility of any electrical and/or electromechanical component(s) of the control unit 108 being exposed to adverse temperature conditions.

Movement (e.g., sliding) of the shutter 116 of the control unit 108 relative to the transfer duct 114 of the control unit 108 between the non-blocking position 1700 of FIGS. 17 and 19-32 and the blocking position 1800 of FIGS. 18 and 33-46 is facilitated via the tab 1510 of the shutter 116. In this regard, the tab 1510 of the shutter 116 effectively functions as a switch (e.g., the shutter switch 118 of FIG. 1 described above) that is movable between a first position (e.g., a pushed rearward position) associated with the non-blocking position 1700 of the shutter 116 and a second position (e.g., a pulled forward position) associated with the blocking position 1800 of the shutter 116. As shown in FIGS. 2-5 and 19-46, the tab 1510 of the shutter 116 of the control unit 108 is preferably located along a portion of the control unit 108 that is readily accessible to a user of the control unit 108, such as a front portion of the external housing 110 of the control unit 108. In other examples, the tab 1510 of the shutter 116 can be omitted and/or eliminated entirely, with operation of the shutter 116 being automated by the controller 130 of the control unit 108. For example, the controller 130 of the control unit 108 can be configured to automatically command, instruct, signal, and/or otherwise cause (e.g., via one or more motor(s), one or more solenoid(s), etc.) the shutter 116 to assume the non-blocking position 1700 of FIGS. 17 and 19-32 in response to the controller 130 determining and/or detecting that the airflow generator 112 of the control unit 108 has been activated and/or turned “ON,” and/or to automatically command, instruct, signal, and/or otherwise cause (e.g., via one or more motor(s), one or more solenoid(s), etc.) the shutter 116 to assume the blocking position 1800 of FIGS. 18 and 33-46 in response to the controller 130 determining and/or detecting that the airflow generator 112 of the control unit 108 has been deactivated and/or turned “OFF.”

In the illustrated example of FIGS. 2-5 and 17-46, movement of the tab 1510 of the shutter 116 from the first position (e.g., as shown in FIGS. 17 and 19-32) toward and/or into the second position (e.g., as shown in FIGS. 18 and 33-46) can be facilitated by a user pushing the tab 1510 toward the transfer duct 114 of the control unit 108. Pushing the tab 1510 toward the transfer duct 114 causes the panel 1502 of the shutter 116 to slide within the slot 1324 of the transfer duct 114 in a first direction (e.g., the first crosswise direction 1702 of FIG. 17) that is crosswise (e.g., transverse) relative to the central axis 1314 of the flow chamber 1312 of the transfer duct 114, with such sliding movement continuing until the opening 1508 of the panel 1502 of the shutter 116 is positioned in alignment with the flow chamber 1312 of the transfer duct 114, and/or until the stepped portion 1606 of the upper flange 1604 of the shutter 116 contacts and/or otherwise engages an interior surface of the first sidewall 1306 of the transfer duct 114. Contact and/or engagement between the stepped portion 1606 of the upper flange 1604 of the shutter 116 and an interior surface of the first sidewall 1306 of the transfer duct 114 prevents the panel 1502 and/or, more generally, the shutter 116 from inadvertently being overextended through (e.g., pushed too far within) the slot 1324 of the transfer duct 114 by a user of the temperature control accessory 100 in connection with the user moving (e.g., sliding) the shutter 116 into the non-blocking position 1700. As shown in FIG. 20, when the shutter 116 is positioned in the non-blocking position 1700 of FIGS. 17 and 19-32, the protrusion 1402 of the transfer duct 114 is positioned within and/or received by the first detent 1610 of the lower flange 1608 of the shutter 116.

Conversely, movement of the tab 1510 of the shutter 116 from the second position (e.g., as shown in FIGS. 18 and 33-46) toward and/or into the first position (e.g., as shown in FIGS. 17 and 19-32) can be facilitated by a user pulling the tab 1510 away from the transfer duct 114 of the control unit 108. Pulling the tab 1510 away from the transfer duct 114 causes the panel 1502 of the shutter 116 to slide within the slot 1324 of the transfer duct 114 in a second direction (e.g., the second crosswise direction 1802 of FIG. 18) that is crosswise (e.g., transverse) relative to the central axis 1314 of the flow chamber 1312 of the transfer duct 114, with such sliding movement continuing until the opening 1508 of the panel 1502 of the shutter 116 is no longer positioned in alignment with the flow chamber 1312 of the transfer duct 114, and/or until the stopper 1602 of the shutter 116 contacts and/or otherwise engages an exterior surface of the first sidewall 1306 of the transfer duct 114. Contact and/or engagement between the stopper 1602 of the shutter 116 and an exterior surface of the first sidewall 1306 of the transfer duct 114 prevents the panel 1502 and/or, more generally, the shutter 116 from inadvertently being withdrawn from (e.g., pulled out of) the slot 1324 of the transfer duct 114 by a user of the temperature control accessory 100 in connection with the user moving (e.g., sliding) the shutter 116 into the blocking position 1800. As shown in FIG. 34, when the shutter 116 is positioned in the blocking position 1800 of FIGS. 18 and 33-46, the protrusion 1402 of the transfer duct 114 is positioned within and/or received by the second detent 1612 of the lower flange 1608 of the shutter 116.

While the aforementioned implementation of the shutter 116 of the control unit 108 incorporates a slidable panel (e.g., the panel 1502) that is configured to move (e.g., slide) transversely across and/or relative to the flow chamber 1312 of the transfer duct 114 of the control unit 108, other contemplated implementations of the shutter 116 can similarly facilitate the shutter 116 being transitioned between a non-blocking position and a blocking position. For example, the shutter 116 can instead be implemented by one or more rotatable panel(s) that is/are rotatable within the flow chamber 1312 of the transfer duct 114 between a non-blocking position that does not block, impede, restrict, and/or otherwise obstruct a pressurized flow of air from passing through the flow chamber 1312, and a blocking position that blocks, impedes, restricts, and/or otherwise obstructs a pressurized flow of air from passing through the flow chamber 1312. In some such examples, movement (e.g., rotation) of the rotatable panel(s) between the non-blocking position and the blocking position can be facilitated by movement of a switch (e.g., the shutter switch 118 of FIG. 1) that is mechanically and/or operatively coupled (either directly or indirectly) to the rotatable panel(s). In still other examples, movement (e.g., rotation) of the rotatable panel(s) between the non-blocking position and the blocking position can be facilitated by the airflow generator 112 of the control unit 108. For example, when the airflow generator 112 is activated and/or turned “ON,” the flow of air generated by the airflow generator 112 may be of sufficient strength and/or force to cause the rotatable panel(s) to transition from a blocking position into a non-blocking position. Conversely, when the airflow generator 112 is deactivated and/or turned “OFF,” the flow of air generated by the airflow generator 112 ceases, and the rotatable panel(s) transition back from the non-blocking position into the blocking position.

In still other examples, the shutter 116 can be eliminated entirely in favor of a windsock positioned within the transfer duct 114 of the control unit 108. In such examples, the windsock is configured to provide a thermal barrier that is dependent upon the flow of air generated by the airflow generator 112 of the control unit 108. For example, when the airflow generator 112 is activated and/or turned “ON,” the flow of air generated by the airflow generator 112 is received within the windsock, thereby causing the windsock to inflate and/or otherwise expand. The inflation and/or expansion of the windsock enables the flow of air to pass through the flow chamber 1312 of the transfer duct 114 (e.g., from the inlet 1316 of the transfer duct 114 to the outlet 1318 of the transfer duct 114). Conversely, when the airflow generator 112 is deactivated and/or turned “OFF,” the flow of air generated by the airflow generator 112 ceases, thereby causing the windsock to deflate and/or contract. The deflation and/or contraction of the windsock prevents any flow of air (e.g., both downstream and upstream) from passing entirely through the transfer duct 114. The windsock accordingly provides a protective thermal barrier when the airflow generator 112 is deactivated and/or turned “OFF.”

FIG. 47 illustrates an example food temperature probe 4700 configured to be implemented with the temperature control accessory 100 of FIGS. 2-5. The food temperature probe 4700 of FIG. 47 includes an example probe shaft 4702 having an example free end 4704. The free end 4704 of the probe shaft 4702 has a pointed and/or spiked tip that facilitates inserting the probe shaft 4702, free end 4704 first, into an item of food (e.g., a piece of meat) such that the food temperature probe 4700 can sense, measure, and/or detect an internal temperature of the item of food. The food temperature probe 4700 of FIG. 47 further includes an example cable 4706 connected to the probe shaft 4702. The cable 4706 can be of any length. The cable 4706 is configured to be receivable and/or to fit (e.g., via a friction fit) in the slot 806 of the first seal 802 that is removably couplable to the support ring 102 of the temperature control accessory 100. The food temperature probe 4700 of FIG. 47 further includes an example jack plug 4708 connected to the probe cable 4706. The jack plug 4708 is configured to be plugged into any of one or more jack(s) of the control unit 108 of the temperature control accessory 100, with such jack(s) being accessible via corresponding ones of the above-described second opening(s) 2002 formed in the bottom surface of the external housing 110 of the control unit 108. The control unit 108 of the temperature control accessory 100 is configured to connect to and/or monitor multiple ones (e.g., two) of the food temperature probe 4700 of FIG. 47 at any given time.

FIG. 48 illustrates an example power cord 4800 configured to be implemented with the temperature control accessory 100 of FIGS. 2-5. The power cord 4800 of FIG. 48 includes an example plug 4802 configured to be connectable to the AC line power source 136 (e.g., a wall outlet). The power cord 4800 of FIG. 48 further includes an example cable 4804 connected to the plug 4802. The cable 4804 can be of any length. The power cord 4800 of FIG. 48 further includes an example connector 4806 connected to the cable 4804. The connector 4806 is configured to be plugged into the power supply 134 of the control unit 108 of the temperature control accessory 100, with the power supply 134 being accessible via the above-described first opening 2202 formed in the rear surface of the external housing 110 of the control unit 108. In some examples, the connector 4806 of the power cord 4800 is implemented as a USB-C connector and the power supply 134 of the control unit 108 is implemented as a rechargeable battery, with the power cord 4800 accordingly being configured to charge the power supply 134 when the connector 4806 of the power cord 4800 is plugged into the power supply 134 of the control unit 108 and the plug 4802 of the power cord 4800 is plugged into the AC line power source 136.

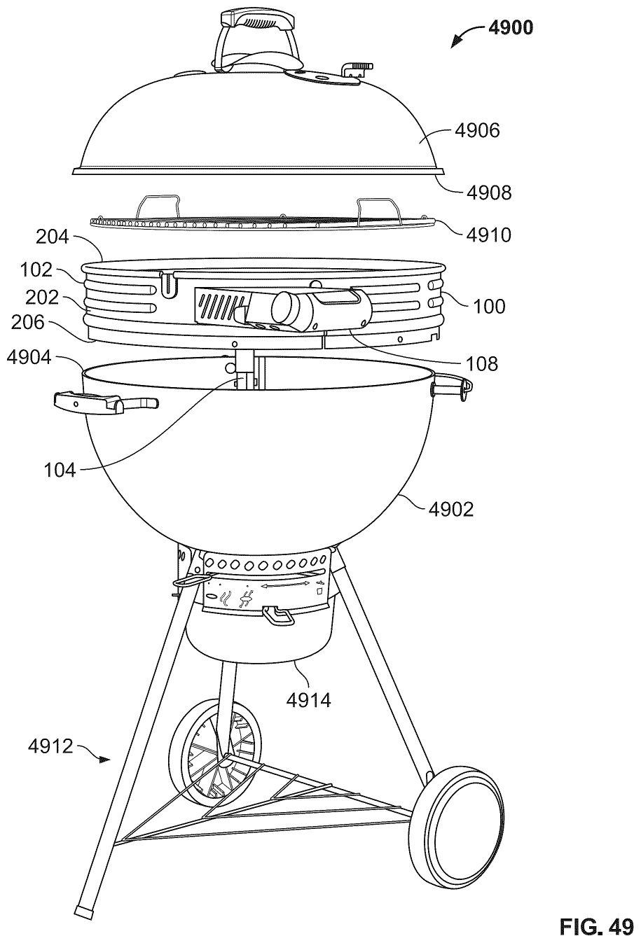

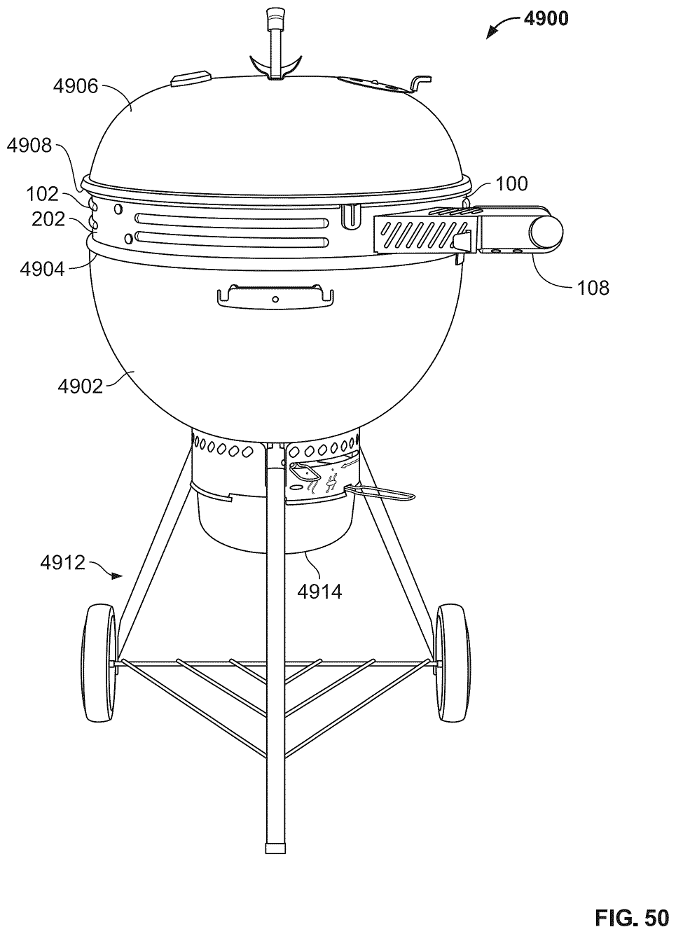

FIG. 49 is an exploded view of an example kettle grill 4900 including the temperature control accessory 100 shown FIGS. 2-5. FIG. 50 is an example assembled view of the kettle grill 4900 shown in FIG. 49, with the temperature control accessory 100 shown installed between a firebox and a lid of the kettle grill 4900. The kettle grill 4900 of FIGS. 49 and 50 includes an example firebox 4902 having an example upper rim 4904, and an example lid 4906 having an example lower rim 4908. In the illustrated example of FIGS. 49 and 50, the firebox 4902 is a bowl-shaped firebox and the lid 4906 is a dome-shaped lid. The upper rim 4904 of the firebox 4902 and the lower rim 4908 of the lid 4906 each have a circular shape. When the temperature control accessory 100 of FIGS. 2-5 is installed on the kettle grill 4900 of FIGS. 49 and 50, the lower rim 206 of the support ring 102 of the temperature control accessory 100 interfaces with the firebox 4902 of the kettle grill 4900, and the upper rim 204 of the support ring 102 of the temperature control accessory 100 interfaces with the lid 4906 of the kettle grill 4900. More specifically, the lower rim 206 of the support ring 102 is seated onto, circumscribed by, and/or nested within the upper rim 4904 of the firebox 4902, and the upper rim 204 of the support ring 102 is seated under, circumscribed by, and/or nested within the lower rim 4908 of the lid 4906. In other examples, the lower rim 206 of the support ring 102 can instead circumscribe the upper rim 4904 of the firebox 4902, and/or the upper rim 204 of the support ring can instead circumscribe the lower rim 4908 of the lid 4906.

When the temperature control accessory 100 of FIGS. 2-5 is installed on the kettle grill 4900 of FIGS. 49 and 50, a cooking chamber is formed by the firebox 4902 and the lid 4906 the kettle grill 4900 along with the support ring 102 of the temperature control accessory 100, with the support ring 102 interposing and/or extending between the firebox 4902 and the lid 4906. The cooking chamber is configured to cook (e.g., grill) one or more item(s) of food contained therein. In some examples, the lid 4906 of the kettle grill 4900 is movable relative to the firebox 4902 of the kettle grill 4900 and/or relative to the support ring 102 of the temperature control accessory 100 between a closed position and an open position. In such examples, the cooking chamber becomes accessible to a user of the kettle grill 4900 when the lid 4906 is moved from the closed position toward or into the open position. Conversely, the cooking chamber is generally inaccessible to the user of the kettle grill 4900 when the lid 4906 is in the closed position. User access to the cooking chamber of the kettle grill 4900 may periodically become necessary, for example, to add an item of food to the cooking chamber (e.g., at or toward the beginning of a cooking process), to remove an item of food from the cooking chamber (e.g., at or toward the end of a cooking process), and/or to flip, rotate, relocate, or otherwise move an item of food within the cooking chamber (e.g., during the middle of a cooking process).

In the illustrated example of FIGS. 49 and 50, the kettle grill 4900 further includes an example fuel grate, an example cooking grate 4910, an example support frame 4912, and an example ash catcher 4914. The fuel grate is configured to support charcoal fuel (e.g., charcoal briquettes) within the firebox 4902 and/or within the cooking chamber of the kettle grill 4900. The cooking grate 4910 is located above the fuel grate, with the cooking grate 4910 being configured to support one or more item(s) of food to be cooked within the cooking chamber of the kettle grill 4900 via heat generated from combustion of the charcoal fuel. The support frame 4912 is configured to support the firebox 4902 of the kettle grill 4900 at a position above an underlying ground surface. The ash catcher 4914 is configured to receive and/or collect ash and/or other debris generated during a cooking process that occurs within the cooking chamber of the kettle grill 4900. In this regard, the bottom of the firebox 4902 of the kettle grill 4900 includes one or more opening(s) configured to allow ash and/or other debris generated during the cooking process to pass from the bottom of the firebox 4902, through such opening(s), into the ash catcher 4914.

When the temperature control accessory 100 of FIGS. 2-5 is installed on the kettle grill 4900 of FIGS. 49 and 50, the controller 130 of the control unit 108 of the temperature control accessory 100 controls the operation of the airflow generator 112 of the control unit 108 to achieve a controlled temperature within the cooking chamber of the kettle grill 4900. In this regard, the controller 130 controls the operation of the airflow generator 112 to regulate a temperature measured from within the cooking chamber (e.g., via the temperature sensor 106 of the temperature control accessory 100) of the kettle grill 4900 relative to a specified temperature setpoint. In some examples, the controller 130 regulates the measured temperature relative to the specified temperature setpoint by operating the airflow generator 112 according to a PID control loop that utilizes the measured temperature as a feedback input to the PID control loop. Use of the example temperature control accessory 100 in conjunction with the kettle grill 4900 as shown in FIGS. 49 and 50 accordingly provides an automated mechanism to regulate the temperature within the cooking chamber of the kettle grill 4900, thereby producing a significant advantage relative to convention kettle grills which lack such an automated temperature control mechanism.

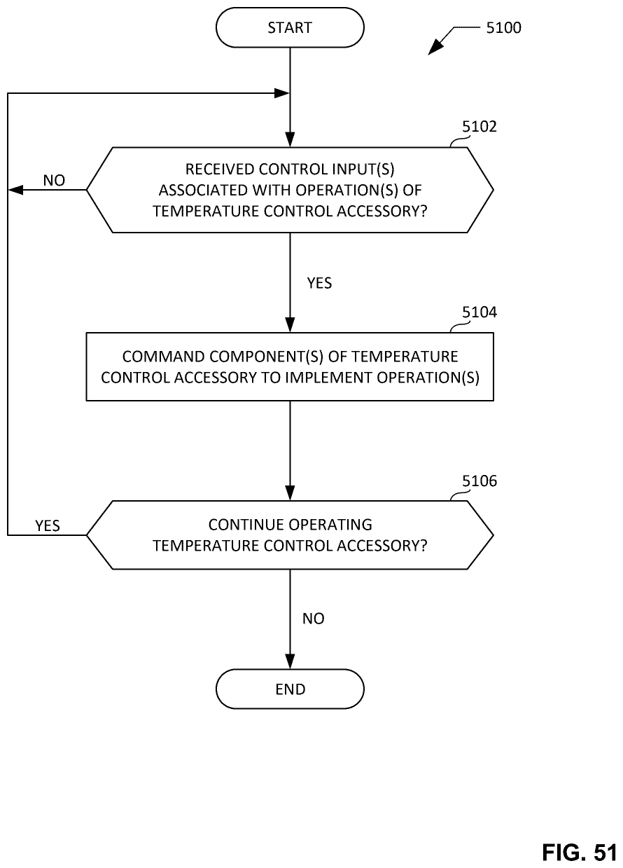

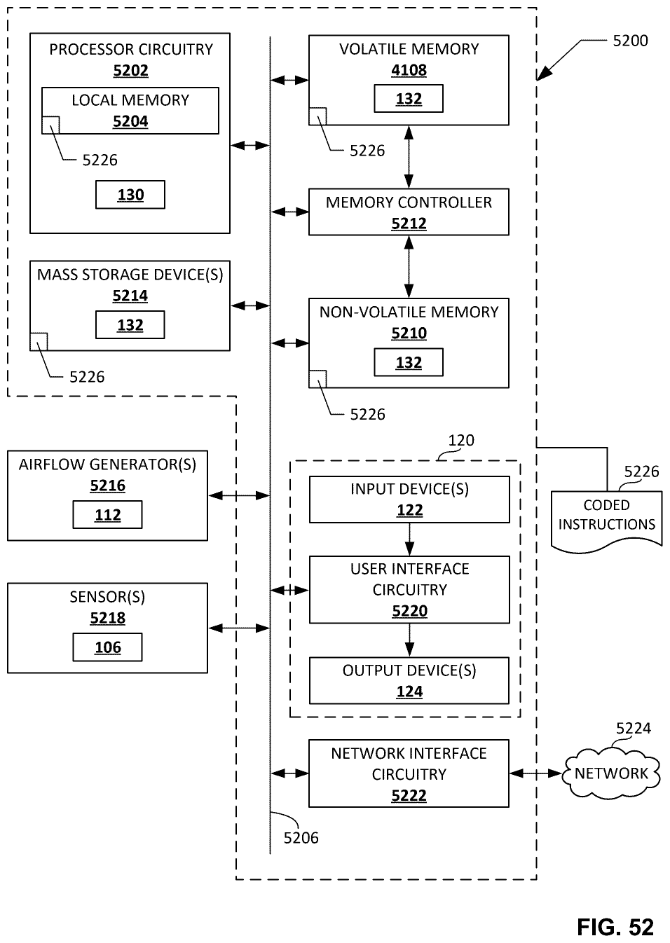

A flowchart representing example machine-readable instructions, which may be executed to configure processor circuitry to implement the temperature control accessory 100 of FIG. 1, is shown in FIG. 51. The machine-readable instructions may be one or more executable program(s) or portion(s) thereof for execution by processor circuitry, such as the processor circuitry 5202 shown in the example processor platform 5200 discussed below in connection with FIG. 52. The program(s) may be embodied in software stored on one or more non-transitory computer readable storage media such as an optical storage device, a magnetic storage device, a floppy disk drive, a hard disk drive (HDD), a solid state storage device, a flash memory, a read-only memory (ROM), a random-access memory (RAM), a volatile memory, a non-volatile memory, a cache, a CD, a DVD, a Blu-ray disk, and/or any other tangible storage device or tangible storage disk associated with processor circuitry located in one or more hardware device(s). Alternatively, the entire program(s) and/or the portion(s) thereof could be executed by one or more hardware device(s) other than the processor circuitry and/or embodied in firmware or dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer-readable storage media may include one or more medium(s) located in one or more hardware device(s). Further, although example programs are described with reference to the flowchart illustrated in FIG. 51, many other methods of implementing the temperature control accessory 100 of FIG. 1 may alternatively be used. For example, the order of execution of the blocks may be changed, and/or some of the blocks described may be changed, eliminated, or combined. Additionally, or alternatively, any or all of the blocks may be implemented by one or more hardware circuit(s) (e.g., processor circuitry) and/or hardware device(s) structured to perform the corresponding operation(s) without executing software or firmware. The hardware circuit(s) and/or hardware device(s) can be located on a single machine, or can be located across multiple machines in different network locations.

The machine-readable instructions described herein may be stored in one or more of a compressed format, an encrypted format, a fragmented format, a compiled format, an executable format, a packaged format, etc. Machine-readable instructions as described herein may be stored as data or a data structure (e.g., as portions of instructions, code, representations of code, etc.) that may be utilized to create, manufacture, and/or produce machine-executable instructions. For example, the machine-readable instructions may be fragmented and stored on one or more storage device(s) and/or computing device(s) (e.g., one or more server(s)) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or any other machine. For example, the machine-readable instructions may be stored in multiple parts, which are individually compressed, encrypted, and/or stored on separate computing devices, wherein the parts when decrypted, decompressed, and/or combined form a set of machine-executable instructions that implement one or more operation(s) that may together form a program such as that described herein.

In another example, the machine-readable instructions may be stored in a state in which they may be read by processor circuitry, but require addition of a library (e.g., a dynamic link library (DLL)), a software development kit (SDK), an application programming interface (API), etc., in order to execute the machine-readable instructions on a particular computing device or any other device. In another example, the machine-readable instructions may need to be configured (e.g., settings stored, data input, network addresses recorded, etc.) before the machine-readable instructions and/or the corresponding program(s) can be executed in whole or in part. Thus, machine-readable media, as used herein, may include machine-readable instructions and/or program(s) regardless of the particular format or state of the machine-readable instructions and/or program(s) when stored or otherwise at rest or in transit. The machine-readable instructions described herein can be represented by any past, present, or future instruction language, scripting language, programming language, etc. For example, the machine-readable instructions may be represented using any of the following languages: C, C++, C #, Java, JavaScript, Python, Perl, HyperText Markup Language (HTML), Structured Query Language (SQL), Non-relational SQL (NoSQL), Swift, etc.

As mentioned above, the example operations of FIG. 51 may be implemented using executable instructions (e.g., computer and/or machine-readable instructions) stored on one or more non-transitory computer and/or machine-readable media such as an optical storage device, a magnetic storage device, a hard disk drive (HDD), a solid state storage device, a flash memory, a read-only memory (ROM), a random-access memory (RAM), a volatile memory, a non-volatile memory, a cache, a CD, a DVD, a Blu-ray disk, and/or any other tangible storage device or tangible storage disk in which information is stored for any duration (e.g., permanently, for extended time periods, for brief instances, for temporarily buffering, and/or for caching of the information).

FIG. 51 is a flowchart representative of example machine-readable instructions and/or example operations 5100 that may be executed by processor circuitry (e.g., processor circuitry of the controller 130 of FIG. 1) to implement the temperature control accessory 100 of FIG. 1. The machine-readable instructions and/or operations 5100 of FIG. 51 begin at Block 5102 when the processor circuitry of the controller 130 of FIG. 1 determines whether one or more control input(s) associated with one or more operation(s) of the temperature control accessory 100 of FIG. 1 has/have been received. For example, the processor circuitry of the controller 130 can determine whether the user interface 120 and/or the network interface 126 of the control unit 108 of FIG. 1 has/have received any commands, instructions, signals, inputs, and/or other data indicative of a control input associated with an operation of the temperature control accessory 100 (e.g., e.g., a desired ON/OFF state, a desired temperature, a desired airflow generator speed, a desired cooking mode, a desired cooking recipe, a desired cooking program, and/or any other state, setting, selection, mode, or program pertaining to an operation of the temperature control accessory 100). If the processor circuitry of the controller 130 determines at Block 5102 that one or more control input(s) associated with one or more operation(s) of the temperature control accessory 100 has/have been received, control of the machine-readable instructions and/or operations 5100 of FIG. 51 proceeds to Block 5104. If the processor circuitry of the controller 130 instead determines at Block 5102 that no control input associated with an operation of the temperature control accessory 100 has been received, control of the machine-readable instructions and/or operations 5100 of FIG. 51 remains at Block 5102.

At Block 5104, the processor circuitry of the controller 130 of FIG. 1 commands, instructs, signals, and/or otherwise causes one or more of component(s) (e.g., the airflow generator 112) of the control unit 108 of FIG. 1 to operate in a manner that corresponds to, achieves, and/or otherwise implements respective ones of the received control input(s) which the processor circuitry of the controller 130 determined at Block 5102 to be associated with the operation(s) of temperature control accessory 100. For example, the controller 130 can command, instruct, signal, and/or otherwise cause the airflow generator 112 of the control unit 108 to operate at a specific rate and/or at specific rate(s) over one or more time interval(s) to achieve a controlled temperature within a cooking chamber of a kettle grill. In some examples, the controlled temperature is based on a temperature setpoint selected and/or otherwise indicated by a user of the temperature control accessory 100 and/or the kettle grill. In other examples, the controlled temperature may vary over time based on different steps of a cooking recipe, a cooking profile, or a cooking program that is conveyed to the controller 130 of the temperature control accessory 100. In some examples, the execution and/or performance of Block 5104 by the processor circuitry of the controller 130 is based in part on temperature data sensed, measured, detected, and/or otherwise obtained by or from the temperature sensor 106 of the temperature control accessory 100 of FIG. 1. For example, the processor circuitry of the controller 130 may consider and/or utilize such temperature data as an input to a control loop (e.g., a feedback input to a PID control loop) implemented by the processor circuitry of the controller 130 in connection with the execution and/or performance of Block 5104. In this regard, the controller 130 can control the operation of the airflow generator 112 to regulate a temperature measured from within the cooking chamber of the kettle grill relative to a specified temperature setpoint. Following Block 5104, control of the machine-readable instructions and/or operations 5100 of FIG. 51 proceeds to Block 5106.

At Block 5106, the processor circuitry of the controller 130 of FIG. 1 determines whether to continue operating the temperature control accessory 100. For example, the processor circuitry of the controller 130 can determine whether the user interface 120 and/or the network interface 126 of the control unit 108 of FIG. 1 has/have received any commands, instructions, signals, inputs, and/or other data indicative of a request to terminate the process and/or protocol of FIG. 51, and/or more generally, to cease operating the temperature control accessory 100. If the processor circuitry of the controller 130 determines at Block 5106 that the process and/or protocol of FIG. 51 is to continue (e.g., that no termination request has been received), control of the machine-readable instructions and/or operations 5100 of FIG. 51 returns to Block 5102. If the processor circuitry of the controller 130 instead determines at Block 4006 that the process and/or protocol of FIG. 51 is to cease or terminate (e.g., that a termination request has been received), the machine-readable instructions and/or operations 5100 of FIG. 51 end.

FIG. 52 is a block diagram of an example processor platform 5200 including processor circuitry structured to execute and/or instantiate the machine-readable instructions and/or operations 5100 of FIG. 51 to implement the temperature control accessory 100 of FIG. 1. The processor platform 5200 of the illustrated example includes processor circuitry 5202. The processor circuitry 5202 of the illustrated example is hardware. For example, the processor circuitry 5202 includes any type(s) and/or any number(s) of processor(s), microprocessor(s), controller(s), microcontroller(s), ASIC(s), PLD(s), FPLD(s), FPGA(s), DSP(s), GPU(s), CPU(s), semiconductor-based (e.g., silicon-based) circuit(s), digital circuit(s), analog circuit(s), logic circuit(s), and/or integrated circuit(s) implemented by any type(s) and/or any number(s) of transistor(s), capacitor(s), diode(s), inductor(s), resistor(s), timer(s), counter(s), printed circuit board(s), connector(s), wire(s), and/or other electrical circuit component(s). In this example, the processor circuitry 5202 implements the controller 130 of the control unit 108 and/or, more generally, of the temperature control accessory 100 of FIG. 1.

The processor circuitry 5202 of the illustrated example includes a local memory 5204 (e.g., a cache, registers, etc.). The processor circuitry 5202 is in electrical communication with a main memory via a bus 5206, with the main memory including a volatile memory 5208 and a non-volatile memory 5210. The volatile memory 5208 may be implemented by any type of random-access memory (RAM) (e.g., Synchronous Dynamic Random Access Memory (SDRAM), Dynamic Random Access Memory (DRAM), RAMBUS® Dynamic Random Access Memory (RDRAM®), etc.). The non-volatile memory 5210 may be implemented by flash memory and/or any other desired type of memory device. Access to the main memory 5208, 5210 of the illustrated example is controlled by a memory controller 5212.

The processor platform 5200 of the illustrated example also includes one or more mass storage device(s) 5214 to store software and/or data. Examples of such mass storage device(s) 5214 include an optical storage device, a magnetic storage device, a floppy disk drive, a hard disk drive (HDD), a solid state storage device, a flash memory device, a read-only memory (ROM), a random-access memory (RAM), a cache, a CD, a DVD, a Blu-ray disk, and/or any other tangible storage device or tangible storage disk in which information is stored for any duration (e.g., permanently, for extended time periods, for brief instances, for temporarily buffering, and/or for caching of the information). In the illustrated example of FIG. 52, one or more of the volatile memory 5208, the non-volatile memory 5210, and/or the mass storage device(s) 5214 implement(s) the memory 132 of the control unit 108 and/or, more generally, of the temperature control accessory 100 of FIG. 1.

The processor circuitry 5202 is also in electrical communication with one or more airflow generator(s) 5216 via the bus 5206. In this example, the airflow generator(s) 5216 include the airflow generator 112 of the control unit 108 and/or, more generally, of the temperature control accessory 100 of FIG. 1. The processor circuitry 5202 is also in electrical communication with one or more sensor(s) 5218 via the bus 5206. In this example, the sensor(s) 5218 include the temperature sensor 106 of the temperature control accessory 100 of FIG. 1.

The processor platform 4100 of the illustrated example also includes user interface circuitry 5220. The user interface circuitry 5220 may be implemented by hardware in accordance with any type of interface standard, such as an Ethernet interface, a universal serial bus (USB) interface, a Bluetooth® interface, a near field communication (NFC) interface, a PCI interface, and/or a PCIe interface. In the illustrated example, one or more input device(s) 122 are connected to the user interface circuitry 5220. The input device(s) 122 permit(s) a user to enter data and/or commands into the processor circuitry 5202. The input device(s) 122 can be implemented, for example, by one or more of a touchscreen, a button, a dial, a knob, a switch, an audio sensor, a microphone, an image sensor, a camera, and/or a voice recognition system. One or more output device(s) 124 are also connected to the user interface circuitry 5220 of the illustrated example. The output device(s) 124 can be implemented, for example, by one or more of a display device (e.g., a light emitting diode (LED), an organic light emitting diode (OLED), a liquid crystal display (LCD), a cathode ray tube (CRT) display, an in-plane switching (IPS) display, a touchscreen, etc.), a tactile output device, and/or a speaker. The user interface circuitry 5220 of the illustrated example, thus, typically includes a graphics driver card, a graphics driver chip, and/or graphics processor circuitry such as a GPU. In the illustrated example of FIG. 52, the user interface circuitry 5220, the input device(s) 122, and the output device(s) 124 collectively implement the user interface 120 of the control unit 108 and/or, more generally, of the temperature control accessory 100 of FIG. 1.

The processor platform 5200 of the illustrated example also includes network interface circuitry 5222. The network interface circuitry 5222 includes one or more communication device(s) (e.g., transmitter(s), receiver(s), transceiver(s), modem(s), gateway(s), wireless access point(s), etc.) to facilitate exchange of data with external machines (e.g., computing devices of any kind, including the remote device(s) 138 of FIG. 1) by a network 5224. The communication can be by, for example, a satellite system, a wireless system, a cellular telephone system, an Ethernet connection, a digital subscriber line (DSL) connection, a telephone line connection, a coaxial cable system, an optical connection, etc. In the illustrated example of FIG. 52, the network interface circuitry 5222 implements the network interface 126 (e.g., including the communication device(s) 128) of the control unit 108 and/or, more generally, of the temperature control accessory 100 of FIG. 1.

Coded instructions 5226 including the above-described machine-readable instructions and/or operations 5100 of FIG. 51 may be stored in the local memory 5204, in the volatile memory 5208, in the non-volatile memory 5210, on the mass storage device(s) 5214, and/or on a removable non-transitory computer-readable storage medium such as a flash memory stick, a dongle, a CD, a DVD, or a Blu-ray disk.

The following paragraphs provide various examples in relation to the disclosed temperature control accessories for charcoal-fueled kettle grills.

Example 1 includes a temperature control accessory for a kettle grill. In Example 1, the temperature control accessory comprises a support ring, an interior duct, and a control unit. The support ring includes a sidewall. The interior duct is located internally relative to the sidewall of the support ring. The control unit is located externally relative to the sidewall of the support ring. The control unit includes an airflow generator configured to generate a flow of air. The flow of air generated by the airflow generator is to pass from the airflow generator, through an opening formed in the sidewall of the support ring, and into the interior duct.

Example 2 includes the temperature control accessory of Example 1. In Example 2, the control unit includes a controller operatively coupled to the airflow generator. The controller is configured to operate the airflow generator to control a temperature within a cooking chamber of the kettle grill.

Example 3 includes the temperature control accessory of Example 2. In Example 3, the controller is configured to operate the airflow generator to regulate a measured temperature of the cooking chamber relative to a temperature setpoint.

Example 4 includes the temperature control accessory of Example 3. In Example 4, the temperature control accessory comprises a temperature sensor having a sensing portion located internally relative to the sidewall of the support ring. The temperature sensor is configured to sense the measured temperature of the cooking chamber.

Example 5 includes the temperature control accessory of Example 4. In Example 5, the support ring includes a sensor mounting bracket coupled to and located internally relative to the sidewall of the support ring. The sensor mounting bracket is configured to support or carry the temperature sensor.

Example 6 includes the temperature control accessory of Example 1. In Example 6, the interior duct includes a first end having an inlet, a second end having an outlet, and a sidewall extending between the inlet and the outlet. The first end of the interior duct is coupled to the sidewall of the support ring such that the inlet of the interior duct is in fluid communication with the opening formed in the sidewall of the support ring.

Example 7 includes the temperature control accessory of Example 6. In Example 7, the flow of air generated by the airflow generator is to pass along an airflow pathway extending from the airflow generator, through the opening formed in the sidewall of the support ring, through the inlet and through the outlet of the interior duct, and into a cooking chamber of the kettle grill.

Example 8 includes the temperature control accessory of Example 6. In Example 8, the sidewall of the interior duct extends downwardly from the support ring such that the outlet of the interior duct is located below a lower rim of the support ring.

Example 9 includes the temperature control accessory of Example 8. In Example 9, the outlet of the interior duct is configured to be vertically oriented at a normal angle relative to a surrounding area of an interior surface of a firebox of the kettle grill.

Example 10 includes the temperature control accessory of Example 6. In Example 10, the control unit includes a transfer duct located between the airflow generator of the control unit and the sidewall of the support ring. The transfer duct includes a first end having an inlet, a second end having an outlet, and a flow chamber extending between the inlet and the outlet. The inlet of the transfer duct is in fluid communication with an outlet of the airflow generator. The second end of the transfer duct is coupled to the sidewall of the support ring such that the outlet of the transfer duct is in fluid communication with the opening formed in the sidewall of the support ring.

Example 11 includes the temperature control accessory of Example 10. In Example 11, the flow of air generated by the airflow generator is to pass along an airflow pathway extending from the airflow generator, through the inlet, through the flow chamber, and through the outlet of the transfer duct, through the opening formed in the sidewall of the support ring, through the inlet and through the outlet of the interior duct, and into a cooking chamber of the kettle grill.

Example 12 includes the temperature control accessory of Example 11. In Example 12, the control unit includes a shutter associated with the transfer duct and movable between a non-blocking position and a blocking position. A portion of the flow chamber of the transfer duct is unblocked when the shutter is in the non-blocking position and blocked when the shutter is in the blocking position.

Example 13 includes the temperature control accessory of Example 12. In Example 13, the shutter includes a panel having an opening. The panel is slidable within a slot formed in the transfer duct. The panel is configured such that the opening of the panel is aligned with the flow chamber of the transfer duct when the shutter is in the non-blocking position and such that the opening of the panel is not aligned with the flow chamber of the transfer duct when the shutter is in the blocking position. Movement of the shutter between the non-blocking position and the blocking position occurs in a direction that is crosswise relative to a central axis of the flow chamber of the transfer duct.

Example 14 includes the temperature control accessory of Example 13. In Example 14, movement of the shutter between the non-blocking position and the blocking position occurs in response to user interaction with a tab of the shutter. The tab is accessible to the user from a location outside of an external housing of the control unit.

Example 15 includes the temperature control accessory of Example 13. In Example 15, the transfer duct includes a protrusion located along and extending downward from a bottom wall of the transfer duct. The shutter includes a lower flange having a first detent and a second detent spaced apart from the first detent. The protrusion is received in the first detent when the shutter is in the non-blocking position. The protrusion is received in the second detent when the shutter is in the blocking position.

Example 16 includes the temperature control accessory of Example 1. In Example 16, the support ring includes an upper rim and a lower rim. The upper rim is configured to interface with a lid of the kettle grill. The lower rim is configured to interface with a firebox of the kettle grill. The sidewall of the support ring extends between the upper rim and the lower rim of the support ring.

Example 17 includes the temperature control accessory of Example 16. In Example 17, the lower rim of the support ring is configured to be seated on, circumscribed by, or nested within an upper rim of the firebox, and the upper rim of the support ring is configured to be seated under, circumscribed by, or nested within a lower rim of the lid.

Example 18 includes the temperature control accessory of Example 16. In Example 18, the upper rim and the lower rim of the support ring have a circular shape.

Example 19 includes the temperature control accessory of Example 1. In Example 19, the support ring includes a plurality of support flanges coupled to and extending internally relative to the sidewall of the support ring. Respective ones of the support flanges are configured to support a cooking grate.

Example 20 includes the temperature control accessory of Example 1. In Example 20, the support ring includes circumferentially opposed openings formed in the sidewall of the support ring. Each one of the circumferentially opposed openings is configured to receive a portion of a rotisserie spit when the rotisserie spit is in use with the temperature control accessory. Each one of the circumferentially opposed openings is further configured to receive a seal when the rotisserie spit is not in use with the temperature control accessory.

Although certain example apparatus, systems, methods, and articles of manufacture have been disclosed herein, the scope of coverage of this patent is not limited thereto. On the contrary, this patent covers all apparatus, systems, methods, and articles of manufacture fairly falling within the scope of the claims of this patent.

The following claims are hereby incorporated into this Detailed Description by this reference, with each claim standing on its own as a separate embodiment of the present disclosure.

What is claimed is:

1. A temperature control accessory for a kettle grill, the temperature control accessory comprising:
a support ring including a sidewall;
an interior duct located internally relative to the sidewall of the support ring; and
a control unit located externally relative to the sidewall of the support ring, the control unit including an airflow generator configured to generate a flow of air, the flow of air to pass from the airflow generator, through an opening formed in the sidewall of the support ring, and into the interior duct.

2. The temperature control accessory of claim 1, wherein the control unit includes a controller operatively coupled to the airflow generator, the controller configured to operate the airflow generator to control a temperature within a cooking chamber of the kettle grill.

3. The temperature control accessory of claim 2, wherein the controller is configured to operate the airflow generator to regulate a measured temperature of the cooking chamber relative to a temperature setpoint.

4. The temperature control accessory of claim 3, further comprising a temperature sensor having a sensing portion located internally relative to the sidewall of the support ring, the temperature sensor configured to sense the measured temperature of the cooking chamber.

5. The temperature control accessory of claim 4, wherein the support ring includes a sensor mounting bracket coupled to and located internally relative to the sidewall of the support ring, the sensor mounting bracket configured to support or carry the temperature sensor.

6. The temperature control accessory of claim 1, wherein the interior duct includes a first end having an inlet, a second end having an outlet, and a sidewall extending between the inlet and the outlet, wherein the first end of the interior duct is coupled to the sidewall of the support ring such that the inlet of the interior duct is in fluid communication with the opening formed in the sidewall of the support ring.

7. The temperature control accessory of claim 6, wherein the flow of air generated by the airflow generator is to pass along an airflow pathway extending from the airflow generator, through the opening formed in the sidewall of the support ring, through the inlet and through the outlet of the interior duct, and into a cooking chamber of the kettle grill.

8. The temperature control accessory of claim 6, wherein the sidewall of the interior duct extends downwardly from the support ring such that the outlet of the interior duct is located below a lower rim of the support ring.

9. The temperature control accessory of claim 8, wherein the outlet of the interior duct is configured to be vertically oriented at a normal angle relative to a surrounding area of an interior surface of a firebox of the kettle grill.

10. The temperature control accessory of claim 6, wherein the control unit includes a transfer duct located between the airflow generator of the control unit and the sidewall of the support ring, the transfer duct including a first end having an inlet, a second end having an outlet, and a flow chamber extending between the inlet and the outlet, wherein the inlet of the transfer duct is in fluid communication with an outlet of the airflow generator, and wherein the second end of the transfer duct is coupled to the sidewall of the support ring such that the outlet of the transfer duct is in fluid communication with the opening formed in the sidewall of the support ring.

11. The temperature control accessory of claim 10, wherein the flow of air generated by the airflow generator is to pass along an airflow pathway extending from the airflow generator, through the inlet, through the flow chamber, and through the outlet of the transfer duct, through the opening formed in the sidewall of the support ring, through the inlet and through the outlet of the interior duct, and into a cooking chamber of the kettle grill.

12. The temperature control accessory of claim 11, wherein the control unit includes a shutter associated with the transfer duct and movable between a non-blocking position and a blocking position, wherein a portion of the flow chamber of the transfer duct is unblocked when the shutter is in the non-blocking position and blocked when the shutter is in the blocking position.

13. The temperature control accessory of claim 12, wherein the shutter includes a panel having an opening, wherein the panel is slidable within a slot formed in the transfer duct, wherein the panel is configured such that the opening of the panel is aligned with the flow chamber of the transfer duct when the shutter is in the non-blocking position and such that the opening of the panel is not aligned with the flow chamber of the transfer duct when the shutter is in the blocking position, wherein movement of the shutter between the non-blocking position and the blocking position occurs in a direction that is crosswise relative to a central axis of the flow chamber of the transfer duct.

14. The temperature control accessory of claim 13, wherein movement of the shutter between the non-blocking position and the blocking position occurs in response to user interaction with a tab of the shutter, wherein the tab is accessible to the user from a location outside of an external housing of the control unit.

15. The temperature control accessory of claim 13, wherein the transfer duct includes a protrusion located along and extending downward from a bottom wall of the transfer duct, wherein the shutter includes a lower flange having a first detent and a second detent spaced apart from the first detent, wherein the protrusion is received in the first detent when the shutter is in the non-blocking position, wherein the protrusion is received in the second detent when the shutter is in the blocking position.

16. The temperature control accessory of claim 1, wherein the support ring includes an upper rim and a lower rim, the upper rim configured to interface with a lid of the kettle grill, the lower rim configured to interface with a firebox of the kettle grill, the sidewall of the support ring extending between the upper rim and the lower rim of the support ring.

17. The temperature control accessory of claim 16, wherein the lower rim of the support ring is configured to be seated on, circumscribed by, or nested within an upper rim of the firebox, and the upper rim of the support ring is configured to be seated under, circumscribed by, or nested within a lower rim of the lid.

18. The temperature control accessory of claim 16, wherein the upper rim and the lower rim of the support ring have a circular shape.

19. The temperature control accessory of claim 1, wherein the support ring includes a plurality of support flanges coupled to and extending internally relative to the sidewall of the support ring, wherein respective ones of the support flanges are configured to support a cooking grate.

20. The temperature control accessory of claim 1, wherein the support ring includes circumferentially opposed openings formed in the sidewall of the support ring, wherein each one of the circumferentially opposed openings is configured to receive a portion of a rotisserie spit when the rotisserie spit is in use with the temperature control accessory, wherein each one of the circumferentially opposed openings is further configured to receive a seal when the rotisserie spit is not in use with the temperature control accessory.
